(19) United States
(12) Patent Application Publication
(10) Pub. No.: US 2013/0304604 A1
(43) Pub. Date: Nov. 14, 2013

(54) SYSTEMS AND METHODS FOR DYNAMIC DIGITAL PRODUCT SYNTHESIS, COMMERCE, AND DISTRIBUTION

(71) Applicants: Michael Theodor Hoffman, Menlo Park, CA (US); Chad James Phillips, Portland, OR (US)

(72) Inventors: Michael Theodor Hoffman, Menlo Park, CA (US); Chad James Phillips, Portland, OR (US)

(21) Appl. No.: 13/668,168

(22) Filed: Nov. 2, 2012

Related U.S. Application Data
(60) Provisional application No. 61/554,532, filed on Nov. 2, 2011.

(51) Int. Cl. G06Q 30/06

(52) U.S. Cl. CPC G06Q 30/0621
USPC 705/26.5

(57) ABSTRACT

A system and method are provided for creating, managing, rendering and delivering digitally synthesized products that can be automatically generated as a function of variable attributes provided by a variety of sources. The system can include design tools for creating workflows that describe the rules for dynamically creating digital products; licensing system to manage product licensing; distributed synthesis systems for generating products; location based services to manage location/time specific products; sharing services for transferring products; web services for composing and sharing products; mobile applications for composing and sharing products; notification services for notifying participants of system state changes; databases for managing the components of the system; extension services for externally developed system extensions; API services for external management and utilization of the system; and e-commerce services for paying or collecting fees for usage of the system by contributors or users.

### BENEFIT CLAIMS TO RELATED APPLICATIONS

This application claims benefit of U.S. provisional App. No. 61/554,532 entitled “Dynamic digital product synthesis, commerce and distribution system” filed Nov. 2, 2011 in the names of Michael Theodor Hoffman and Chad James Phillips, said provisional application being hereby incorporated by reference as if fully set forth herein.

### BACKGROUND

The field of the present invention relates to digital products. In particular, systems and methods are disclosed herein for dynamic digital product synthesis, commerce, and distribution. The disclosed systems and methods relate to dynamically generating digital content as a function of workflows and transferring that generated content to a variety of digital and physical destinations.

In the past ten years or so, there has been an enormous focus on creating more personally relevant content that can be digitally generated and delivered to consumers. There are a variety of business and end-consumer solutions to meet this demand for personalization. The Variable Data Publishing industry has developed solutions that deliver pages that have been substantially personalized to the end-consumer who will receive the printed or emailed product. Pageflex® and Quark Dynamic Publishing solutions are examples of systems that enable dynamic page layout for both print and digital delivery. The image personalization industry has developed solutions that deliver digital images that have been personalized to the end-consumer who will receive the image. These images are generally used in 1:1 email marketing and digital print marketing campaigns. Directsmile®, AlphaPicture® and Xerox® XMPie® are examples of systems that generate personalized images.

### SUMMARY

A method is performed using a system of one or more programmed hardware computers; the system includes one or more processors and one or more memories. The method comprises: receiving electronic indicia of a synthesis descriptor reference and one or more variable attributes; retrieving the referenced synthesis descriptor, constructing a digital product instance of a digital product class, and electronically delivering or storing a digital copy of the digital product instance. The electronic indicia of the synthesis descriptor reference and the one or more variable attributes are received automatically at the computer system from a first requesting interface device. The referenced synthesis descriptor is retrieved automatically from one or more of the memories. The synthesis descriptor defines the digital product class. The digital copy of the constructed digital product instance is delivered electronically to a receiving interface device or stored on one or more of the memories.

The synthesis descriptor includes one or more instructions which, when applied to the computer system, instruct one or more of the computers to cause a corresponding digital product instance to be constructed using a corresponding set of one or more variable attributes. The one or more variable attributes includes one or more parameters or one or more references to one or more digital content items. The one or more parameters or the one or more referenced digital content items of the first set are used by the computer system according to the first synthesis descriptor to construct the first digital product instance.

Objects and advantages pertaining to systems and methods for dynamic digital product synthesis, commerce, and distribution may become apparent upon referring to the exemplary embodiments illustrated in the drawings and disclosed in the following written description or appended claims.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates schematically an exemplary digital product synthesis system.

FIG. 2 illustrates schematically exemplary interactions among participants in an exemplary digital product synthesis end-to-end ecosystem.

FIG. 3 illustrates schematically an exemplary database for an exemplary digital product synthesis system.

FIG. 4 illustrates schematically an exemplary synthesis system workflow component.

FIG. 5 illustrates schematically details of an exemplary single component.

FIG. 6 illustrates schematically components of an exemplary self-contained product synthesis device.

FIG. 7 illustrates schematically various primary components of an exemplary synthesis system.

FIG. 8 illustrates schematically an exemplary sequence of steps for serving a request for a finished product.

FIGS. 9A, 9B, and 9C illustrate schematically an exemplary method for representing and transmitting zones for a raster image.

FIGS. 10A and 10B illustrate schematically exemplary in-image selection and editing of arbitrarily rendered text in an image.

FIG. 11 illustrates schematically an exemplary method for merging digital image products into a video frame sequence.

FIG. 12 illustrates schematically another exemplary method for merging digital image products into a video frame sequence.

FIGS. 13A and 13B illustrate schematically an exemplary method for constructing and using complex paths for flowing glyphs, glyph justification, and copy-fitting.

FIGS. 14A and 14B illustrate schematically an example of support of glyph composition flow, copy fitting, and glyph range specification.

FIG. 15 illustrates schematically examples of collaborative story lines created from a series of digital products arranged into sequences of multiple frames.

FIG. 16 illustrates schematically an example of collaborative story commerce.

FIG. 17 illustrates schematically an exemplary process for retrieving a finished product request from a URL.

FIGS. 18A-18C illustrate schematically exemplary processes for in-video advertisement placement.

FIG. 19 illustrates schematically an exemplary system for providing access control and policy settings.

FIG. 20 illustrates schematically an exemplary workflow for handling policy metadata.

FIG. 21 illustrates schematically another exemplary workflow for handling policy metadata.

FIG. 22 illustrates schematically another exemplary workflow for handling policy metadata as a function of a job identifier.

FIG. 23 illustrates schematically an exemplary method for handling unique identifiers.

FIG. 24 illustrates schematically an exemplary method for retrieving a synthesized product.

FIG. 25 illustrates schematically an exemplary method for publishing an editable product.

FIG. 26 illustrates schematically an exemplary workflow for composing or incorporating one or more messages into at least one image.

FIGS. 27A and 27B illustrate schematically exemplary workflows for end-to-end distribution processes.

FIG. 28 illustrates schematically another exemplary synthesizer workflow.

FIGS. 29A, 29B, and 29C illustrate schematically alternative exemplary hybrid on-device synthesis workflow.

FIG. 30 illustrates schematically an exemplary workflow for systems between components.

FIG. 31 illustrates schematically an exemplary workflow for signals between other systems, devices, and a back-end.

It should be noted that the embodiments depicted in this disclosure are shown only schematically, and that not all features may be shown in full detail or in proper proportion. Certain features or structures may be exaggerated relative to others for clarity. It should be noted further that the embodiments shown are exemplary only, and should not be construed as limiting the scope of the written description or appended claims.

### DETAILED DESCRIPTION OF EMBODIMENTS

However, although the examples listed in the Background provide documents that have been personalized to a particular person, each one of those systems provides only rudimentary forms of personalization of non-textual content, particularly images. None provides comprehensive synthesis, commerce, and distribution systems or methods that enable an end-user to select content, interactively personalize that content, and readily share the personalized content with others. Furthermore, none provides a marketplace for content designers to design interactive content, submit it to the marketplace for others to find and use, and earn money whenever it is personalized and used by others.

The disclosed systems and methods provide synthesis and delivery of digital product instances, including but not limited to one or more of images, image sequences, videos, 3D models, web pages, and multimedia documents, as a function of information provided by corresponding synthesis descriptors and variable attributes. Each synthesis descriptor describes basic steps for synthesizing a class of digital products into digital product instances. Variable attributes can describe a wide variety of possible synthesis variations, and each variable attribute can originate from a variety of sources, including but not limited to one or more of default values, system configuration files, databases, internal and external real-time data sources, expert systems, knowledge databases, recommendation systems, artificial intelligence systems, neural networks, historical analysis systems, random number generators, or the agent (i.e., person, entity, computer or server, or software) requesting the digital product instance. Variable attributes can include, but are not limited to, one or more of text messages, images, image transformation instructions, tweening instructions, video clips, audio clips, font faces, font sizes, embellishments, text composition choices, resolution, compression quality, background image choices, compositing choices, sequencing choices, colors, filtering choices, geo-location, time, date, personal preferences, age, gender, social graph, communications history, or demographics.

In addition to data processing services coupled directly to the synthesis system, the synthesis system can also be externally coupled to a wide variety of external data processing services, typically provided by other, third-party organizations. Any number of internal or external data processing services can be referenced by each synthesis descriptor to describe how to produce a class of digital products. Each variable attribute describes a variation within the class of digital products. A plurality of variable attributes can expand the possible variations within a class of digital products, thereby enabling the creation of diverse digital product instances. The synthesis descriptor can optionally describe some or all of the variable attributes that can be used to alter the digital product instances generated by that synthesis descriptor.

The synthesis system can be used to associate a corresponding identifier to the synthesis descriptor and the variable attributes required to synthesize (i.e., construct) a requested digital product instance for a first agent, store that association for later retrieval, and deliver that identifier to a second agent so that the second agent can request a functionally similar digital product instance to be delivered for that identifier. The synthesis system can also associate that same identifier with a cached version of the produced digital product instance so that the identifier can first attempt to retrieve the digital product instance from the cache. If the digital product instance is not found in the cache, the identifier can then be utilized to retrieve the synthesis descriptor and the variable attributes used to initially generate the digital product instance and to synthesize a second digital product instance that is substantially similar to the first digital product instance generated earlier. The second digital product instance thus synthesized can then be added to the cache for a period of time for subsequent requests for the same digital product instance. The synthesis system can store a detailed history of information utilized to produce digital product instances and what agent requested the digital product instance so that the use of the system can be later analyzed, users (i.e., agents, or users or administrators thereof) can be billed for use of the system, content designers can be paid for the use of content, and recommendations can be made for subsequent uses of the system.

In some examples, the synthesis system can track one or more linear sequences or logical trees of digital product instances, wherein each digital product instance can be regenerated from a synthesis descriptor and at least one variable attribute. Different agents can initiate the synthesis of a new digital product instance that is then logically added to a linear sequence or as a new end node in a logical tree of sequences. In one embodiment, the linear sequence of digital product instances is a series of cartoon story frames where a plurality of agents (e.g., people) have added frames to the story. In another embodiment, a plurality of people can add different frames at a certain point in the story, effectively creating multiple stories with unique story lines. Furthermore, a plurality of people can add unique frames to each of the plurality of previous frames, effectively creating a logical tree of story lines. Users can then rate story lines so that some story lines are highlighted as being preferred over others. At any point, story lines can be culled from the logical tree of possible stories.

The exemplary embodiments set forth below include information to enable those skilled in the art to practice the disclosed systems and methods, and to illustrate the best mode of practicing the disclosed systems and methods. Upon reading the following description in light of the accompanying drawing figures, those skilled in the art will understand the concepts of the disclosed systems and methods and will recognize applications of these concepts not particularly or explicitly addressed herein. It should be understood that these concepts and applications fall within the scope of the present disclosure or the appended claims.

### Vocabulary Used in the Present Disclosure

Digital Product—The set of instructions and data required for the synthesis platform to create any of a variety of finished products in a class of digital products. In the various exemplary embodiment this comprises a Synthesis Descriptor and a set of digital assets referenced from within the Synthesis Descriptor (such as vector fonts, raster fonts, image elements, video elements, audio elements, and so on). Each unique digital product can be referenced and invoked via a unique identifier.

Digital Product Instance—One instance of a digital product that was produced by the synthesis platform utilizing a synthesis descriptor of the associated digital product and variable attributes. Each instance can vary from one another as a function of the values of the variable attributes. A Digital Product Instance can further be used to produce physical hard goods either manually or via automated processes initiated by the Synthesis System according to instructions contained within the Synthesis Descriptor or via external mechanisms.

Finished Product—synonymous with Digital Product Instance.

Metadata—any data that describes how a particular aspect of the system shall function.

Variable Attributes—the information provided by an agent to specify, in conjunction with a synthesis descriptor, how to produce one finished product. Variable Attributes can be provided as <key,value> pairs.

Synthesis Descriptor—a set of instructions and metadata that describes how to synthesize a variety of finished products from the instructions contained within the Synthesis Descriptor plus externally provided variable attributes as inputs. In one example the Synthesis Descriptor can be an XML data stream. It can generally include: general instructive and descriptive information; information describing the expected inputs and outputs; references to external digital assets used in synthesis; or the actual declarative or procedural instructions on how to digitally assemble a finished product.

Workflow—a description of at least one component (e.g., a software component) that describes at least one operation that can perform a specific function. A workflow is described by a workflow descriptor which describes the function of the workflow and optionally provides default values for parameters that can be provided when the function described by the workflow is executed. A workflow descriptor can be a synthesis descriptor or a synthesis descriptor can be a workflow descriptor. The exact nature and outcome of the function is determined by a variety of design time and run time parameters that govern the operation of the workflow. The various components of a workflow can be operatively coupled by logical data flow paths, referred to as wires. For example, a workflow might include an image reader component which can read an image file into memory, an image scaler component which can change the resolution of an image, and an image writer component which can write an image to a file in a standard image format. When the image reader is operatively coupled to the image scaler and the image scaler is operatively coupled to an image writer, the workflow can then be used to transform digital images to a different resolution.

Executing a workflow—perform the function described by the workflow as a function of its description and as a function of optional input parameters.

Component—a unit (e.g., a software unit) that describes at least one operation that can perform a specific function. A component can optionally specify a variety of input connectors for receiving data or signals and a variety of output connectors that provide data or signals. The connectors of one component can be operatively coupled to the connectors of other components by logical data flow paths, referred to as wires. Signals or data can be retrieved from one component and provided to another component so that a series of operations can be performed. Externally, a workflow can appear to be a component such that one workflow can function as a component in another workflow. This nesting of workflows can continue to any practical depth.

Widget—synonymous with Component

Connector—a logical port on a component which can receive or provide signals or data. A component can have any number or type of connectors. Connectors can be classified as being an input connector, an output connector, or both. Each connector can serve a specific purpose relative to the function of the component. Each connector can specify at least one type of signal or data that they can receive or provide. Typically, each connector of a specified purpose can specify the minimum and the maximum number of connections it can support of that at least one type for the specified purpose. For example, an image scaler component expects (i) exactly one input connector for receiving one type of data in the form of a digital image for the purpose of receiving that image at runtime with the intent to scale that image and (ii) exactly one output connector for providing one type of data in the form of a digital image for the purpose of providing the scaled image to another function. In another example, an audio mixer component can specify that it expects two or more input connectors for the purpose of receiving two or more left channels of two or more audio signals with the intent to mix those two or more audio signals into one signal and to provide the one audio signal to exactly one output connector for providing one type of data in the form of an output left channel audio signal.

Wire—the description of a logical data flow path between two components. When a workflow is executed, this description can be used to determine where to receive data or signals from one component and where to provide data or signals to another component.

Synthesis Descriptor Reference—a unique identifier that can be used to access the actual synthesis descriptor data.

Synthesis Subsystem—The portion of the overall system that can accept a synthesis descriptor or a synthesis descriptor reference and variable attributes to synthesize a finished product.

Synthesis System—The overall system (also referred to as a “platform” or “ecosystem”) that manages user data, commerce, service requests, analytics, databases, product synthesis requests, caching, load balancing, and other components necessary to manage the entire data flow and control in a product synthesis ecosystem.

Synthesize—The process of accepting the inputs of a Synthesis Descriptor or Synthesis Descriptor Reference plus any number of Variable Attributes, and using those inputs to produce a Finished Product.

Glyph—Any one graphical representation of at least one character code in a character set. A character set can be the set of characters described by an ASCII or a Unicode character set, or can represent one or more graphical members of any arbitrary set of symbols that have meaning in a particular context. Further, a glyph can also represent a consecutive sequence of character codes in a character set. For example, the ASCII character code sequence for the word “smile” can lead to a single graphical representation of a smiley face image.

Digital Content or Digital Assets—The digital files, typically images, videos, vector fonts, or raster fonts, that can be used to synthesize finished products.

In one example, a digital product might be called “water-tower-graffiti” which references a synthesis descriptor, which can be in the form of an XML (i.e., eXtensible Markup Language) text stream containing, inter alfa, a logical set of instructions, metadata, content data, or references to an external background image file (e.g., that exists as a digital image available from photo editing solutions, such as Adobe® Photoshop®, in any suitable format, such as JPEG or TIFF). Some or all of those can be used to synthesize previews of the water tower image, accept and place some textual message such as “Harry loves Mary” into the water tower image (e.g., in the proper orientation, justification, transformation, coloring, shading, or other embellishment necessary to look like graffiti painted on the water tower), and to produce a finished product. The finished product can comprise a digital image file modified to look like the water tower with graffiti that reads “Harry loves Mary”. The finished product can also further refer to an individualized physical product (such as a T-shirt) which has had the modified image of the water tower digital image placed thereon. Generally, one finished product will exist as one digital file or one data stream in memory. In some instances, the finished product can be stored on a hard drive or other persistent digital storage. In other instances, for performance reasons, it may be advantageous to deliver a finished product from random access memory without ever committing the finished product to a persistent storage device. One finished product can include a plurality of actual digital data files or data streams. As an example, a finished product can include both a digital image file and an instruction file for controlling a printing, cutting, and folding machine that prints the digital image file on a substrate such as cardboard, then die-cuts the substrate and folds it into a three dimensional object as a function of the instructions in the instruction file.

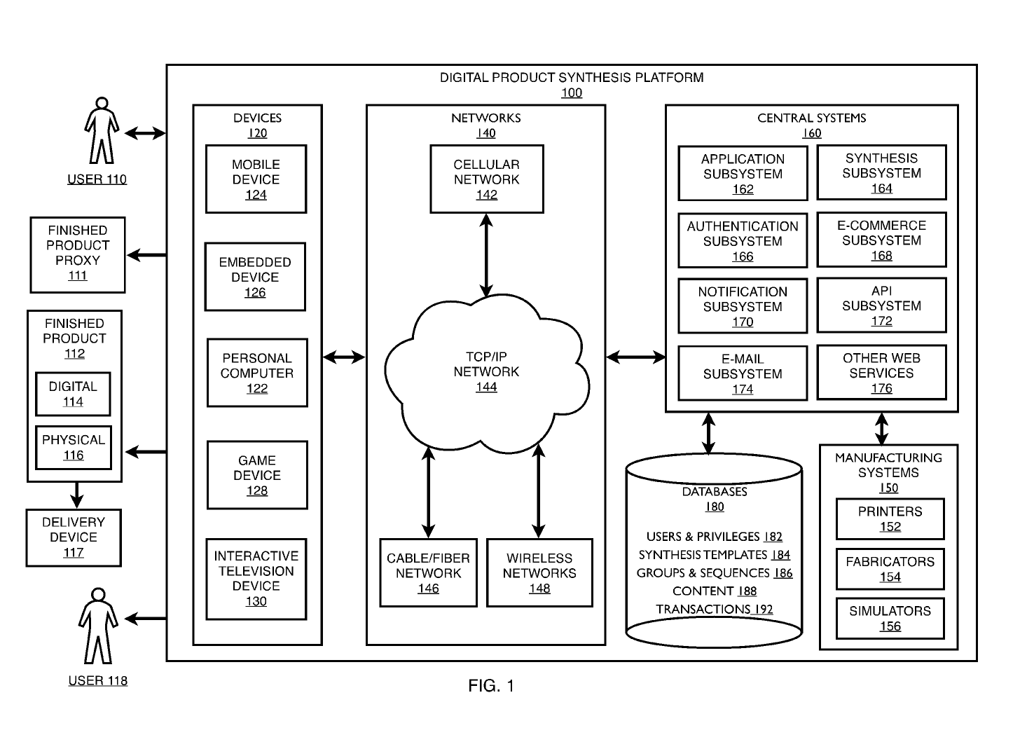

### FIG. 1

FIG. 1 illustrates schematically an exemplary digital product synthesis system 100 (also referred to as a “platform” or “ecosystem”) that enables a user 110 to employ a variety of devices 120 (i.e., interface devices 120) to search for and browse available classes of digital products, interactively specifying variations to a class of digital products to see a finished product proxy 111 of the finished result, such as a low resolution digital image or a low fidelity rendering of a three dimensional object, and to select a method for causing the synthesis of a higher fidelity finished product 112 represented by the digital product proxy 111.

In some examples, the delivery of a finished product 112 by the system can be in the form of a digital product 114 (e.g., a multimedia document, a PDF file, a CAD file, an image file, a video file, a 3D rendering file, an HTML page, an Adobe® Flash® file, or an instruction file suitable for producing the finished product via other specialized digital or physical delivery device 117). One specific example of a digital delivery device 117 is a laser show device; the laser show device can receive the digital finished product 114 as a digital instruction file that is used to determine the nature of the laser show. Another specific example of a specialized physical delivery device 117 is a mechanical billboard- or mural-painting device that receives the digital instruction file to drive the mechanical painting device to render an image on a large surface with a colorant such as paint or chalk.

Other examples of delivery of a finished product 112 by the system can include delivery of a physical product 116 produced by any one of a variety of manufacturing systems 150 able to accept digital data and instructions to produce the physical product 116. Examples of suitable manufacturing systems include but are not limited to: a wide variety of printers 152; a variety of fabricators 154 such as 3D printers; other rapid prototyping devices that produce 3D physical models from a substrate; or computational simulators 156 that simulate physical world systems, e.g., a robotic simulator or manufacturing process simulator which can be used to simulate a physical product without the need to actually produce that product (which might be desirable during the initial prototyping or testing portion of a development process). Printers 152 can include photocopiers, ink jet printers, dye sublimation printers, digital presses, large format printers, pen plotters, and other ways of depositing colorants on a surface. Physical products 116 can include, but are not limited to, digital prints, articles of clothing, apparel accessories, bags, mugs, awards, banners, bumper stickers, machine milled objects, fabricated 3D models, laser etched objects, pen drawn surfaces, painted surfaces, or objects produced by machines that can accept digital instruction files to specify how to produce the desired physical product. The physical finished product 112 can further be utilized by a delivery device 117 to enable the delivery device to provide an individualized experience or object. Examples of a physical finished product 112 that could be further used by a delivery device 117 is an individualized DVD that is viewed by a DVD player, and an instruction file that can be used to instruct a personal 3D digital printer to fabricate specific objects on-demand.

For the purposes of interacting with the system 100, a user 110 may employ a variety of devices 120 that provide outputs such as a digital display for showing a proxy of a finished product 111 and inputs such as keys, buttons, or touch screens for receiving user instructions. Examples of user instructions can include searching among all available classes of digital products, browsing digital products, selecting digital products, specifying variations to digital products, or choosing a way of delivering finished products 112 derived from digital product variations. Alternatively, a user 110 may employ devices 120 as digital agents which use programs to automatically solicit data from other sources, specify variations of a digital product, and specify delivery instructions of the finished product 112 derived from the varied digital product. In this case the device 120 does not necessarily require any input or output device for interaction with the user and only requires a wired (e.g., electrical or optical) or wireless communication link to the central systems 160. Such digital agents may run on any type of device 120 that is capable of communicating to one or more networks 140 (e.g., a TCP/IP network or other suitable communications network).

Each of the one or more central systems 160 can include one or more of an application subsystem 162, a synthesis subsystem 164, an authentication subsystem 166, an e-commerce subsystem 168, a notification subsystem 170, an API subsystem 172, an email subsystem 174, or other web services subsystems 176. Each of the one or more central systems 160 comprises one or more central processing units for executing program instructions, one or more memories for storing program instructions or storing program data, and a network communications interface for signaling across networks 140 and optionally for signaling directly with one or more other central systems 160.

In some examples, devices 120 can synthesize and deliver finished products 112 to a user 110 without requiring a network 140 or separate central systems 160 or separate databases 180. In such examples the necessary functionality of the central system 160, including the synthesis subsystem 164, can be digitally packaged to be embedded into and operate directly on devices 120. Certain other central system components and databases can also be embedded directly into devices 120 to allow such devices to function properly even when no networks 140 are available. In such examples, some or all of the information from one or more central systems 160 can be replicated in a cache or database within one or more devices 120 to facilitate proper operation regardless of the level of connectivity to one or more networks 140.

Examples of a mobile device 124 that can be used in the system include: an iPod® or other handheld computer; an iPhone®, Android®, or other smartphone; an iPad®, Android®, Surface®, or other tablet computer; a Kindle®, Nook®, Sony®, or other electronic reader; a laptop, notebook, netbook, or other portable computer; or any suitable portable electronic device that is able to run agent programs, applications, or a web browser. Examples of an embedded device 126 include wearable computers, a kiosk in a store, building, or other venue, a computerized sensing device that senses changes in its environment, a computer in a vehicle, or a digital camera. In a typical scenario, such an embedded device accepts input from a variety of sources, converts these inputs into instructions on how to vary a digital product, and then initiates the synthesis and delivery of the finished product 112. An example of a personal computer 122 is a desktop computer (e.g., an iMac® or a PC running the Windows® operating system) or other workstation, terminal, computer, or computer system that communicates with networks 140 via Ethernet, wireless, fiber, or other similar communications link for sending and receiving digital data to and from central systems 160. Examples of game devices 128 include, but are not limited to, a Nintendo® Wii®, a Sony® PlayStation®, or a Microsoft® Xbox®; such devices are increasingly powerful and generally communicate with networks 140. In the case of game devices 128, the input device often includes a variety of handheld game controllers or distance- or motion-sensing cameras that enable a user 110 to instruct the device. Examples of interactive television devices 130 include a wide variety of set-top boxes or other integrated receiver/decoder devices (i.e., IRDs) connected to or incorporated into traditional television sets. These set-top boxes perform the input and output functions with the user 110 and the communications functions with networks 140. Recently, user interactivity has been incorporated directly into television sets which has in some cases obviated the need for external set-top boxes. Examples of interactive television devices are TiVo®, Apple TV®, Microsoft® Windows® XP Media Center, Lodgenet®, MiTV®, ReplayTV®, UltimateTV, Miniweb, and Philips Net TV. An example of using such a device can include a user 110 providing information such as a name and preferences to the interactive television device as well as specifying preferences during the showing of a movie. The combination of all provided inputs can be used by a digital agent to assess desirable variations to the delivered video stream, which can then provide a set of variation instructions to the central systems 160 for synthesizing the finished product 112 (in this example a video stream that includes content that has been customized to that user 110).

The networks 140 that digitally connect devices 120 to central systems 160 can generally include TCP/IP networks 144 (such as the Internet backbone used to transfer TCP/IP traffic across the globe and into space), cellular networks 142 (such as those controlled by AT&T®, Sprint®, Verizon®, or other cellular companies) that transmit cellular data used to communicate between a plurality of mobile phones and the Internet), cable and fiber networks 146 controlled by the various cable or telecom companies (such as Cablevision®, Comcast®, Time Warner Cable®, or telephone companies), or wireless networks 148 such as WiFi or WiMAX (commonly used to provide Internet access in stores, restaurants, airports, other public spaces, or even entire cities). Any or all of these networks can also employ satellites, microwave repeaters, or other equipment or protocols to move digital data from one point to another. In general these networks 140 are interconnected and can, individually or in various combinations, convey digital data back and forth between devices 120 and central systems 160.

One or more of the central systems 160 typically provide the majority of services for synthesizing and delivering digital products. Representative examples of central systems are included, but are not intended to represent all possible systems that can be employed. A person skilled in the art will understand that: each representative system can span a wide variety of types and numbers of computing devices; each computing device can provide all or only a portion of the overall available functional services; these computing devices can be geographically distributed across the globe; and any one request to the system can be processed by one or more of the computing devices. Currently, a common implementation of such systems includes so-called cloud computing wherein a large number of similar computing devices are provisioned and de-provisioned as needed to provide particular services. Any one device may only provide a subset of all available services so that those services provided by a central system 160 can be independently scaled up or down based on actual usage over time. Load balancing servers can be employed to accept requests for services and delegate the requests to any of a plurality of other computing devices. Each of the representative central systems 160 are described in more detail below and each can employ all or part of the above described methodologies for providing large scale services that may span many computing devices. The various computing devices are typically interconnected via networks 140, but can instead, or in addition, be interconnected by other digital communications links (e.g., a digital signal bus between CPUs on the same computer backplane, or a high speed optical fiber channel connection between one or more racks within a computer data center).

The application subsystem 162 provides the back-end services and business logic for enabling users to interact with the system 160 through client devices 120. In an exemplary embodiment, the application system is a web application server developed using Java™ 2 Enterprise Edition (J2EE), or one or more of a variety of other popular web-focused development software frameworks such as Node.js™, PHP, or Ruby on Rails®. The application subsystem 162 can accept input from devices 120 transmitted across networks 140 and received by the application subsystem 162. This input can then be used to invoke business logic such as search for digital products based on keywords, request a list of all available digital products, request a list of digital product categories, request detailed information about one class of digital product, apply variations to a digital product, request a proxy of the final digital product 111, or request the actual final product 112.

The application subsystem 162 can manage user interaction sessions that allow for continuity from one request to the next received from each device 120. One aspect of this continuity can include storing authentication information for the user session. A user can be considered to be authenticated if the user has provided valid authentication credentials. Typically, the application subsystem 162 can employ the services of an authentication subsystem 166 and a users & privileges database 182 to assess the validity of an authentication request and, if validated, store information in the current session that references the validated user's information and attributes. Once a session is established, the authentication subsystem 166 can maintain that session until the user explicitly de-authenticates (i.e., logs out) or the current session expires (e.g., due to inactivity for a period of time). The application subsystem 162 can allow only a subset of all available actions to be performed if no user 110 is currently authenticated for the current session. If a user 110 is currently authenticated for the current session, privileges information stored in the users & privileges 182 database can be used to determine what services the application system is allowed to provide for that user. The privileges might in some instances be managed in other databases 180 that are not in the same table as the primary user authentication information. Some users can have privileges to administer the application system itself.

The synthesis subsystem 164 can provide services to synthesize digital products based on receiving requests from other central systems 160 or directly from devices 120. An example of a device 120 request is an HTTP URL (i.e., HyperText Markup Language Uniform Resource Locator) that includes an arbitrary number of variable parameters describing the action to be performed. Alternatively the synthesis subsystem 164 can be integrated directly into devices 120 so that no communication across a network 140 is required to invoke its services. The synthesis subsystem 164 receives requests that can include a synthesis descriptor reference as well as at least one variable attribute that specifies how to synthesize a final product from the information contained in the referenced synthesis descriptor. In an exemplary embodiment, the synthesis descriptor reference can be a unique textual identifier such as “mobile_lowresolution_water_tower”, or a unique database identifier such as an integer or a UUID (i.e., Universally Unique IDentifier).

In an exemplary embodiment, the synthesis descriptor referenced by the synthesis descriptor reference can be an XML-formatted text stream; the variable attributes can take the form of a set of one or more <key,value> pairs where the key is an identifier that describes the nature of the attribute and the value describes which of the possible values are to be employed for that attribute. For example, the key can be the textual identifier “message” and the value can be the textual string “Harry loves Mary”. Such <key,value> pairs are often provided in the form key=value, e.g., “message”=“Harry loves Mary”. In another exemplary embodiment, the synthesis descriptor reference is provided as a <key,value> pair where they key identifies the attribute as specifying a synthesis descriptor reference, e.g.,

“descriptor”=“mobile_lowresolution_water_tower” or “descriptor”=“e691a3d0-2a66-11 e0-91 fa-0800200c9a66”.

Once the synthesis subsystem 164 has received a synthesis request that includes a synthesis descriptor reference and at least one variable attribute, the synthesis system can retrieve the referenced synthesis descriptor and utilize the information contained in the descriptor and the values associated with the variable attributes to synthesize a finished product. The act of synthesizing a finished product in one example can be as simple as using the at least one variable attribute to select one of a plurality of digital data streams stored in a memory. In such a simple case, the term synthesis merely involves selecting the desired digital data stream and transmitting it. The finished product can be stored for later retrieval in association with a unique identifier (for enabling that later retrieval), or the finished product can be transmitted immediately to the requesting central system 160 or requesting device 120 (with or without first storing the finished product locally).

The act of synthesizing or delivering a finished product can be assigned a monetary value. The monetary value can be defined, e.g., as a certain amount of money for a specific number of finished products or for a certain number of deliveries of a finished product. Instead or in addition, the assigned monetary value can be determined or modified as a function of the amount of computing resources (e.g., CPU time or memory) that are required to synthesize the finished product. Alternatively, a subscription model can be employed wherein a certain period of time within which a particular digital product can be used to synthesize finished products can be assigned a monetary value. In all of these cases, an e-commerce subsystem 168 can be employed to track uses of the synthesis subsystem 164, to match these uses against monetary value policies for the synthesized digital products (e.g., that govern how to monetize uses of that digital product), and to charge accounts as a function of account referencing information provided by a user 110. In some examples, the user can be charged each time one finished product 112 is delivered. In other examples, a certain number of one or more finished products can be generated before the user is expected to pay for additional uses; at that point, the system can automatically charge a user account or can notify the user 110 to manually purchase additional credits for future finished products. Alternatively, the user can be billed on a periodic basis for the right to use a certain number of digital products, or a certain quantity of finished products, or a combination of both. For example, a monthly fee of $9.99 may allow one user 110 to synthesize up to one hundred finished products 112 synthesized from any selection among a set of five hundred digital product choices. Other digital product choices beyond the five hundred can be requested and billed separately using another monetization policy. In another example of a monetization policy, the first N finished products delivered for a specific digital product can be free, while subsequent finished products can result in a charge to the user.

In one embodiment of the digital product synthesis system 100, certain events may occur where it is beneficial or desirable to notify a user 110 that such event has occurred. In a typical example, an event occurs in the application subsystem 162 which in turn signals a notification subsystem 170 with at least one attribute of the event and at least one attribute describing the at least one recipient for a corresponding notification of the event. Each recipient can be any one or more of the central systems 160 or any one or more of the devices 120. The notification system can queue the signal for future transmission or can alternatively immediately signal the one or more recipients. The notification can be transmitted locally or across the networks 140. As an example, instead of directly delivering a finished product 112 immediately after it has been synthesized by the synthesis subsystem 164, the synthesis system can instead send an event notification to the notification subsystem 170 indicating that the requested finished product has been synthesized.

Once signaled by one of the other subsystems, the notification subsystem 170, in turn, can queue up this event and at some point in the future signal one or more devices 120 that an event has occurred (e.g., that a finished product has been synthesized). The device 120 can then provide visual, tactile, or other feedback to the user 110 to indicate that an event has occurred. The notification can indicate: only the fact that an event has occurred, a count of the number of events that have occurred (e.g., since the last notification), or more extensive information regarding the nature of the event. The notification can serve as a call to further action by the user 110, or by one or more devices 120, or by one or more other central systems 160. In the case of a user notification, once the user has determined that the notification indicates that, e.g., a finished product is now available, the user can request any desirable action regarding that finished product.

In another example, the user can employ a mobile device 124 or embedded device 126 that includes a geo-location sensor (e.g., a GPS or other logic to assess geo-location) wherein the device periodically transmits geo-location information across the networks 140 to a central system 160. The application subsystem 162, upon receiving such geo-location information, can use this information to identify digital products that are relevant to that geo-location. For each such digital product (i.e., for which geo-location information is available), the size and shape of the corresponding relevant geographic region can be specified so that a given geo-location can be determined to be either inside or outside each corresponding region. If at least one digital product has a corresponding geographic region that intersects the geo-location information received from a mobile, embedded, or portable device, the application subsystem 162 can send an event to a notification subsystem 170 specifying that the geo-location intersection has occurred. The notification subsystem 170, in turn, can queue up this event and at some point in the future signal one or more devices 120 that an event (e.g., the device was located in a geographic region relevant to a corresponding digital product) has occurred. The device 120 can then provide visual, tactile, or other feedback to the user 110 that an event has occurred. In some examples, the event may only be signaled if certain other conditions also are met, such as the event occurring within a certain time frame, or known attributes of the user 110 meet certain criteria. For example, a digital product or a finished product can be associated with geo-location for a specific club and a 3-day time frame during which a certain event is scheduled to occur at that club. A given user may have indicated a desire to receive club events; if that user approaches that club during the timeframe of the event, a notification signal will be received. If the user instead indicates that no club events are desired, or physically enters the proximity of the correct geographic region outside the specified time window, the notification signal would not be sent.

The digital product synthesis system 100 may include an API subsystem 172 that provides one or more services to other web services 176, to one or more other central systems 160, or to one or more devices 120. These services can be provided locally or across networks 140. In an exemplary embodiment these services can take the form of, e.g., HTTP RESTful (i.e., REpresentational State Transfer) requests over a TCP/IP network 144. As each service request is received, the request is validated and can be rejected if any aspect of the request is found to be invalid. The request can be logged to provide an audit trail and to enable analytics of how the system is being used.

For the purposes of this disclosure, a user agent is any software or system that is acting on behalf of a user 110, either automatically, autonomously, or as a function of direct instruction from the user 110. The user agent typically has direct or indirect access to one or more credentials that the user agent can use to authenticate to other systems on behalf of the user. The user agent often can take the form of devices 120 or other central systems 160 such as other web services 176, but is not limited to these cases. The service request can be for an anonymous user agent that is not credentialed for any user 110, or for an authenticated user agent. In the case of an anonymous user agent, the request can be matched against a list of services allowed for anonymous users and, if allowed, can be further processed; otherwise it can be rejected. In the case of the authenticated user agent, the request can be matched against a list of services allowed for the authenticated user agent and, if allowed, can be further processed; otherwise it can be rejected.

Depending on the nature of the request, the API subsystem 172, can further process the request and employ the services of one or more other central systems 160 to fulfill the requested functionality. In some cases the API subsystem 172 can fulfill the requested functionality without the employment of other central systems 160. One form of request can be to authenticate or de-authenticate a user agent in which case the API subsystem 172 employs the services of the Authentication subsystem 166 to fulfill the request. For many requests, the parameters of the request can be extracted and passed directly to the Application Subsystem 162 for execution; results of the request can be passed back to the API subsystem 172 for transmission back to the requesting user agent. In an exemplary embodiment, the response signaled back to the user agent that made the request can be formatted using, e.g., JSON (i.e., JavaScript Object Notation) or XML. One of the parameters provided with the request can specify which response format is desired; a default format can be used if none is specified.

In an exemplary embodiment of the digital product synthesis system 100 the application subsystem 162 can receive a request from a first user 110 to deliver a finished digital product 114 to a second user 118 via an email subsystem 174. In this case, the application system can receive at least one destination email address of the second user 118 and a reference to a finished product in the form of an identifier that has previously been associated with a finished product previously synthesized, or in the form of a synthesis descriptor and at least one variable attribute necessary to synthesize a finished product. The application subsystem 162 can in turn transmit the reference to the finished product and the destination email address to the email subsystem 174, which can provide the services to ensure that the email containing the reference to the finished product is transmitted to the second user's 118 email inbox. In an exemplary embodiment, the email can contain HTML data (e.g., including metalanguage tags that provide the reference to the finished product) so that when the second user 118 receives the email and views it on a device 120, the referenced finished product can be retrieved for static or interactive viewing.

Instead or in addition, the actual digital data of the referenced finished product can be embedded directly into the email itself. This results in an email that is considerably larger in size, but eliminates the need to later retrieve the finished product. In another exemplary embodiment, the synthesis subsystem 164 can be embedded directly into a device 120; that device 120 can synthesize the finished product. The actual digital data of the referenced finished product can be embedded by the device 120 directly into the email and the native email system of the device 120 can be utilized for email transmission of the finished product.

In yet another exemplary embodiment, the device 120 can transmit a reference to the synthesis descriptor and at least one variable attribute necessary to synthesize the finished product to the application subsystem 162. The application subsystem 162 can associate an identifier with said synthesis descriptor and at least one variable attribute, store this association in a memory for later retrieval, and transmit the associated identifier back to the requesting device 120. To deliver the finished product via email to a second user 118 without transmitting the actual digital data, the requesting device 120 includes this identifier in the email so that it can be used later by the second user 118 to retrieve the finished product by transmitting the identifier in a subsequent request to the application subsystem 162 to retrieve the associated finished product. In an exemplary embodiment, the identifier can be a URL that can be embedded in an email so that when the email is viewed by the second user 118, the URL automatically retrieves the finished product for viewing. The URL, when received by the application subsystem 162, is recognized as being or containing an identifier that can be used to retrieve the referenced finished product. The identifier can be used to query a cache that may contain an already synthesized finished product. If the finished product cannot be found in a cache, the identifier can be used to retrieve from the memory the associated synthesis descriptor and at least one variable attribute; those can then be transmitted in a request to the synthesis subsystem 164 to synthesize the finished product. Once the product has been synthesized, it can be associated with the identifier and added to a cache for subsequent retrieval. Finally, the finished product can be delivered back to the requesting device that provided the URL from the email.

Other web services 176 generally developed by third-party companies can request services of the various central systems 160. In general, such requests are received by the API subsystem 172, validated, logged, and routed to the appropriate other central systems 160 for further processing.

One or more databases 180 provide for storage and organization of a wide variety of data used by the central systems 160. Each such database can exist in a variety of forms including, but not limited to, one or more associative databases, relational databases, XML files, configuration files, or CSV files (i.e., Comma-Separated Values). In an exemplary embodiment, information can be stored in a relational SQL (i.e., Structured Query Language) database, e.g., such as that provided by MySQL™. The users & privileges 182 database stores basic information associated with each user. This can include basic identification information, authentication credentials, gender, age, birth date, email addresses, physical addresses, billing information, credentials to external systems, access rights, personal preferences, communications opt-in preferences, social graphs, or any variety of additional information that enables the central systems 160 to offer a rich user experience. The application subsystem 162 can utilize this information to determine which digital products or categories of digital products are likely to be the most relevant for the current user 110. It can also be used to determine what types of individualization may be of most interest or most relevant. It can also be used to communicate with second users 118 who are in the current user's social graph or directly specified by the user 110.

The synthesis templates database 184 can store information pertaining to each digital product supported by the system. The information for each synthesis template can include a unique identifier, a name, a description, information about the most common variable attributes, declarative instructions for synthesizing finished products, procedural instructions for synthesizing finished products, references or parameters for external services, references to content in the content database 188, references to external data files, or other information that can be used to synthesize finished products for the digital product described by the synthesis template. The groups & sequences database 186 can store information pertaining to logical sequences of digital products, logical groupings of digital products, or logical groupings of logical sequences. Every node in a logical sequence can reference multiple subsequent nodes, effectively creating a tree of possible sequences whereby any navigational path from the sequence root to any end node in the tree represents one logical sequence. The content database 188 can store information describing a wide variety of data needed to synthesize finished products. Each record in the content database 188 can include the actual content, or can include a reference to an external data file or an external data source from which the content can be retrieved. In addition to the content references, each record of the content database 188 can include other metadata describing the corresponding content, e.g., the author(s), owner(s), copyright information, licensing information, background story, or the content in its original, unmodified form.

The transactions database 192 can store information on a wide variety of historical information including past purchases, login or logout requests, previously synthesized finished products, attributes used to produce synthesized finished products, changes to groups or sequences, destinations for finished products, marking digital products, finished products with ratings or favorite status, or other transactional information that can be utilized by the system. This information can be used to provide current or future services or end user experiences. It can be analyzed to assess the system overall and inform changes and improvements.

In one exemplary embodiment of the digital product synthesis system 100, manufacturing systems 150 receive requests to produce physical products that are at least in part derived from the digital finished products produced by the synthesis subsystem 164. A wide range of digital printers 152 as noted previously can be utilized to produce printed goods from digital finished products, particularly those that are in the form of digital images. In some exemplary embodiments, finished products are first transformed to a digital format suitable for the specific manufacturing system 150. Finished digital products that contain descriptions of three dimensional (3D) objects can be transmitted to fabricators 154 that produce physical 3D objects. Such fabricators 154 are typically called rapid prototyping machines or 3D printers. Future uses of the digital product synthesis system may include digital products that describe substantially different finished products such as 3D renderings, interactive movies, virtual worlds, nanotechnology devices, molecular structure, DNA sequences, instructions for robots or robotic toys, electronic circuits, designs for toy fabrication, folding instructions for making 3D objects from paper products, or instructions for controlling any variety of electro-mechanical machinery.

The synthesis subsystem 164 is designed to accommodate such future classes of digital products by the addition of new specialized components as standardized modules, much as new styles of LEGO® blocks enable the creation of new types of LEGO® structures that nevertheless also incorporate earlier styles of blocks. Many of these future finished products can be used to instruct a wide variety of manufacturing systems 150 to produce physical articles. Each finished product can also include additional information that facilitates user interaction with the finished product, effectively creating a feedback loop that enables a plurality of interaction and synthesis cycles. As an example, when a textual message has been integrated into a digital image, the location of each character in the text would normally be lost or at least unspecified in an externally accessible way. If the finished product also includes metadata that describes the area in two dimensional or three dimensional space occupied by each character, it would be possible for a user interaction system to provide a visual representation for selecting individual characters directly in a view of the digital image or for providing visual feedback on which individual characters are selected. Once selected, such characters could be edited in some way, such as deleted, dragged, changed in size, copied to a clipboard, justified, or otherwise manipulated.

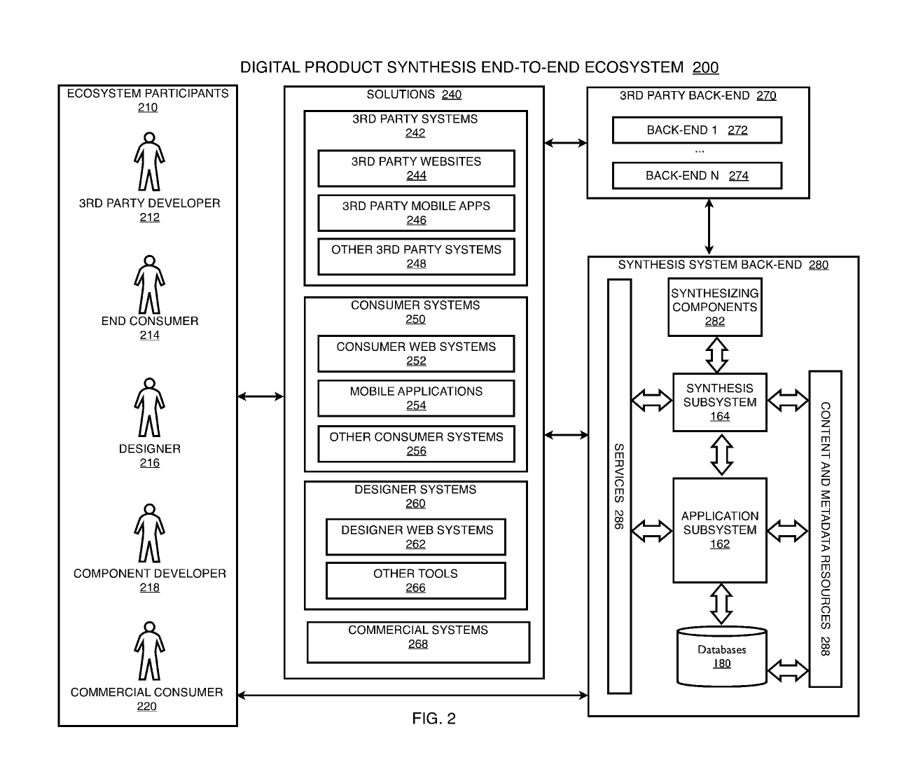

### FIG. 2

FIG. 2 illustrates schematically examples of how each of the various types of ecosystem participants 210 interact within the digital product synthesis end-to-end ecosystem 200. Ecosystem participants 210 typically can employ a variety of solutions 240 that provide for user input and output for interacting with a particular service. However, typically solutions 240 are operatively coupled with the synthesis system back-end 280 indirectly through services 286 that serve as a gateway. This gateway can provide validation, authentication, load balancing, caching, throttling, blocking, or other services for requests that are then optionally transmitted to the application subsystem 162 or the synthesis subsystem 164.

A third-party developer 212 can be any developer who develops third-party systems 242 that operatively couple to the synthesis system back-end 280. Typically, a third-party developer 212 can develop a third-party system 242 that provides a service for use by other ecosystem participants 210. The service can be intended for use by one or more among other third-party party developers 212, end consumers 214, designers 216, component developers 218, or commercial consumers 220. Third-party systems 242 also can provide services intended for use by other solutions 240, particularly, other third-party systems 242 developed by other third-party developers 212. Exemplary forms of third-party systems 242 can include website services 244 that offer additional web experiences that are coupled to the synthesis system back-end 280 to transmit requests and receive responses. Third-party developers 212 also can provide third-party mobile apps 246 that provide mobile experiences that are operatively coupled to the synthesis system back-end 280. Instead or in addition, third-party systems 242 can be operatively coupled to third-party back-ends 270 which in turn are operatively coupled to the synthesis system back-end 280. Other third-party systems 248 can include user agents, background daemons, desktop applications, kiosks, consumer electronics, or a wide variety of other devices or systems that are operatively coupled to third-party back-ends 270 or directly to the synthesis system back-end 280. In one exemplary embodiment, a third-party system 242 can receive a first finished product from the synthesis system back-end 280 and further process the first finished product to produce a second finished product before transmitting said second finished product to an ecosystem participant 210.

An end consumer 214 can be any person whose primary use of the system at any one time is to personally employ the services provided by solutions 240, and most generally services provided by consumer systems 250. Examples of consumer systems 250 provided primarily for use by an end consumer 214 can include consumer web systems 252, e.g., the pijaz.com website, the Pijaz (frame application for Facebook®; mobile applications such as the Pijaz iPhone® and iPad® applications. Ecosystem participants 210 typically can employ consumer systems 250 for a variety of services, including but not limited to: logging in to the system; logging out of the system; searching for digital products; browsing digital products; marking digital products as favorites; viewing recently used digital products; rating digital products; viewing social graphs; viewing sequences of digital products; selecting digital products; specifying or transmitting the values or the sources of values for at least one variable attribute of a digital product (using a variety of physical controls, digital controls, virtual controls, rss feeds, web services, external systems, touch screens, text edit fields, graphic tablets, serial ports, flash drives, bluetooth devices, audio recorders, digital cameras, video cameras, 3D capture systems, or other input device that can capture input directly or indirectly from an external source); previewing proxies of digital products (which can include low fidelity rough approximations of a finished product, reduced resolution versions of a finished product, digital representations of a physical finished product, or substantially identical to the actual finished product); requesting the synthesis of a finished product; providing information for transmitting the finished product to other systems or persons (including third-party back-end 270 systems, solutions 240, or ecosystem participants 210; specifying personal attributes (e.g., gender, age, likes, dislikes, hobbies, social graphs, preferences, location information, identifying information, credentials for other systems, or billing information). Future other consumer systems 256 can include systems such as a digital product synthesizing service within a Macintosh® or Windows® PC desktop application, a set-top box operatively coupled to a television, or a game console such as Nintendo® Wii® or Microsoft® Xbox®, a kiosk, or a custom embedded system for use in theaters, at amusement parks, or other locations where digital product synthesizing services provided by the synthesis system back-end 280 might be desired.

A designer 216 can be any ecosystem participant 210 whose primary use of the system at any one time is to design digital products, manage designed digital products, and analyze the use of designed digital products. In general, a designer 216 also can function as an end consumer 214 at different times (or perhaps even intermixed). Until synthesizing components 282 exist for system uses other than the synthesis of images, image sequences, or videos, a designer 216 typically can be one or more of: an artist using traditional physical media such as canvas, paper, oil, watercolor, pencil, charcoal, clay, metal, or any other two dimensional or three dimensional materials or tools to produce a work of art; a photographer using a film or digital camera; a graphic designer using computer software such as Adobe® Illustrator®, Adobe® Photoshop®, or any of a variety of other software systems designed for the creation of digital designs; or any person using a combination of the above systems for the creation of designs. In the event that a physical design is created, a digital apparatus such as a digital camera, a flatbed scanner, a 3D scanner, or other type of input device can be employed to generate from a physical object a computer readable digital description, rendering, representation, or approximation of that physical design.

A designer 216 can employ designer systems 260 for: creating new digital products; specifying how to produce a finished product from a digital product comprising a synthesis descriptor and at least one variable attribute; retrieving, modifying, and storing digital product synthesis descriptors; managing monetization policies for digital products; managing usage policies and parameters for digital products; creating sequences or groups of digital products; retiring digital products; submitting a wide variety of content such as images, fonts, 3D models, videos, or audio that can be referenced by digital products; reviewing histories of how digital products have been used by other ecosystem participants 210 to synthesize finished products; or reviewing revenues generated by the use of digital products to synthesize finished products.

Designer web systems 262 can provide services to accomplish one or more of the above mentioned functions and are operatively coupled to the synthesis system back-end 280 for transmitting first requests. These first requests can be signaled directly to synthesis subsystem 164 or application subsystem 162, however, these first requests can typically, but not necessarily, be transmitted to services 286, which in turn can transmit all or a portion of the first requests in the form of at least one second request to at least one of synthesis subsystem 164, application subsystem 162, or at least one other synthesis system back-end 280 system or component. Any of these system back-end 280 components can in turn signal third requests to third-party back-end 270 systems to process at least a portion of the first or second requests. Responses to these first, second, or third requests can be transmitted back to designer systems 260. These responses can contain one or more pieces of digital information for further processing by the designer systems 260. As an example, a designer web system 262 can request a preview of a digital product currently under design by a designer 216. This preview request can include a reference to a synthesis descriptor and at least one variable attribute and can be transmitted to a service 286 which in turn signals the synthesizing components to synthesize the requested preview finished product. Some signaled requests might produce no responses; some signaled responses can be ignored.

A component developer 218 generally can be a person who develops and deploys additional synthesizing components 282 to add additional functionality to the synthesis subsystem 164. In combination synthesis components 282 enable the synthesis subsystem 164 to perform a wide variety of tasks spanning many fields of endeavor. The synthesis subsystem 164 can be designed to accommodate a wide variety of future processing capabilities that might not be integrated initially, including future capabilities that have not yet been envisioned. The flexibility of the synthesis subsystem 164 is one novel aspect of the systems and methods disclosed herein and described in more detail below.

Examples of synthesizing components can include but are not limited to: digital image processing components (e.g., for algorithmic image creation, applying Fast Fourier Transforms (i.e., FFTs), adding or deleting alpha channels, tweening, adding drop shadow, cropping, changing color mode, masking, feature detection, object detection, pattern matching, detecting perspective, detecting 3D, creating stereoscopic images, analyzing, blurring, arching, concatenating into a video stream, composing a series of glyphs onto contiguous or non-contiguous 2D and 3D paths, merging, transforming, adding perspective, scaling, resampling, anti-aliasing, smoothing, adding noise, sharpening, changing contrast, changing saturation, changing hue, rotating, rendering to a 3D curved surface, colorizing, area filling, texture mapping, swirling, filtering, distorting, pixelating, posterizing, retrieving from external sources, transmitting to external destinations, or any of a wide variety of other common or novel hardware, software, or combinations thereof for manipulating digital image data); text processing components (e.g., for spell checking, adding or deleting text, concatenating, changing capitalization, word or letter replacement, word splitting, algorithmic creation, retrieval from external sources or databases, auto word completion, transforming into 3D models, transforming into digital images, pattern matching, searching, letter counting, word counting, looking up referenced external text, or any of a wide variety of other common or novel hardware, software, or combinations thereof for manipulating digital text); audio processing components (e.g., changing amplitude, changing pitch, changing tempo, adding or deleting segments, filtering, applying FFTs, resampling, analyzing, pattern matching, concatenating, merging with video, extracting from video, or any of a wide variety of other common or novel hardware, software, or combinations thereof for manipulating digital audio data); 3D synthesizing components (e.g., for rendering to 2D, extruding, convolving, applying radiosity methods, rotating, distorting, flattening, transforming, spherizing, reflecting, generating caustics, shading, texture mapping, manipulating depth of field, tinting, flat shading, phong shading, gouraud shading, adding text, scrolling, moving, bump mapping, cel shading, projection, ray tracing, object creation, union or intersection of objects, motion blurring, generating lens flare, generating particle systems, compositing, subsurface scattering, volumetric sampling, or any of a wide variety of other common or novel hardware, software, or combinations thereof for manipulating digital 3D data); process flow control and instruct components (e.g., split, conditional branch, jump, switch, loop, repeat until condition, sort, pause, resume, stop, cancel, reset, random number generation, execute sub-process, execute thread, authenticate, de-authenticate, transmit data, receive data, return from sub-process, monitor for signal, awake upon signal, transmit signal, queue, dequeue, stack, unstack, execute external process, create instruction sequences, execute instruction sequences, execute scripts, execute binary code, signal data to external systems, control or instruct external electronic or electro-mechanical devices or systems, or any of a wide variety of other common or novel hardware, software, or combinations thereof for controlling and instructing process flow); binary logic components (e.g., and, EOR, OR, NOR, NOT, clock, decode, encode, flip flop, memory, adder, multiplier, arithmetic unit, CPU, gate array, or any of a wide variety of other common or novel hardware, software, or combinations thereof for manipulating binary data); a wide variety scientific processing components (e.g., genotyping, SNP analysis, DNA sequencing, remote sensing, digital signal processing, pattern analysis, neural networks, artificial intelligence systems, expert systems, heuristics, language translation, physics simulation, spectrum analysis, chemical bond synthesis, molecular folding, logical deduction, predictive analysis, bayesian filter, solving complex mathematical equations, encryption, decryption, chemical analysis, drug interaction analysis, gene splicing, controlling external scientific electro-mechanical equipment, sensing data inputs, emitting data outputs, or any of a wide variety of other common or novel hardware, software, or combinations thereof for conducting scientific processes). A person skilled in the art will recognize that a synthesis component can perform practically any human endeavor that can be represented or transmitted digitally.

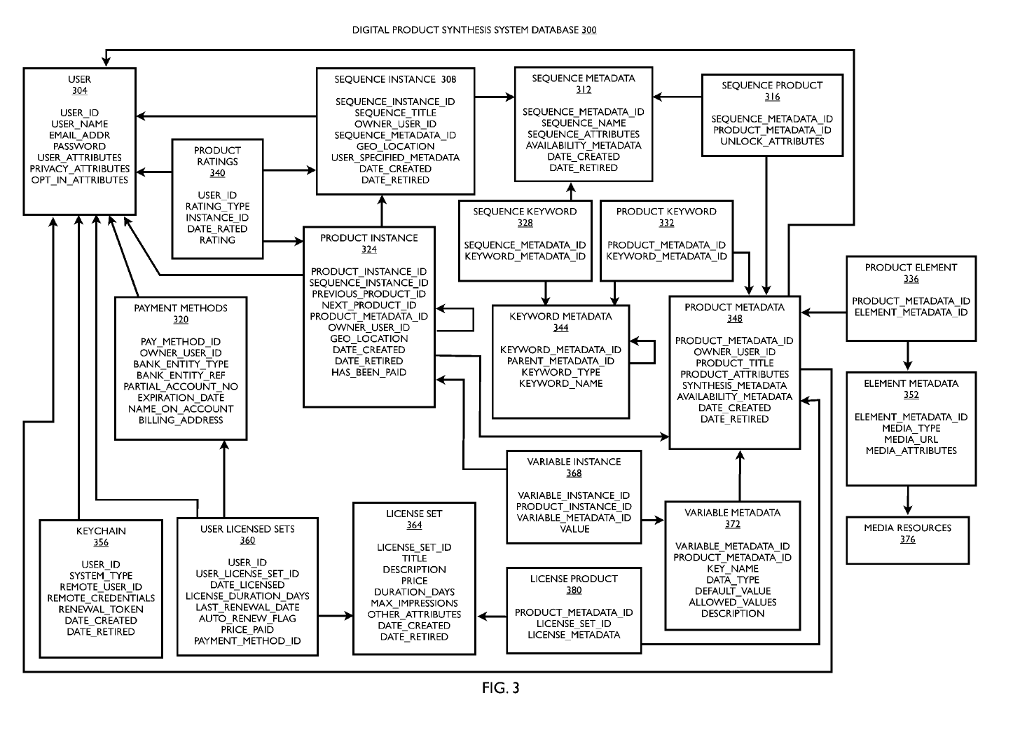

### FIG. 3

FIG. 3 illustrates schematically an exemplary embodiment of the Digital Product Synthesis System Databases 300, showing the relationship between various key types of information that can be utilized by the Digital Product Synthesis System 100. One skilled in the art of database design will readily recognize that the managed information can be organized in any of a variety of suitable ways to accomplish similar objectives with varying degrees of efficiency and flexibility. The present disclosure describes the information being managed in terms associated with a relational database as an exemplary embodiment; however, one skilled in the art will readily recognize that the information can be managed using any variety of information management strategies. One alternative can include managing the data as stored <key,value> pair associations, as is becoming increasingly common.

The User Table 304 can store general information about every user known to the system. A user can be anonymous until said user self identifies. In the anonymous case, the user can be identifiable only by a unique identifier that persists in another location (e.g., in the form of an HTTP cookie on a client computer). Once a user self identifies, it is possible to interact with the user in more meaningful ways, such as sending email notifications. Each user record in the User Table 304 can be associated with zero or more keychain entries in a Keychain Table 356. Each keychain entry can provide credentials for authenticating against another system such as Facebook®, Twitter®, or Google+®. Each user record can also be associated with zero or more payment method entries in a Payment Methods Table 320. Each entry describes one method for providing payment for services. Actual charges for uses of the system can accumulate externally before a payment transaction is initiated to cover those charges. Zero or more product ratings records can exist in the Product Ratings Table 340 for each user record in the User Table 304. Product ratings can record each rating that a user has provided for any number of Product Instance Table 324 records or Sequence Instance Table 308 records.

Sequence Instance Table 308 records can each describe one story sequence that is being created collaboratively. Each record can reference a Sequence Metadata Table 312 that provides a description of the characteristics of a sequence (e.g., which products are allowed at which points in the sequence or under what circumstances they are unlocked, which could include geo-location or temporal constraints). The Sequence Metadata Table 312 entries can describe an allowed storyline. Story lines can be created individually or collaboratively by one or more users. A story line sequence can draw from any of a variety of products. The products allowed can be constrained by the entries in the Sequence Products Table 316 associated with each entry in the Sequence Metadata Table 312. Sequence Keyword Table 328 can allow any number of hierarchically organized searchable keywords in the Keyword Metadata Table 344 to be associated with each sequence in the Sequence Metadata Table 312.

Each product instance in the Product Instance Table 324 can reference an entry in the Product Metadata Table 348 which can describe the nature of the product represented by the product instance. Each entry in the Product Metadata Table 348 can hold directly or indirectly all or part of the information needed to synthesize product instances of the product described by the entry. In an exemplary embodiment, much of the information in this and associated tables can be a subset of the information managed in the Synthesis Descriptor File used by the Synthesis System to actually synthesize products. This information can be replicated in part to control the external visibility of metadata for each specific product. Any number of entries in the Variable MetaData Table 372 can be associated with each entry in the Product Metadata Table 348. Each entry can describe one variable attribute that can be provided for the synthesis of the product described by the associated entry in the Product Metadata Table 348. Each entry in the Variable Instance Table 368 can associate one Variable Metadata Table 372 entry with one Product Instance Table 324 entry. The Variable Instance Table 368 entry also can associate a value which is the value used for that variable in the synthesis of that product instance. The set of variable instance values and their associated key names in the Variable Metadata Table 372 can be sufficient to re-synthesize the product instance described by the associated entry in the Product Instance Table 324.

The entries in the License Set Table 364 can describe the attributes of a set of products that are governed by a single license policy. This can represent the basic concept of a “product pack” whereby the user can license the rights to use all of the products in the product pack as a function of the constraints described by this license set. The User Licensed Sets Table 360 entries can associate a License Set Table 364 entry with a User Table 304 entry. This can describe which product packs are currently licensed by which users and what is the payment policy for that license, including which payment method is described by the associated entry in the Payment Methods Table 320. Product Element Table 336 entries can associate any number of Element Metadata Table 352 entries with each Product Metadata Table 348 entries. Each entry in the Element Metadata Table 352 can provide the information for one piece of media used in the construction of one product described by the associated Product Metadata Table 348 entry. This information primarily can be used to ensure all media required are accessible at the time of product synthesis. It can also be used to provide proper attribution for each element in a product. Each entry in the Element Metadata Table 352 can reference Media Resources 376. These resources typically are not stored in a database; they can simply be URLs to resources stored elsewhere, or file paths to media stored on a local hard drive. Product Keyword Table 332 can allow any number of hierarchically organized searchable keywords in the Keyword Metadata Table 344 to be associated with each product in the Product Metadata Table 348.

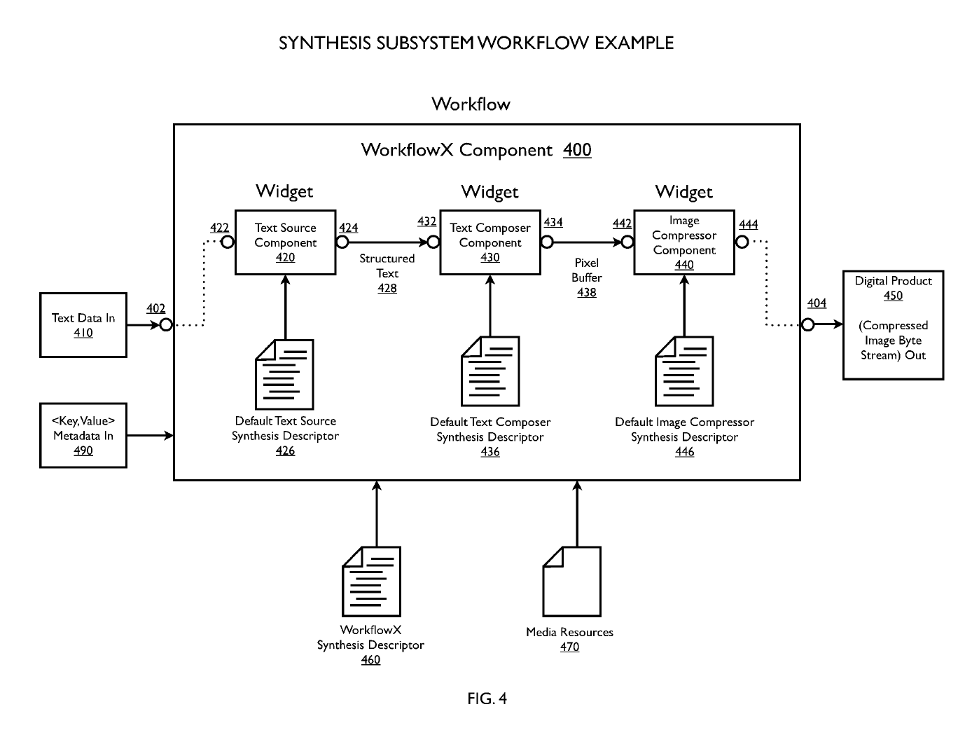

### FIG. 4

FIG. 4 illustrates schematically a simple exemplary synthesis system workflow component 400, in this example called WorkflowX. Such a software component can solicit the work of other software components. In this example, component 400 can solicit the help of the Text Source Component 420, the Text Composer Component 430, or the Image Compressor Component 440. The components 420, 430 and 440 can be considered to be primitive components and can be referred to herein as Widgets. Component 400 is considered to be a composite component and is referred to herein as a Workflow. Note that a composite component 400 is indistinguishable from a primitive component 420, 430, or 440 from the perspective of any outside agents or other components that might solicit the services of a Workflow or a Widget component. This external similarity can enable arbitrarily deep nesting or mixing of Workflows and Widgets. Any of the sub-components 420, 430, or 440 of WorkflowX 400 can in some instances be another Workflow that performs a distinct set of work on behalf of the outer WorkflowX component 400.

Each component 400, 420, 430 and 440 can be designed to perform a specific type of digital work; the work performed can typically consume digital products generated from a different upstream component or from an external agent, and then can typically produce one or more digital products to be consumed by a downstream component or provided to an external agent. In this example, the Text Source Component 420 can produce a Structured Text Digital Product 428, the Text Composer Component 430 can produce a Pixel Buffer Digital Product 438, and the Image Compressor Component 440 can produce a Compressed Image Byte Stream Digital Product 450. Some digital products might only be transmitted between the input ports and output ports of the internal components of a workflow component. For example, the only external input port of this workflow 400 is the input port 402, which is expected to receive text data in 410. Further, the only digital product produced by the WorkflowX workflow that is visible outside of the digital workflow is the compressed image byte stream digital product 450, which is transmitted by the only output port 404 ready for transmission to an external agent, such as a browser client via HTTP protocols. In this scenario, an exemplary embodiment can be to deliver the image byte stream as a web compatible digital image format such as JPEG or PNG. However, different workflows can produce a wide variety of digital products 450, e.g., audio streams, video streams, image streams, 3D meta streams, VRML, CAD, stereo lithographic, page layout formats, page description language, scientific modeling, or any other imaginable format for presenting information digitally, for describing the fabrication of a physical output, or for serving any other useful purpose.

Each component can offer an arbitrary number of input ports or output ports, each belonging to an arbitrary number of port types. In the illustrated example, port 402 is an input port at which is expected a raw text stream, port 422 logically maps to 402 at which is also expected a raw text stream, port 424 is an output port that provides a structured text 428 object, the input port 432 is expected to receive a structured text object 428, the output port 434 delivers a pixel buffer object 438, the input port 442 is expected to receive a pixel buffer object 438, the output port 444 delivers a compressed image data stream (e.g., as a function of the metadata provided by a combination of its own default synthesis descriptor 446, the workflow synthesis descriptor 460, and the metadata 490 provided by the external invoking agent).

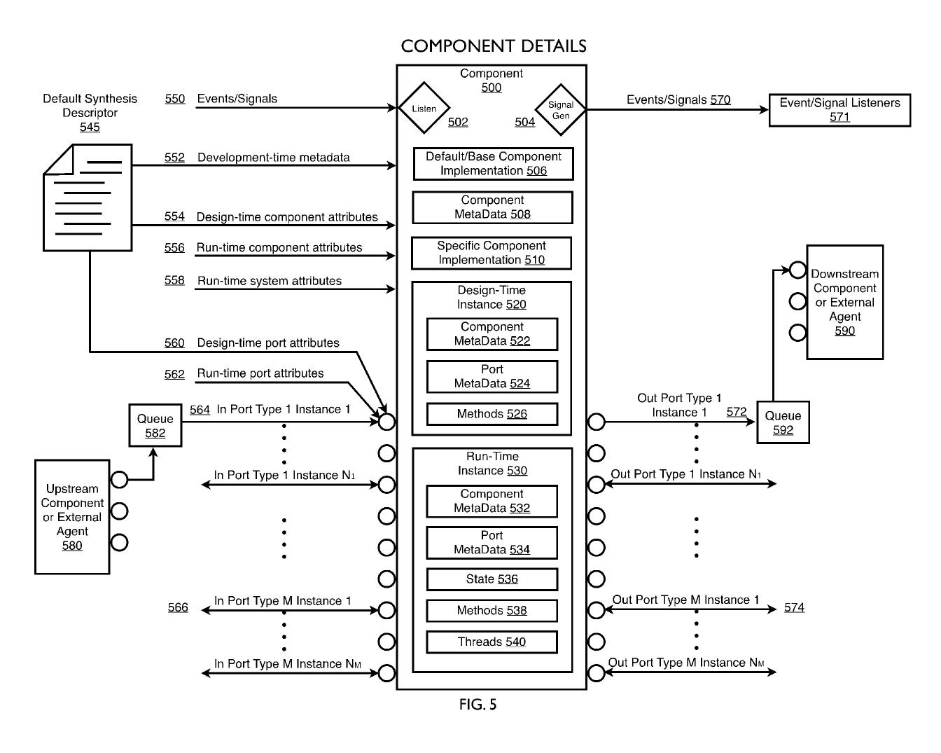

The minimum and maximum number of ports for each port type can be specified by the Default Synthesis Descriptor for each component. Any workflow can connect the ports of any number of components in arbitrary ways to perform the desired work. More details on the inner workings of a component are illustrated schematically in FIG. 5. The default behavior and overall description of a component's characteristics typically can be governed by a metadata file called a synthesis descriptor. In an exemplary embodiment, this synthesis descriptor can be an XML file that can reside in a special directory of all synthesis descriptors where the name of the XML file matches the name of the component, so that it can be automatically loaded and parsed. A synthesis descriptor file is described in more detail below. The actual behavior of a workflow can be governed by the aggregate metadata contained in all the synthesis descriptors for each component 426, 436, 446, and 460, as well as the <key,value> meta data input 490 or any port data 410 provided by the invoking agent. Each level of external inputs can override default behavior described by internal synthesis descriptors. All metadata can reference external media resources 470 that are used to perform the work. External media resources can include digital data such as images, audio, movies, text, metalanguage instructions, or any other data useful or suitable for performing work. External media resource references typically can exist as file path descriptors or URLs that reference resources available via protocols such as HTTP or RSS (i.e., Rich Site Summary). However, metadata can also reference media resources through other identification strategies as well.

### FIG. 5

FIG. 5 illustrates schematically exemplary details of a single component 500. Much of the default behavior of a component can be provided by a base implementation 506 combined with a default synthesis descriptor 545. In an exemplary embodiment, the base implementation can comprise a C++ class that reads the default synthesis descriptor XML 545 for this component and then populates many of the C++ instance variables containing the component metadata 522 and port metadata 524. Helper class instances can also be included that can manage some or all of the information provided by the metadata and can govern the behavior of many of the object's design time methods 526 or run time methods 538. A component typically can manage a single design-time instance object 520 and an arbitrary number of run-time instance objects 530. Only a single design-time instance object typically is needed because it typically is static for the life of the component 500. However, multiple instances of a workflow that uses this component can be running simultaneously, in which case more than one run-time instance 530 is required, i.e., one for each running workflow. A component developer is not necessarily required to use the default component implementation 506; instead, the component metadata 508, the design-time component metadata 522, the design-time port metadata 524, the run-time component metadata 532, and the run-time port metadata can come from any source. In some instances it can be hard wired into the design of the component; in other instances it can come from external sources such as an external development-time metadata resource 552, an external design-time component attributes source 554, or an external design-time port attributes source 560.

In addition to the default component implementation 506, for a component to provide the desired functionality, typically it also should provide a specific component implementation 510 that provides the unique functionality of the component. For example, an image scaling component typically can include software instructions, e.g., for accepting an image pixel buffer from one of the input ports 564 and 566, accepting scaling instructions from the design-time component attributes 554, transforming the pixel buffer into a new pixel buffer that has either more or fewer pixels in the X or Y dimensions, or providing the scaled pixel buffer to one of the output ports 572 and 574. A component that can perform work that can be run in parallel to increase throughput can be instructed to spawn one or more threads 540 to assist in performing the work. In the example of an image scaling component, it can divide the pixel buffer into four quadrants and spawn four threads to independently scale each of the four quadrants. Each component can offer any suitable number of input ports 564 and 566 of any suitable number of port types. Each port type is expected to receive a corresponding type or one of a set of types of incoming data. For example, one port type might be expected to receive raw text, another might be expected to receive an image pixel buffer, and yet another might be expected to receive a video stream. Each component can also offer any suitable number of output ports 572 and 574 of any suitable number of port types. Each port type produces a certain type of outgoing data. The exact number of instances of each input and output port type to be used in one workflow is determined at workflow design time where components are operatively linked to one another within a workflow. This linking can be described by the workflow-specific metadata for a workflow component.

Each input port 564 can be attached to its own queue 582 that receives information from an upstream component or an external agent 580 that provides the correct data in the queue. Each output port 572 can be attached to its own output queue 592 that receives the data appropriate for the port type and queues that data for the next downstream component or external agent 590. Each entry in the queue typically can provide one primary data object of a corresponding correct data type as well as an arbitrary amount of metadata that may be useful to the downstream component. Note that except for queues attached to external agents, the output queue of one component can often also function as the input queue to another component. An example of a component that can have more than one instance of an in port type 564 is an audio mixer that can mix any number of audio input streams into one audio output stream 572. A more elaborate example would be an audio mixer component that supports stereo. Such a stereo audio mixer can support any number of left channel audio inputs 564 and any number of right channel audio inputs 566, and typically would support one and only one output left channel 572 and one and only one output right channel 574. In these examples, the design-time port attributes 560 can specify a variety of audio mixing instructions such as the level of attenuation to apply to the incoming audio stream on each port.

At run-time, a component can receive a wide variety of inputs that govern how it functions. For example, it can receive a wide variety of component attributes 556 that determine how the component functions, system attributes 558 that describe the environment in which the component is running (e.g., the current time, a job identifier, the name of the workflow, or the IP address(es) of the computer system), or port attributes 562 that determine how each port functions. Each component 500 can establish event listeners 502 that can listen for external events 550 and react accordingly. Each component 500 can also trigger events 504 that can transmit one or more signals 570 to one or more other listeners 571. Signals can be used, e.g., to notify of queue full or queue empty conditions, or to allow for any nature of asynchronous signaling between components. A component 500 typically can manage one design-time object 520 and any number of run-time objects 530. The design-time object 520 can manage component metadata 522 or port metadata 524, and can provide a number of methods 526 to access and establish this metadata. The data managed by this one design time instance 520 typically is static during the life of the component 500; however, while a design is actively being changed, this data might be allowed to change during the life of the component 500. Each run-time instance 530 can represent some or all of the run-time metadata specific to this instance, for example the incoming <key,value> pairs provided by the run-time component attributes 556 received from the invoking agent. Each run-time instance 530 can also hold various state information 536 during run-time. Each run-time instance 530 provides a series of standard methods that are invoked externally to perform work. More specifically, once all the inputs are primed, an execute( )method is invoked to actually perform the work that this component is intended to perform.

### FIG. 6

FIG. 6 illustrates schematically the components of an exemplary self-contained Product Synthesis Device 600 that enables a User 110 to synthesize a Finished Product 112. The exemplary Product Synthesis Device 600 comprises Inputs 620, Outputs 630, one or more processors 640, one or more types of memory 650, a synthesis system 660, one or more synthesis descriptors 670, and digital content 680. Inputs 620 are used for accepting variable information from the user 110. The general flow can be as follows. A processor 640 executes instructions in memory 650 that guide the synthesis of a finished product 112 as a function of inputs 620. Inputs 620 gather variable information from the User 110 using input devices such as keyboard, mouse, camera, microphone or touchscreen. Inputs 620 can also include automated sources of information from other external sources such as might be available over a network, including, e.g., variable information such as news, stock market statistics, weather, or social network feeds. The input variables are transmitted to the Synthesis System 660 to synthesize a Finished Product 112. The Synthesis System 660 uses the input variables to select a Synthesis Descriptor 670. The input variables and the synthesis descriptor can reference any number of digital content 680 items. The selected Synthesis Descriptor provides further instructions on how to synthesize the Finished Product 112. The Synthesis System 660 utilizes the input variables, the synthesis descriptor, and referenced content 680 to synthesize a digital finished product 112 that typically resides in its entirety in memory 650; however, more complex finished products might need to be synthesized in subsets that are transferred out of memory 650 in stages so that the entire finished product never exists at one time in memory 650. An example of this would be the synthesis of an audio stream, which while being played to a user has portions of digital audio information deleted from memory after each such portion of the audio stream has been played. The Finished Product 112 typically is then output to the user via one or more Outputs 630, e.g., digital screens, projectors, speakers, external storage devices, networks, printers, 3D fabricators, or any other suitable output device that can be instructed by a digital data stream. The Finished Product 112 can be comprised of a digital data stream 114 such as a digital image, video or audio stream. It can instead or in addition comprise a physical product 116 such as printed photograph.

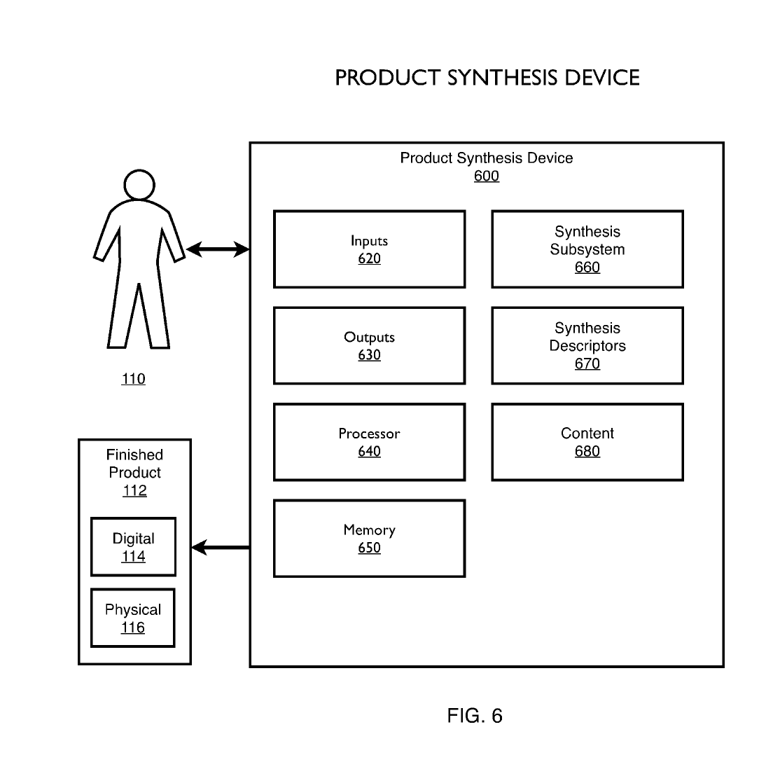

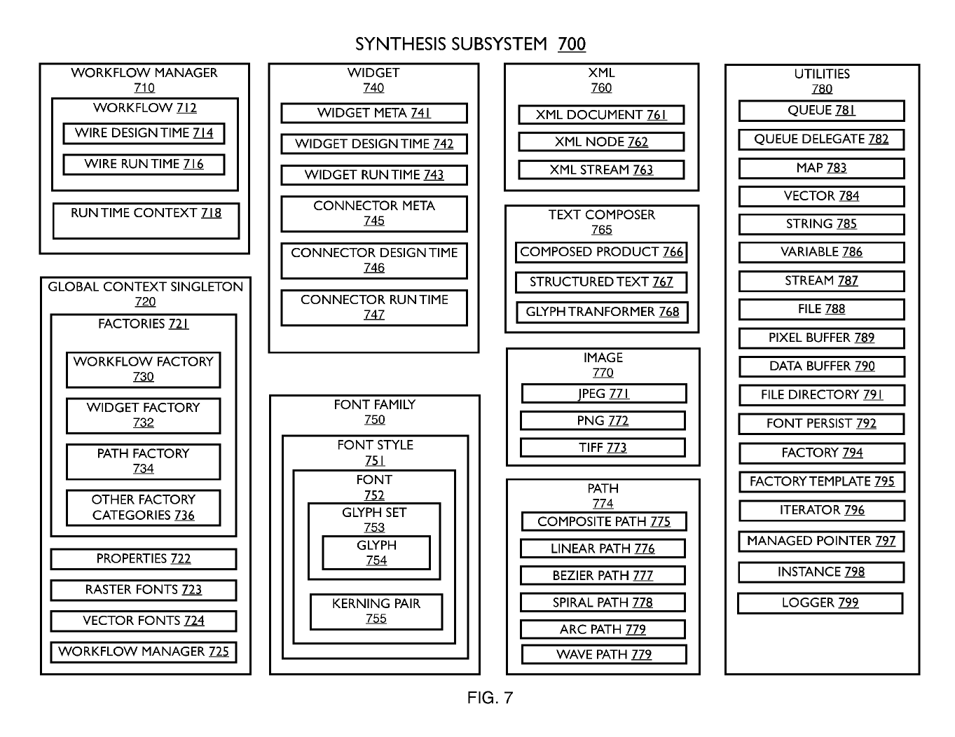

### FIG. 7

FIG. 7 illustrates schematically the various primary components of the exemplary synthesis system 700. The synthesis system 700 comprises a variety of categories, each comprising a variety of objects. In an exemplary embodiment, these objects can be implemented as C++ classes that each obey one or more pure abstract C++ interfaces. In many cases, only pointers to interfaces are passed as references between method calls to different objects. This strategy hides all implementation details and increases object re-usability and separation of responsibility. In an exemplary embodiment all C++ classes can utilize a reference counting methodology for tracking object references and object self-deletion when the reference count indicates no more references are outstanding. The Workflow Manager 710 can manage all workflows known to the system; it can be responsible for managing workflow objects 712, reloading changed workflow objects, or executing workflows. Each workflow 712 can be executed to perform its intended work. A workflow can be considered effectively also to be a widget 740, so all information relating to a widget 740 typically also is relevant for a workflow 712. A workflow can effectively encapsulate any number of other widgets or workflows into a single work unit that can function as if it were a widget. This can enable an arbitrarily deep nesting of workflows to perform more complex work, and can enable reuse of workflows that perform a common function.

Workflows can be considered distinct from widgets in that they also manage connections between widgets; such software-based connections or links are also referred to as wires. Each workflow 712 can manage wire design time 714 objects or wire run time objects 716. Wire design time 714 objects can manage information about which two widgets are connected by the wire or design attributes such as a unique label for the wire, or plotting locations for the wire when being presented to the user visually. Wire run time 716 can manage information needed at run time such as the queue that the wire represents to hold information flowing from the upstream widget to the downstream widget. The workflow manager also can create a run time context object 718 which is used to provide services during widget and workflow execution that span the entire task. One example of a service of the run time context object 718 is to provide a variable resolver delegate which can strategically replace specially marked variables throughout the synthesis descriptor with input variables provided in the form of a <key,value> pair associative map. This is one of the key ways in which external variables influence the behavior of a workflow.

The Global Context Singleton 720 typically is the first point of contact from outside programs and agents attempting to utilize the Synthesis System. It can provide a number of services to give access to necessary resources. It can provide a number of factories 721 that instantiate a wide variety of objects. In an exemplary embodiment, the unique object type can be identified by a textual identifier commonly referred to as reverse dot notation. This type of identifier minimizes ID collision without the need for a central authority issuing IDs, even if multiple third-party component developers each choose their own IDs. Each factory also can declare an object category which identifies the primary interface provided by the objects created by that factory. This identifier also can be a reverse dot notation text identifier in an exemplary embodiment. This category can allow factory items to be grouped into sets as a function of the functionality they provided. Different factories of different categories can instantiate the same class of object if that class of object provides more than one interface. The global context singleton 720 can offer a service for registering new object factories that can be identified by a reverse dot notation type and category. The global context singleton 720 also can provide an iterator 796 for iterating all factories of a specific category. Some examples of categories of object factories include workflow factories 730, widget factories 732, or render path factories 734. Given the reverse dot notation system of specifying categories, a wide variety of other factory categories can be supported, including ones not yet conceived of. The global context singleton 720 can provide an arbitrary set of properties 722 that exist as an associative array of <key,value> pairs. The global context singleton 720 also can manage and provide access to all installed raster fonts 723 or all installed vector fonts 724. It also can control the workflow manager 725 singleton and provide access to it.

Among important components of the synthesis system 700 are widgets 740. Any number of widgets can be installed and managed by the system. Each one can register itself with the global context singleton 720 so that it can be instantiated at any time by its type identifier. A substantial portion of a widget's default behavior can be provided by a base class that is governed, e.g., by an XML synthesis descriptor file. A widget can manage a variety of meta data about itself 741 and further provides access to a widget design time object 742. When an external agent requests to run a widget, the widget object can instantiate a widget run time 743 object to manage a running instance of the widget. That run time object can hold some or all necessary state information for performing its intended work. Widgets also can connect to other widgets via input and output connectors. The nature of each type of supported connector for a widget is described by connector meta 745 objects. The design time instantiation of each instance of each connector type can be provided by connector design time 746 objects. The instantiation of each instance of each design time connector at run time can be provided by connector run time 747 objects. These run time connectors can provide the necessary state and connectivity information for data to flow from one widget to the next at run time.

An important element of the synthesis system is its ability to render textual messages in arbitrarily complex ways into a composite image. To support this composition, the synthesis system can provide support for two types of fonts, vector fonts and full color raster fonts. The vector font support can map to any variety of existing vector font formats such as TrueType® or PostScript®. Raster fonts are a proprietary format of the synthesis system. Both raster and vector fonts are abstracted to appear and function the same across the synthesis system. Each supported font is packaged in a font family 750. A font family can support any number of font styles 751 such as plain, bold, italic, bold-italic, and any of a variety of less familiar styles that can be appropriate for specialized raster fonts. Within a font style 751, any desired or needed number of fonts can exist at various point sizes. The system can choose the most optimal font size based on the specified desired size. Within a font 752, there exists a glyph set for each supported character code or each unique sequence of character codes. In an exemplary embodiment, character codes can be arbitrary textual unicode strings. This can allow certain sequences of characters to translate to a single visual glyph. Familiar examples of this include emoticons wherein sequences of characters such as “:-)” are recognized to render a single glyph of a smiley face instead of three glyphs consisting of a colon, a dash, and a right parenthesis. However, this methodology is not limited to emoticons and can be used to provide special images for any sequence of characters. The glyph set 753 manages any needed or desired number of glyph 754 variations. The raster fonts often can be employed for simulating real-world, varying letter shapes, such as a hand-written chalk font. A real hand-written chalk message on a chalkboard would have variations among repeated occurrences of each letter. When retrieving glyphs, a round-robin or other selection strategy can be used to deliver the next glyph 754 variation within a glyph set 753. Certain glyphs when rendered next to each other will appear too close to or too distant from each other when using the nominal character spacing. To correct this, a font 752 can provide a horizontal spacing correction for any pair of glyphs. This is called a kerning pair and is managed by a kerning pair 755 object.

The exemplary synthesis system 700 can make heavy use of one or more structured data formats, e.g., XML. To abstract what underlying XML tools or other structured data format tools are used, objects are provided that in turn provide XML services throughout the system. The XML document 761 can manage a complete XML text stream. The XML document can be responsible for parsing an XML stream 763 and providing the root XML node 762 object. Each XML node object 762 can provide attributes, text, and child XML objects. In an exemplary embodiment, the underlying XML technology is an open source project called xerces-c.

The synthesis system 700 can include a comprehensive text composition service via the text composer 765 object. The text composer 765 can be configured by synthesis descriptor which in an exemplary embodiment is an XML fragment with a root tag of <composer>. This synthesis descriptor can fully describe how any or a variety of text inputs or other digital image inputs can be employed to render text into a composite output image. The text composer then can accept an arbitrary number of structured text 767 input objects managed by a composed product 766 object. The composer can solicit the services of any variety of external objects to perform its work. The first such category of external objects are glyph transformers 768. Glyph transformers can be specified by a unique identifier (e.g., their reverse dot notation textual identifiers) which can be used to instantiate the desired glyph transformer utilizing the appropriate factories 721 of the global context singleton 720. Glyph transformers can be chained together to transform a glyph in multiple different ways before the glyph is rendered. The text composer 765 can produce output digital images that are encapsulated in a composed product 766 object. To facilitate the support of any variety of popular image formats, an abstract image 770 interface can be provided for use throughout the system. Any number of image formats can be supported. Currently the system supports JPEG 771, PNG 772, and TIFF 773 image objects.

The text composer 765 can support rendering text along an arbitrary path 774 of arbitrary complexity, including paths with disjoint segments. The text composer 765 also can support a second top-line path that can determine the polygon area to be used to render each glyph. To provide support for arbitrary paths, they can be abstracted by a path 774 interface. Each path can provide an x, y, and z coordinate for any position on the path as well as the arctangent angle of the curve at that position. There are a wide variety of paths that can be implemented by the path 774 interface. Each path type can be specified by its unique identifier (e.g., its reverse dot notation type identifier) that can be used to retrieve the correct path factory 734 from the global context singleton 720. Although new path types can be added at any time in the future, the currently supported path types are a composite path 775 which is any arbitrary sequence of paths of any supported type including other composite paths, a linear path 776 which describes a straight line in 2D or 3D space, a bezier path 777 which describes a bezier curve, a spiral path 779 which describes a spiral of specific number of revolutions, pitch, and start angle, an arcuate path 779 which describes an arbitrary arc of a circle, or a wave path 779 which describes a sine wave of specified start phase, frequency, amplitude, and number of periods.

A variety of utility objects 780 can be provided to support the rest of the system. The queue 781 class can provide a standard FIFO queue of arbitrary objects. The queue delegate 782 object can allow other objects to be notified of queue empty and full conditions. The map 783 class can provide a <key,value> associative array for managing an arbitrary object type. The vector 784 class can provide array management of an arbitrary class of objects. The string 785 class can manage unicode strings. The variable 786 class can manage an arbitrarily complex nested structure of primitive types, maps, and vectors. This class can be modeled after the JavaScript Object and the variable 786 class can provide services for emitting a JSON-formatted string of its entire contents. The stream 787 interface can provide a standard interface for accessing a wide variety of sources of byte streams. The file 788 class can provide access to persisted (i.e., stored) files. The pixel buffer 789 class can provide services for managing and manipulating a raster image. The data buffer 790 class can provide a dynamically sized byte array. The file directory 791 class can provide services for traversing a persistent storage directory. A font persist 792 class can provide services for reading a raster font file format or for producing a raster font file from a set of resources. The factory 794 interface can provide an abstract interface for instantiating other objects; the factory template 795 class can provide an easy way to create a factory for any other object in the system. The iterator 796 interface can provide a consistent abstract way to iterate any type of object. The manage pointer 797 can act as a helper class that can manage all other object instances to facilitate proper object reference counting. The instance 798 class can act as a template class that can envelope all other classes to implement reference counting. The logger 799 class can provide services for easily logging internal state information to a log file.

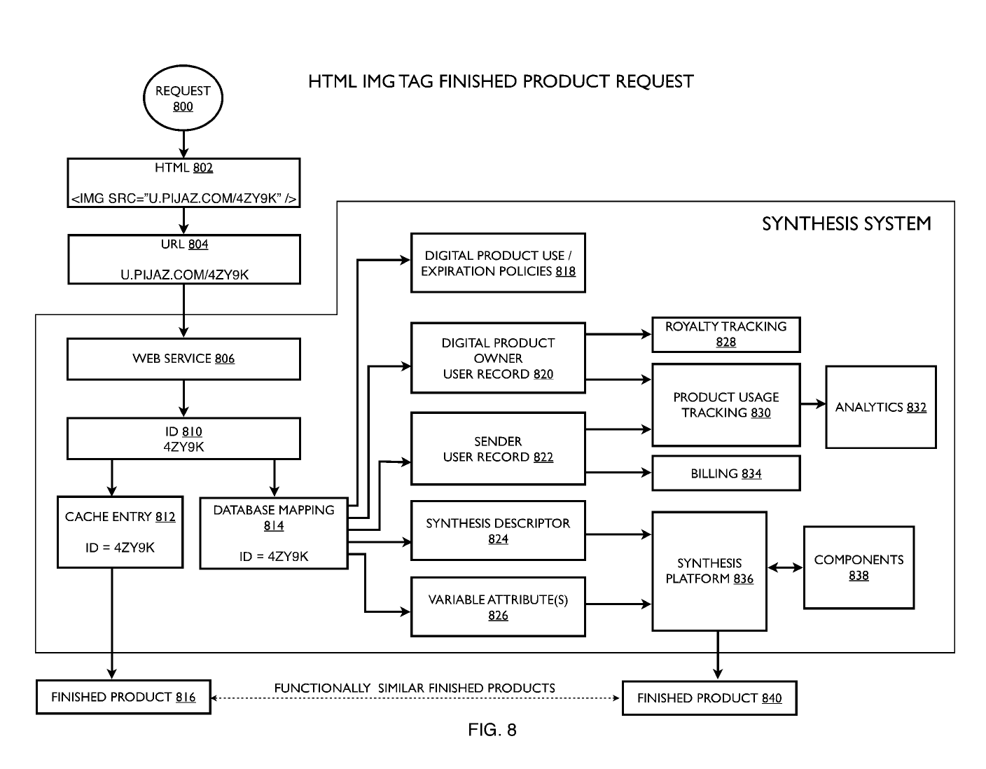

### FIG. 8

FIG. 8 illustrates schematically an exemplary sequence of steps for serving a request 800 for a finished product via an HTML img tag. A web developer can design a web site to provide a special shortened URL as the “src” attribute of an HTML 802 “img” tag. When a client web browser sends the URL 804 request to, e.g., the Pijaz URL-shortening server “u.pijaz.com”, a Pijaz web service 806 can process the request. This web service 806 can extract the ID 810 from the URL. In an exemplary embodiment, this ID can be a base 62 (a-z, A-Z, 0-9) identifier. The service can check whether there is an entry in a cache 812 for that identifier. If so, the cache entry 812 can include information for retrieving the digital product referenced by the identifier and can return that digital product byte stream to the client browser.

If no cache entry 812 is found for the ID 810, then the identifier can be used as a database mapping 814 to retrieve a variety of information necessary to reproduce the digital product or manage the digital rights of reproduction or any related e-commerce transactions. The database mapping 814 can be used to retrieve the digital product use or expiration policies 818 of the digital product associated with the database mapping 814. These policies can be used to determine the nature of the product to deliver, e.g., whether a watermark will be applied to the image, or whether a low resolution or a high resolution version will be synthesized and delivered. The use and expiration policies can be used to determine a monetary charge for the synthesis of this product. If there is a monetary charge, the appropriate amount can be recorded in a billing 834 record associated with the sender user record 822 and a calculated royalty amount can also be recorded in a royalty tracking 828 record associated with the digital product owner 820. An entry can also be added to the product usage tracking 830 table to record this use of the system. The product usage tracking 830 entries can be retrieved and analyzed to provide analytics 832 information. The database mapping 814 can be used to retrieve all of the variable attributes 826 used to generate the finished product 816 or the synthesis descriptor 824 for the digital product associated with the database mapping 814. The synthesis descriptor 824, the variable attributes 826, or other attributes associated with the use and expiration policies 818 can be provided to the synthesis system 836 to synthesize a finished product 840 that is functionally similar to the formerly cached finished product 816. If the web service determines that the use and expiration policies allow it to re-synthesize the finished product, the new finished product 840 can be added as a cache entry 812 to the cache for that ID 810. The synthesis system 836 can utilize any number of widget or workflow components 838 to produce the finished product 840.

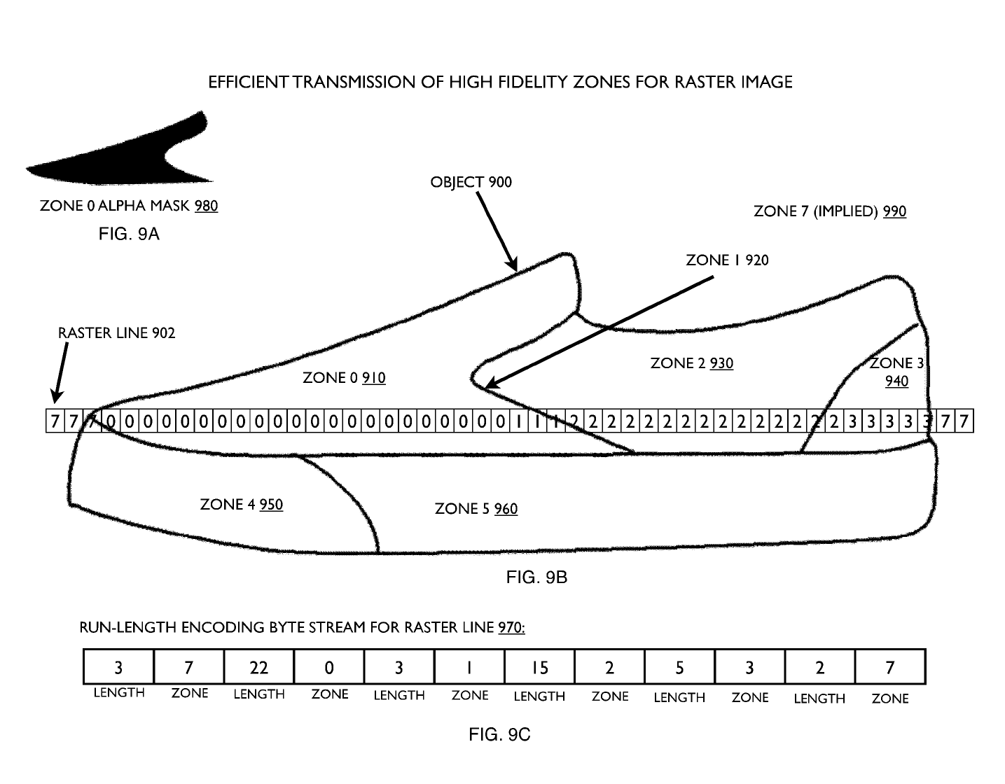

### FIGS. 9A, 9B, and 9C

FIGS. 9A, 9B, and 9C illustrate schematically an exemplary method for efficiently representing and transmitting high fidelity zones for a raster image. This can be useful for presenting an object 900 where it is desired for the user to be able to select individual zones of that object for the purposes of altering only a portion of the object that coincides with the selected zone. This alteration can be in the form of altering its color, brightness, or texture, or more complex alterations can be implemented such as applying a pattern that itself has been individualized. The preparation of the necessary information can be fully automated once the zones have been defined by a person skilled in masking a raster image (e.g., in an application such as Adobe® Photoshop®). First, each zone can be defined as an alpha channel mask at the same resolution as the original raster image. An alpha mask typically can be an 8-bit value that can allow for an anti-aliased edge between zones. Zone 0 Alpha Mask 980 is an example of such a mask for the tongue of the shoe. Each zone can have a similar alpha mask channel defined in, e.g., a photo editing application such as Adobe® Photoshop®. In this example, the object 900 has six zones: zone zero 910 is the tongue, zone one 920 is the tongue border, zone two 930 is the side panel, zone three 940 is the heal panel, zone four 950 is the front sole, and zone five 960 is the back sole. There also exists an implied zone seven 990 which is the sum of all areas not within another zone.

Once all of the alpha masks are created, a software program can scan each row of the image. The example low resolution raster line 902 can show what the zone number would be for each pixel in that representative row and hence which alpha mask would have a non-zero pixel value. For brevity and clarity, the raster line 902 in the illustration shows which alpha channel has a non-zero value for each pixel, with 7 representing no alpha channel. From a practical standpoint, these would typically exist as N alpha mask channel pixel maps where N is the number of defined zones. For each row in a raster line 902, each pixel in the row can be scanned in order from left to right. For each pixel, each alpha mask channel can be checked to see if the alpha mask pixel at that x,y pixel location is non-zero; if it is non-zero, then the alpha mask channel can be checked against that identified in the previous pixel. If the alpha mask index has not changed, the next alpha channel is similarly checked. If no alpha channels have a non-zero value at that pixel, then the implied alpha channel value equal to the total number of alpha channels is used. This non-existent alpha channel index value is a virtual zone that represents all pixels that are not in any other zone. If it is unchanged then the next pixel can be checked. If it has changed, then the distance between the last pixel position that changed value and the current pixel position can be recorded, as well as the previous alpha channel value. The new pixel position and new alpha channel index are retained for the next span. The end result is a run-length encoded (RLE) byte stream as shown in 970 for the raster line 902. This can continue until all pixels in the row have been processed and the final span length and alpha channel value is recorded. Each row can be scanned in this manner until all rows have been processed. The output now is a run-length encoded list of zone spans for each row. In an exemplary embodiment, each count and value are emitted as 8-bit bytes, allowing for up to 255 zones. For increased efficiency, the bit sizes can be altered as a function of the characteristics of the image, or the result could be further compressed such as with the LZW compression method.

In a web browser environment, the JavaScript on the client browser can request that a RLE zone map be provided for a certain digital product. This static zone map can then be efficiently received from a server-side web service and cached for the duration of the user experience of altering the visual characteristics of the object 900. As the user touches or moves the mouse over various zones, it is a simple matter, for one skilled in the art, of using the x,y position of the touch or mouse to find the correct zone in the RLE zone map. This zone can then be used to determine the names of the attributes to associate with user selections of the visual characteristics of that zone such as color, texture or pattern, when submitting to the server all information needed to synthesize a new image with the proper characteristics for each zone. For example, if the selected zone is 5, and the user selects the color yellow for zone 5, the <key,value> pair(s) provided to the synthesis system can be derived from those user choices. An example of that might be to submit “zone_{—}5_color=yellow”. In a more complex scenario, the client side program can track a wide variety of all user selections so that the sum total of information returned might look like this:

product_id=shoe_1
zone_0_color=blue
zone_1_color=tan
zone_2_color=black
zone_5_color=yellow
jpeg_quality=95

In an exemplary embodiment, the smallest containing area in the pixel image for each zone is also calculated and transmitted along with the RLE data. This allows for more efficient zone checking in the client software.

It is interesting to note that the synthesis system itself is able to produce these zone maps with the help of a zone map widget, and deliver them as a digital product (in this example as a JSON-compliant text stream that can be delivered directly to the invoking agent). For efficiency sake, these are typically calculated once and cached to avoid re-analyzing the image every time a zone map is needed.

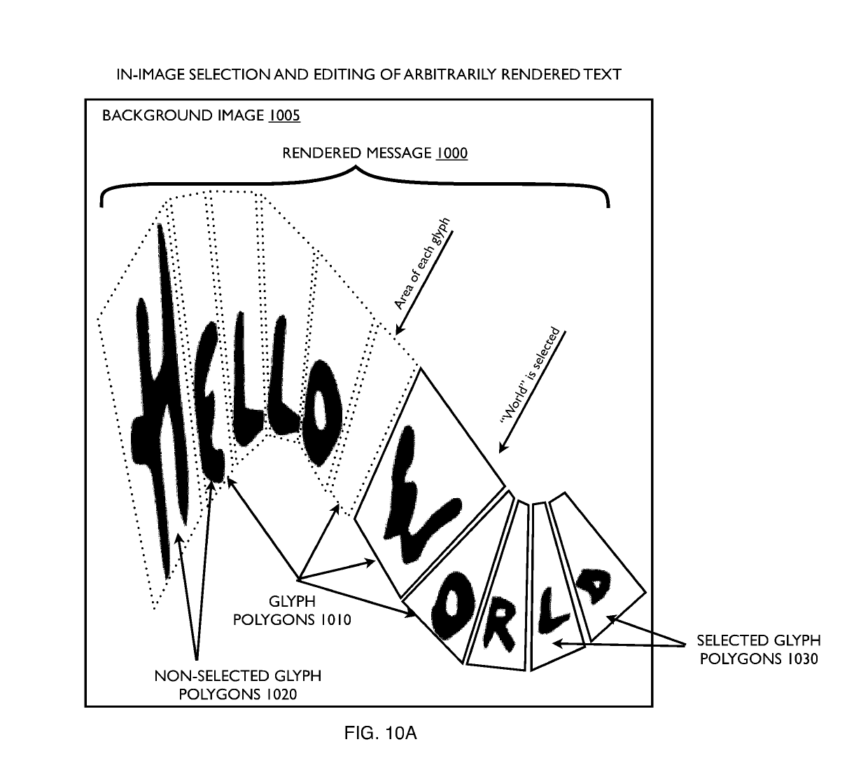

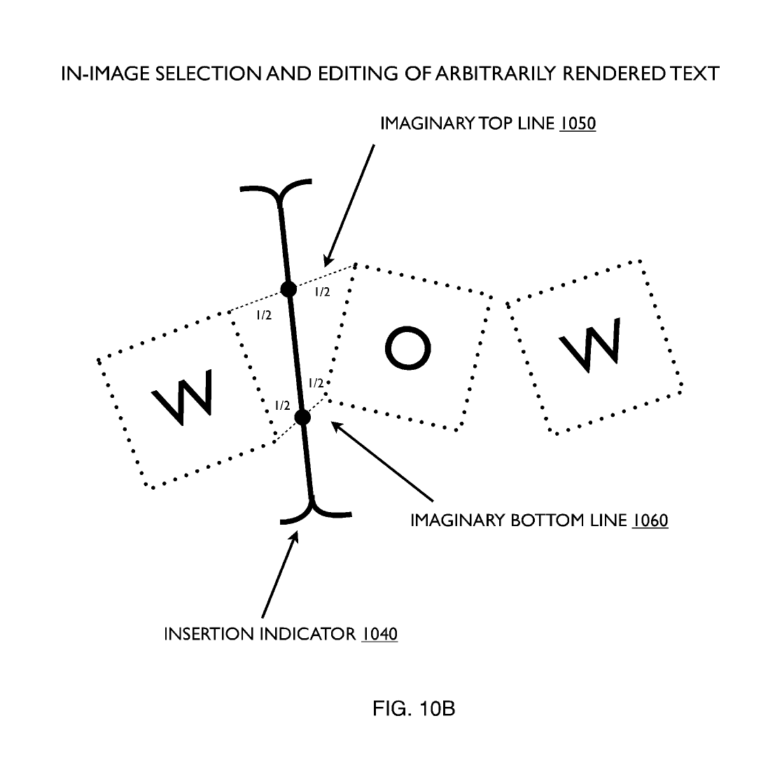

### FIGS. 10A and 10B

FIGS. 10A and 10B illustrate schematically exemplary in-image selection and editing of arbitrarily rendered text in an image. In this example, the rendered text message “Hello World” has been rendered into a background image 1005, in this example between a top-line and a base-line bezier curve. The actual final glyph rendering shape and position can be quite complex and can be the result of many transformations. Once the message has been rendered into the image, it typically exists only as pixels in a larger raster image that can be delivered to a client agent. In an exemplary embodiment the image can be delivered as a standard JPEG or PNG image, typically to a standalone or embedded web browser via either an Ajax request or via a standard URL on the “src” attribute of an <img> tag, or to any type of application able to make URL requests via the HTTP protocol. However the resulting image can be obtained by any client agent that is able to signal the parameters to the synthesis system necessary to describe the work to be performed and subsequently receive a signal containing the synthesized digital product, which in this case is in the form of a digital raster image. However, without receiving further information, the client agent has no way to allow the user to select this raster message for editing.

At the time the synthesis system renders the glyphs into the raster image, it typically calculates and utilizes glyph polygons 1010 for each glyph to merge each transformed glyph raster image into a background raster image. A more generalized solution can allow any final polygon to describe the render location of each glyph. To allow a client to know where glyphs exist in a raster image, at the time that the synthesis system performs this transformation, it can create a set of glyph polygon coordinates comprising the x,y points of each of the four corners of the polygon used to transform the image, preferably represented in x,y coordinates of the produced digital product. As a final product is constructed from all of its parts, images often can be further processed or further placed into other images in subsequent synthesis steps. Therefore it can be important that this vector of polygon coordinates is properly modified to account for any changes in their position, scale, and other transformations relative to the coordinates of the final product, so that once all synthesis steps have been performed, the coordinates still properly convey the position of each raster image. This means the synthesis system updates all of these glyph polygons as each component in the synthesis workflow transforms the glyphs. The coordinates of the glyph polygons can become part of the job metadata passed down the queue to downstream components. Each component that may change the metrics of a glyph can update this area metadata appropriately for each glyph. This metadata is then associated with the final product so that a client can request the metadata.

In an exemplary embodiment, the polygon metadata can be embedded directly into application specific tags within the delivered digital image file. However, this metadata is not necessarily readily available to all client agents, most specifically to the JavaScript programs of today's standard web browsers. In an exemplary embodiment, JavaScript code referenced by a web page can signal a request to the synthesis system with a digital product identifier and can receive a response signal containing the glyph coordinates metadata. The synthesis system can retrieve the cached vector of glyph polygon coordinates for one or more messages rendered into a finished product image, or if the cache does not contain the necessary information, it can be created as needed by the synthesis system. The synthesis system can then deliver these results, typically as a JSON or an XML data stream, back to the client. The client can then utilize this information to allow for the selection of text directly in the image. Although it is not necessarily given that the client already knows what text was rendered into the image, an exemplary embodiment also can return the actual text messages associated with the original keywords provided and can correlate those provided text messages to the correct polygon vectors. In this way it is much easier for the client to provide these services with no chance of confusion or mismatch. It also makes it easy to support multiple messages, each with its own set of polygon vectors. An example metadata JSON request might look like this:

http://api.pijaz.com/get_glyph_metadata?product_id=1234

A reply from the synthesis system may look like this:

{“product_id” : “1234”,
“glyph_metadata” :

[ { “message1” : “Hello World”,
“polygons : [

| { | “glyph” : “H”, |
|---|---|
| | “x0” : 0, “y0” : 0, |
| | “x1” : 100, “y1” : 0, |
| | “x2” : 100, “y2” : 100, |
| | “x3” : 0, “y3” : 100 |
| }, ... | |
| { | “glyph” : “d”, |
| | “x0” : 1000, “y0” : 0, |
| | “x1” : 1100, “y1” : 0, |
| | “x2” : 1100, “y2” : 100, |
| | “x3” : 1000, “y3” : 100 |

| | } ] |
|---|---|
| }, | |
| { | “message2” : “Another message”, |

“polygons : [ { “glyph” : “A”, ... }, { ... }, ... { ... } ]

} ]
}

Once a client agent has received the polygon coordinates for each glyph, the client agent can use these coordinates to highlight or embellish the selected glyph polygons 1030 as a user, using a touch or pointing device, drag selects over a selection.

There are a wide variety of ways to highlight the selected glyph polygons. One method is to darken or lighten the image area immediately underlying the polygon using an opacity function. Non-selected polygons 1020 are not highlighted at all, or can be highlighted in a more subdued way as a way to show where a message flows, particularly if a message follows a complex or segmented path where it may be less obvious where the entire message exists within the raster image. In an exemplary embodiment, if the polygons are not quadrilaterals, a separate quadrilateral that represents the final transformed positions of the original four corners of the containing area of the original glyph can be included along with the polygon data in the provided metadata. With these quadrilateral coordinates, a visual insertion indicator 1040 that represents where any newly typed characters will be inserted into the existing text message can be readily positioned. This indicator would typically be blinking or drawing attention to itself in some other fashion. In an exemplary embodiment, the insertion indicator can include an axis that bisects both an imaginary top line 1050 connecting the upper right corner of the glyph immediately preceding the insertion point and the upper left corner of the glyph immediately following the insertion point, as well as an imaginary bottom line 1060 connecting the lower right corner of the glyph immediately preceding the insertion point and the lower left corner of the glyph immediately following the insertion point. If there is no glyph following the insertion point, it would intersect with the upper right and lower right coordinates of the preceding glyph. If there is no glyph preceding the insertion point, it would intersect with the upper left and lower left coordinates of the following glyph. This methodology of conveying the location of rendered objects can be extended to three dimensions by tracking X, Y, and Z coordinates of a volume that defines the boundaries of a transformed glyph.

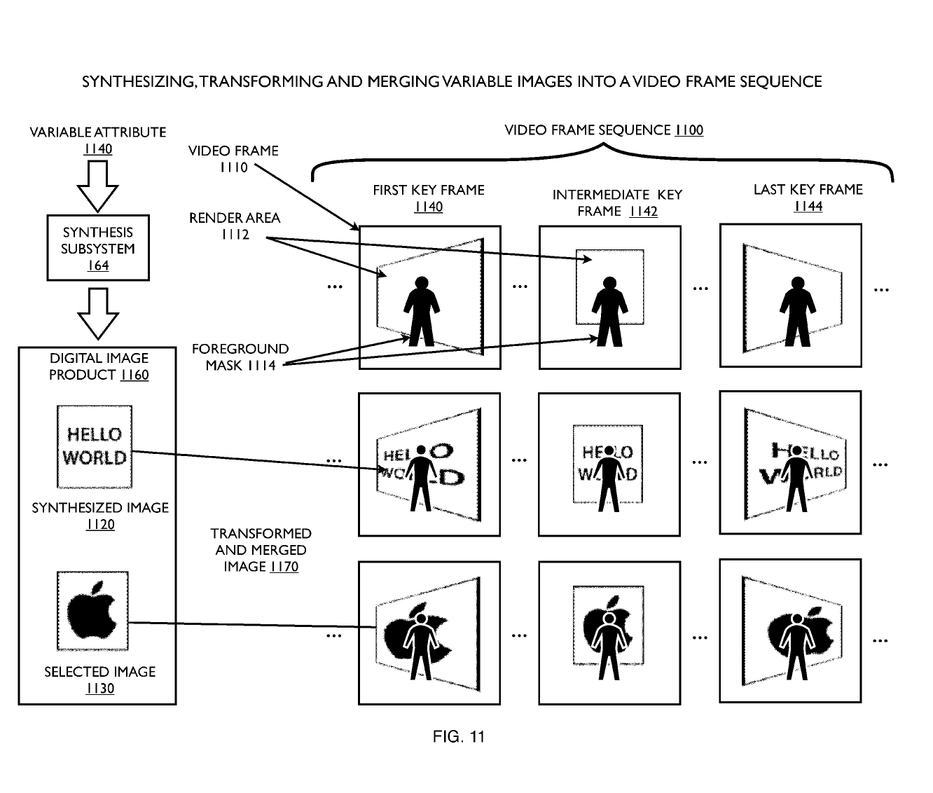

### FIG. 11

FIG. 11 illustrates schematically an example of how digital image products can be merged into a video frame sequence. Given a video frame sequence 1100, at least one variable attribute 1140, a synthesis subsystem 164, a digital image product 1160 (e.g., a synthesized image 1120 or a selected image 1130, which can be synthesized or elected as a function of the at least one variable attribute), and one or more key frame metadata (that can describe, inter alia, at least one render area 1112 and optionally can also describe a foreground mask 1114), the digital image product 1160 can be merged into the video frame sequence 1100 as follows. A first key frame 1140 can be selected in a video frame sequence 1100. Render area coordinates 1112 and an optional foreground mask 1114 can be established for the first key frame 1140. If the render area or the foreground mask differ from frame to frame, subsequent intermediate key frames 1142 or last key frame 1144 can be similarly selected; in that case, render area coordinates 1112 and an optional foreground mask 1114 can be established for the intermediate key frames 1142 or the last key frame 1144. If the render area coordinates and the optional foreground mask are static over the video frame sequence, the last key frame typically is identified, but no render area or optional foreground mask need be specified, because they are the same as those already determined for the first key frame 1140.

A synthesis subsystem 164 receives at least one variable attribute 1140 and delivers a digital image product 1160 (e.g., a synthesized image 1120 or a selected image 1130, which can be synthesized or selected as a function of the at least one variable attribute). The digital image product 1160 can be transformed as a function of the render area 1112 for the first key frame 1140 and then can be merged with the first key frame 1140 as a function of an optional foreground mask 1114 to determine which pixels are transferred to the first key frame 1140. If no optional foreground mask 1114 exists, the entire image can be merged, at the appropriate position and with the correct transformation, with the first key frame 1140. One skilled in the art will recognize that a matrix transformation typically is required to merge a flat rectangular source image, 1120 or 1130, onto an arbitrary 3D rectangular planar area within a scene 1112 that is mapped to a destination 2D plane (e.g., the video frame 1110). This matrix captures the necessary source pixel to destination pixel transformation for every pixel in the source image 1120 or 1130, typically involving a combination of position, scale, rotation, or perspective distortion. Note that the foreground mask 1114 can determine which of these pixels are actually transferred to the corresponding destination pixel.

There can be additional frames between the key frames. For such frames between the key frames, the render area 1112 coordinates can be calculated as the fractional distance along an imaginary line that connects each render area coordinate of the previous key frame and the next key frame. This fractional distance is in proportion to the position of the additional frame between the previous key frame and the next key frame. For example, if the current frame is the 10th frame out of one hundred frames that exist between key frames, then the fractional distance will be 1/10th of the total distance between the previous key frame coordinates and the next key frame coordinates. One skilled in the art will recognize that this is a common technique called tweening. Similarly, the foreground mask can be tweened, which is also a common technique that works well for static objects. The algorithm for such tweening has already been well documented and need not be disclosed herein. The synthesis subsystem 164 is described in more detail in other sections of this disclosure. Note that the video frame sequence 1100 typically can comprise a subset of a longer video.

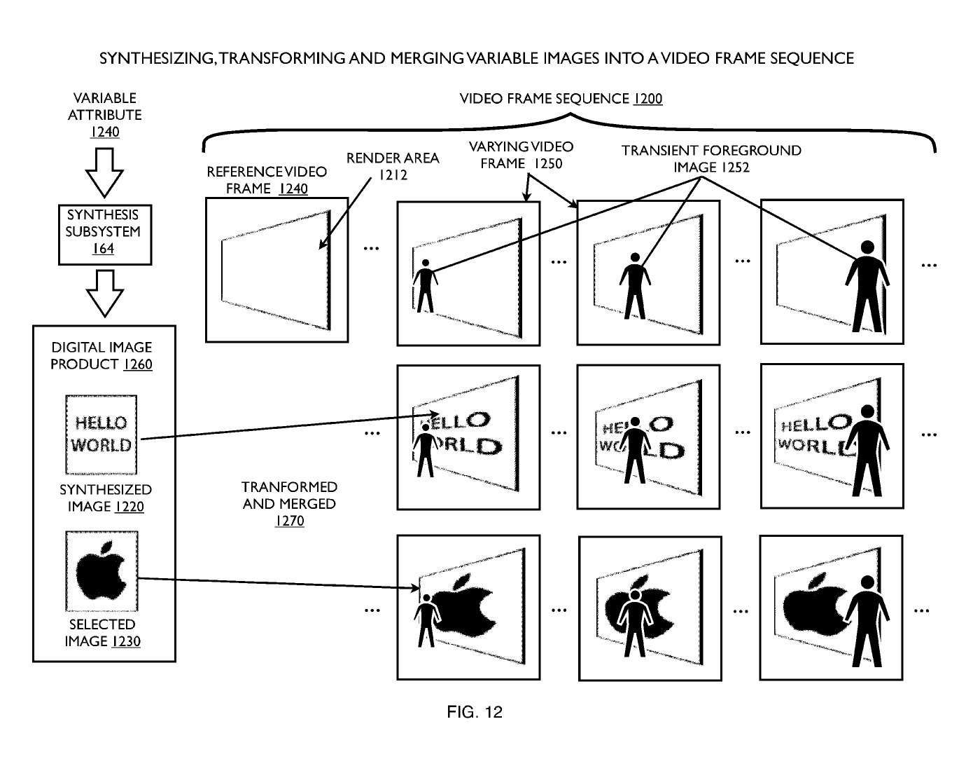

### FIG. 12

FIG. 12 illustrates schematically a simpler exemplary scenario of merging a digital image product 1260 (e.g., in the form of a synthesized image 1220 or a selected image 1230), into a video frame sequence 1200. Given a video frame sequence 1200, at least one variable attribute 1240, a synthesis subsystem 164, a digital image product 1260 (synthesized or selected as a function of the at least one variable attribute), at least one reference video frame 1240, and at least one render area 1212, the digital image product 1260 can be merged into the video frame sequence 1200 as follows. A reference video frame 1240 can be chosen that has no transient foreground image 1252 obstructing any portion of the render area 1212. Each frame of the video frame sequence 1200 can be compared with the reference video frame 1240 on a pixel by pixel basis for each pixel within the render area 1212. For each pixel that is within a threshold of similarity, the corresponding pixel from the digital image product 1260 can be transformed and merged 1270 into the currently processed frame of the video frame sequence 1200. In some instances of a varying video frame 1250, there might be a transient foreground image 1252 that partially or entirely obstructs the render area 1212. The pixels that comprise the transient foreground image 1252 typically can be dissimilar pixels that are not within the threshold of similarity to the same pixel position in the reference video frame 1240. The pixel in the digital image product 1260 that corresponds to these dissimilar pixels in the varying video frame 1250 typically are not be transformed and merged, resulting in the transient foreground image 1252 remaining in the final frame and the transformed and merged 1270 digital image product 1260 effectively appearing to be visually behind the transient foreground image 1252. Note that the video frame sequence 1200 typically can be a subset of a longer video. In some cases, the algorithm for the threshold of similarity can simply be a maximum permitted difference in color channel values between the two pixels. This allows for minor pixel value differences from frame to frame, typically due to compression anomalies, CCD capture noise, or variations in lighting over time. In more complex scenarios similarities in tone and luminance between the reference video frame 1240 and the transient foreground image 1252 will cause too many pixels to be incorrectly classified as being within a threshold of similarity. In these more complex scenarios, more complex algorithms typically are employed. One exemplary strategy can include finding the outline of a transient foreground image 1252 by looking for the outermost pixels that are dissimilar as a function of a threshold of similarity algorithm and then classifying all pixels within those outer boundaries as also being dissimilar; those pixels are therefore retained instead of being overwritten by the transformed and merged 1270 digital image product 1260. Note that given the reference video frame 1240, there typically is no need to mask the foreground image on a frame-by-frame basis, making the example of FIG. 12 an easier solution from a setup perspective than the example of FIG. 11 for many classes of images.

The automated detection described in FIG. 12 can be combined with a foreground masking described in FIG. 11 for a hybrid solution. This would be useful for cases where a surface such as a wall intended to receive a variable message is obstructed by both static objects such as a pole, as well as a dynamic object such as a person walking by. In this example, the mask could be used to mask out the variable message behind the static foreground pole, while the dynamic detection could be used to detect and mask out the variable message behind the person walking by.

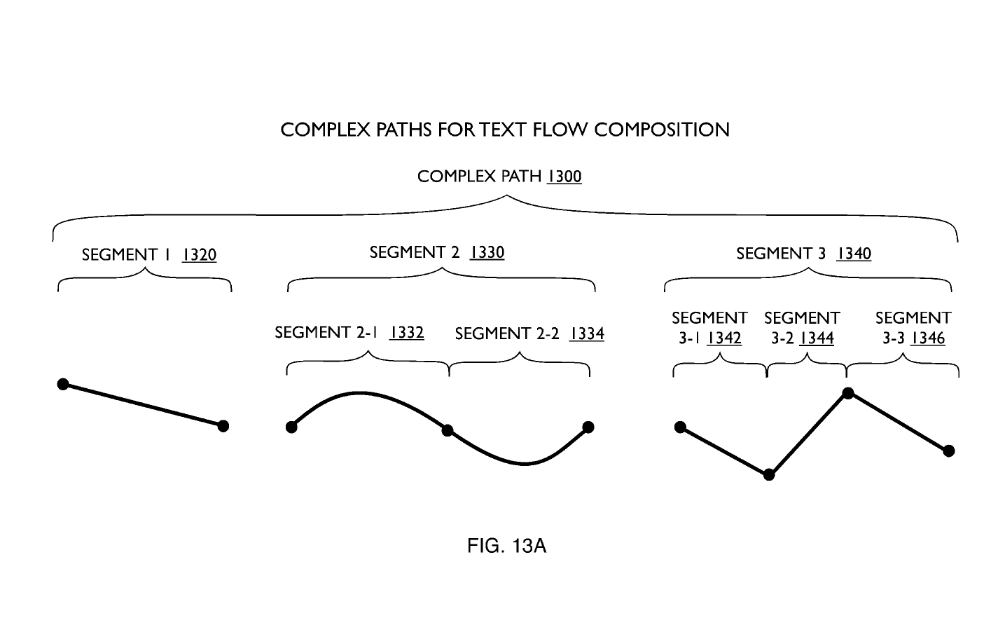

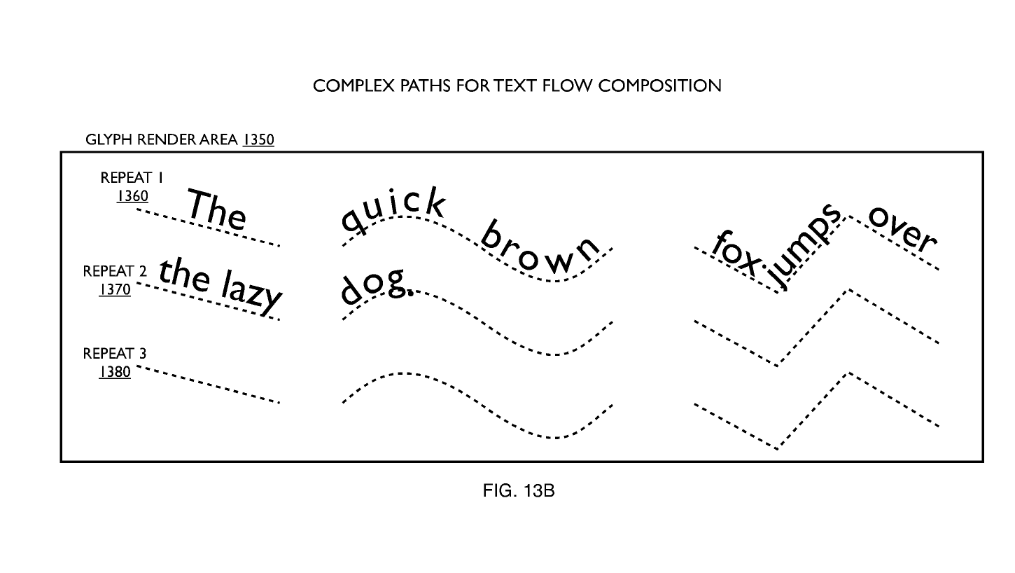

### FIGS. 13A and 13B

FIGS. 13A and 13B illustrate schematically an exemplary method by which complex paths can be constructed and used for the purposes of flowing glyphs, glyph justification, and copy-fitting. A path can comprise an arbitrarily long and complex series of contiguous and non-contiguous straight or curved lines. In this example, the complex path 1300 comprises three primary path segments 1320, 1330, and 1340. Path segment 1330 further comprises two shorter path segments 1332 and 1334. Path segment 1340 further comprises three shorter path segments 1342, 1344, and 1346. Segments 1, 2-1, 2-2, 3-1, 3-2, and 3-3 (1320, 1332, 1334, 1342, 1344, and 1346, respectively) are considered simple paths or primitive paths in that they are fully described by one path algorithm or mathematical function. A path can comprise any combination of one or more primitive paths. Given a path of arbitrary complexity, this path is then utilized by a text composer to determine each glyph position, scale, rotation, transformation, or other attributes. Typically, the path can be rendered into a glyph render area 1350.

A minimum and maximum number of path repeats can be specified for fitting all of the glyphs. A glyph render area 1350 can specify the boundary within which path repeats can exist and which guides vertical and horizontal justification of paths. An optimal glyph size can be specified as well as a minimum and maximum glyph size. If all glyphs fit onto the specified path at the optimal size, then no scaling need be applied. However, if not all glyphs can fit on the specified path at the optimal size, one or more of the glyphs can be scaled until the entire set of glyphs can fit on the path or until the minimum glyph size has been reached (in which case a warning can be emitted stating that all glyphs do not fit at the minimum size). Note that during the process of determining a scale at which all glyphs can fit, the total distance between path repeats can change, thus allowing for fewer or greater number of path repeats 1360, 1370, and 1380 to fit within the glyph render area 1350. In an exemplary embodiment, the strategy employed for finding the optimal scaling factor for fitting the glyphs can be a binary search which assesses how many path repeats 1360, 1370, and 1380 will fit in the glyph render area 1350, and then how closely the glyphs fill all available path repeats. The binary search continues until either a certain minimum delta in scaling factor has been reached, or until the glyphs fill the available path repeats within a certain tolerance factor.

Instead or in addition, the formatting parameters can specify that the glyphs should fill the entire path repeats 1360, 1370, and 1380 within the minimum and maximum path repeat constraints. In this case, glyphs can be scaled up until all glyphs fill the path repeats within a certain tolerance factor or until the maximum glyph size has been reached (in which case a warning could be emitted stating that the path could not be filled according to the specified constraints). Alternatively, the formatting parameters can specify to leave an end portion of the path unfilled, or that the entire glyph sequence shall be repeated until the area is filled. In the repeated-sequence case, a set of separator glyphs can be specified to be inserted between the repeats. Formatting parameters can also specify that glyph set repeats must end on a glyph group boundary so that partial glyph groups are not rendered. In an exemplary embodiment, this scaling up can employ a binary search strategy similar to the copy-fitting for scaling down described previously.

Note that within each segment of a complex path 1300, the glyphs can follow certain justification rules such as left-justified, right-justified, centered, or full-justified. Full justification rules can specify the distribution of the remaining space between glyphs and in the greater spaces between glyph groups (e.g., words). The formatting parameters can further specify that certain glyph groupings must remain on the same contiguous path segment 1320, 1330, or 1340 or on the same primitive path segment 1320, 1332, 1334, 1342, 1344, or 1346. This forces those glyph groupings to remain together instead of spanning potentially distant path segments. The copy-fitting algorithm typically obeys these formatting constraints when assessing whether glyphs fit the available space on a path. Note that glyph flow and copy-fitting can span multiple glyph render areas 1350, each providing for different paths, different glyph styles, or different formatting parameters. In this case, the formatting parameters can specify a distribution process. One example of a distribution process is that a certain percentage of the available glyphs shall reside within each glyph render area. The exact split of glyphs to meet the suggested percentages can depend on other formatting parameters such as whether glyph groups must remain within a single glyph render area 1350 or whether they can span render areas. The glyphs can be divided into sub-sets for each glyph render area in a way that best meets the intent of all formatting parameters. Note that for path repeats 1360, 1370, and 1380, formatting parameters can specify that each repeat to be offset both vertically and horizontally, by either a fixed or a random amount, thus allowing for some amount of variability to give a wider variety of glyph rendering effects.

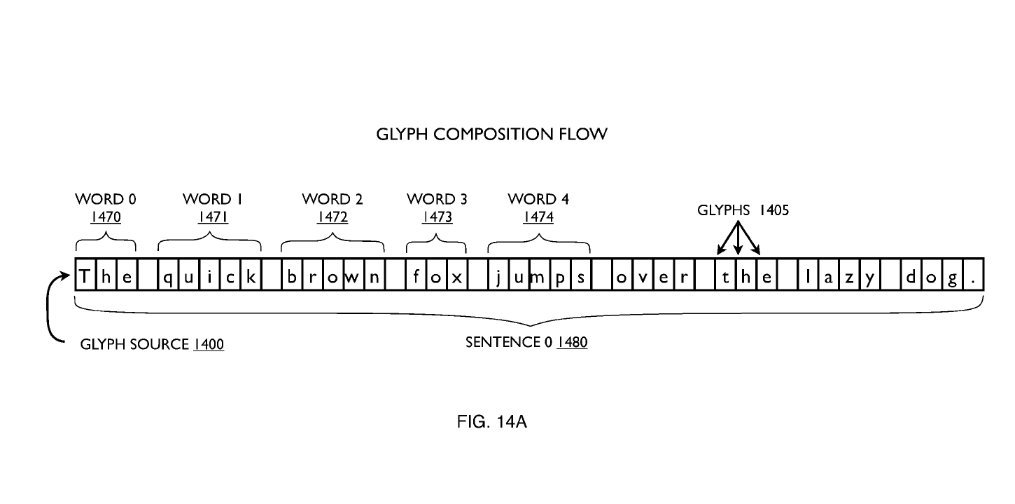

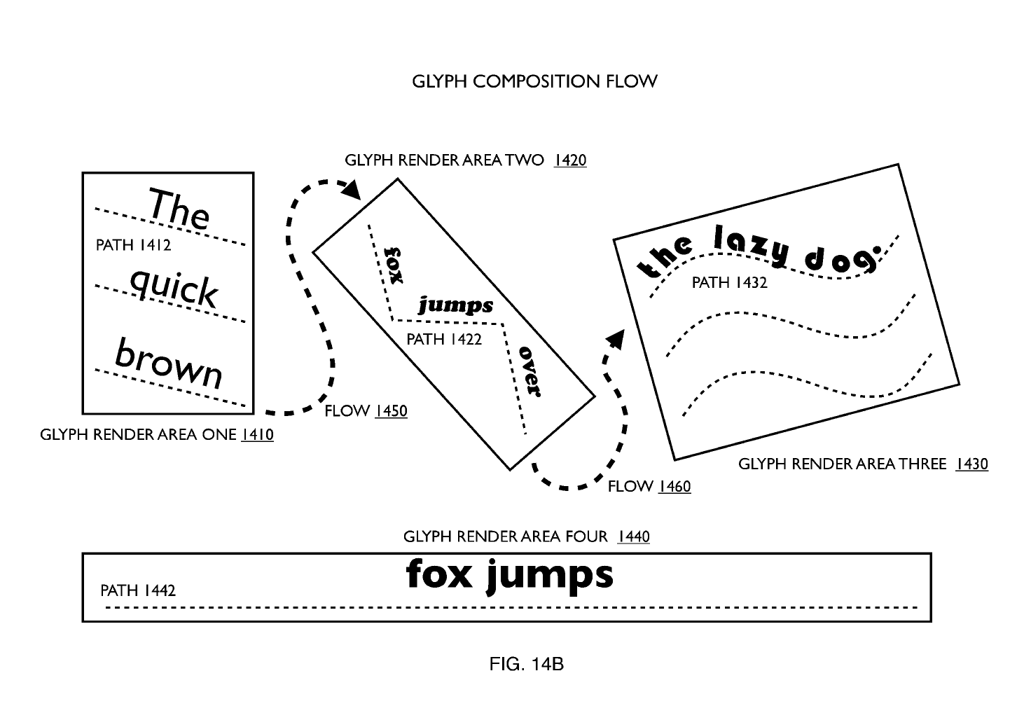

### FIGS. 14A and 14B

FIGS. 14A and 14B illustrate schematically an example of comprehensive support of glyph composition flow, copy fitting, and glyph range specification. One or more glyph sources 1400 can be used to provide a series of arbitrary sequence of glyphs 1405 that are intended to be rendered. The glyphs of the glyph source(s) 1400 can be further divided into groupings such as words 1471, 1472, 1473, and 1474. These can be further grouped into sentences 1480, paragraphs, or any other useful, needed, or desirable groupings; such groupings can provide beneficial access to useful sets of glyphs for the purposes of determining the best placement for a given purpose. Each glyph render area 1410, 1420, 1430, and 1440 can be associated with a corresponding path 1412, 1422, 1432, and 1442, respectively. As discussed in the description of FIGS. 13A and 13B, each path can be automatically repeated according to parameters that specify the minimum and maximum supported repeats as well as spacing and constraint to the glyph render area.

The glyphs 1405 of a glyph source 1400 can in some instances flow automatically along all of the calculated path repeats of a sequence of glyph render areas. In this example, glyph render area One 1410 effectively flows 1450 to glyph render area Two 1420 which effectively flows 1460 to glyph render area Three 1430. With copyfitting enabled, a glyph scaling factor can be applied within specified constraints to ensure the specified portion of the glyph source 1400 fits within all of the calculated path space provided by the aggregate of all of the possible path repeats of each path 1412, 1422, and 1432 across the sequence of glyph render areas 1410, 1420, and 1430. Note that the number of path repeats for each path can change as the scaling factor changes during the search algorithm that determines the best copyfit scaling factor. Also note that each render area 1410, 1420, and 1430 can specify a unique set of a wide variety of additional rendering parameters that determine the exact final style, transformations, or other manifestations of each glyph within that render area. The most obvious examples for glyphs which represent letters of an alphabet are attributes such as the font, color, or minimum and maximum point size. However, the attributes can include one or more of a wide variety of other transformations such as pattern fill, the glyph shape, algorithmically fill a glyph shape from a set of digital images, frame a glyph with framing images, randomize the position, rotation, or scale of the glyph, etc.

Certain transformations specified for the glyph render area can change the size of a glyph and this size alteration can be accounted for when determining how to place glyphs along a path. In particular, if a transformation changes the width of a glyph, that change in width can be accounted for when determining where along the path that glyph will be rendered. For each of the one or more glyph sources 1400, the glyphs 1405 that are available for flowing onto the one path 1412, 1422, 1432, or 1442 can be specified as a subset of all available glyphs. For example, glyph render area Four 1440 only shows word 3 1472 and word 4 1474 of the glyph source 1400. Each glyph render area can specify the range of glyphs from one of the glyph source(s) 1400 that can be rendered into that glyph area. The range can be specified as starting at any particular combination of glyph offset, word offset within a sentence, sentence offset within a paragraph, paragraph offset within the glyph source, or any other unit of glyph groupings. The size of the range can be specified according to any combination of glyph count, word count, sentence count, paragraph count, or count of any other meaningful group of glyphs. Alternatively, the end of the range can be specified as occurring at a specific glyph offset, word offset within a sentence, sentence offset within a paragraph, paragraph offset within the glyph source, or any other unit of glyph groupings. The end can be left unspecified, in which case, the entire remaining set of glyphs is indicated for inclusion.

Once the subset has been specified, that subset is treated as if it is the only glyphs available for rendering into a glyph render area. As an example, the glyph render area Four 1440 receives only word 3 1473 and word 4 1474 from the glyph source 1400, and the glyph render area parameters specify that it shall center justify the glyphs and render it at a certain maximum size. Given that the entire subset of glyphs 1473 and 1474 can be composed without copyfit scaling in this example, no scaling factor is required and the maximum glyph size does not entirely fill the available path space 1442. The appropriate positions on the path 1442 are calculated as a function of the final glyph widths so that the glyphs appear centered on the path 1442 within the area 1440. Note that the same glyph source 1400 can supply glyphs for any number of related or unrelated glyph render areas.

The exemplary embodiment of a glyph render area, called a zone, supports the zone composition parameters described in this section. The composition framework is designed to be open ended and to allow for easy addition of new parameters. In an exemplary embodiment, the parameters can be specified in an XML data stream as indicated in the tables below.

Zone Composition Parameters

| Attribute Name | Description |
|---|---|
| zone_transform | Apply a transformation to the zone pixels. Any number of |
| | transformations can be specified in any order. A type attribute |
| | can be used to identify and invoke the correct transformation |
| | algorithm. Each transformation can accept any number of fixed |
| | and variable parameters. The actual transform can be applied |
| | as a function of type, fixed parameters and variable parameters. |
| glyph_transform | Apply a transformation to the glyph pixels for each glyph before it |
| | is applied to the zone pixels. A type attribute can be used to |
| | identify and invoke the correct transformation algorithm. Any |
| | number of transformations can be specified in any order. Each |
| | transformation can accept any number of fixed and variable |
| | parameters. The actual transform can be applied as a function of |
| | the type, fixed parameters and variable parameters. |
| compose_path | Specify a baseline path, an optional topline path and |
| | path_repeat parameters. |
| baseline | Specify a baseline path as component of the compose_path. A |
| | type attribute can be used to identify and invoke the correct path |
| | algorithm. Each path can accept any number of fixed and variable |
| | parameters. The path metrics can be a function of the type, the |
| | fixed parameters, and the variable parameters. |
| topline | Specify a topline path as component of the compose_path. If a |
| | topline path is specified, each glyph can be placed within an area |
| | that is specified by a subpath of the topline and a subpath of the |
| | bottomline. If no topline path is specified, each glyph can be |
| | placed as a function of a subpath of just the baseline path. A type |
| | attribute can be used to identify and invoke the correct path |
| | algorithm. Each path can accept any number of fixed and variable |
| | parameters. The path metrics are a function of the type, the fixed |
| | parameters and the variable parameters. |
| path_repeat | Specify a path repeat as a component of the compose_path |
| | attribute. A path repeat can occur within the area allotted for a zone. |
| | An ascent_offset attribute of the path_repeat attribute can |
| | determine how much extra headroom to provide the topmost repeat |
| | to accommodate the height of the glyphs above the baseline. |
| min_count | A min_count parameter of the path_repeat parameter can |
| | specify the minimum number of repeats to use. This can |
| | default to one. |
| max_count | A max_count parameter of the path_repeat parameter can |
| | specify the maximum number of repeats to use. This can |
| | default to no-limit, in which case the glyph render area |
| | combined with the glyph height can determine the actual |
| | maximum number of repeats. |
| x_offset | An x_offset parameter of the path_repeat parameter can specify a |
| | fixed, random, or best fit horizontal distance to offset each repeat. |
| | For a random offset, the min, max, and variation parameters |
| | determine the boundaries of the randomness and the minimum |
| | variation per repeat. For a fixed offset, a distance attribute can |
| | specify the fixed horizontal offset amount. |
| y_offset | An y_offset parameter of the path_repeat parameter can |
| | specify a fixed, random, or best fit vertical distance to offset |
| | each repeat. For a random offset, the min, max, and |
| | variation parameters can determine the boundaries of the |
| | randomness and the minimum variation per repeat. For a |
| | fixed offset, a distance attribute can specify the fixed vertical |
| | offset amount. |
| size | Specifies the pixel size of the zone glyph render area. This |
| | can be used for determining the rendering bounds when |
| | glyphs are rendered into the zone. The number of |
| | path_repeats that can fit is also a function of the size. If not |
| | specified, the zone size can default to the page size of the |
| | page this zone is rendering into. |
| paragraph_advance | Determines how paragraphs are advanced when glyphs are |
| | positioned. Glyphs can be logically organized into words that |
| | are separated by space characters and paragraphs that are |
| | separated by newline characters. When each paragraph |
| | boundary is encountered, this parameter can be used to |
| | determine glyph flow as follows: a) none - subsequent glyphs |
| | shall advance with no break and flow uninterrupted, b) |
| | segment - start a new flow in the next path segment, c) path - |
| | start a new flow in the next full path, or d) zone - start a new |
| | flow in the next zone in a sequence of text flow zones. |
| position | Specifies the x and y position of this zone relative to the |
| | page. This parameter can be ignored if a transform is |
| | specified. |
| opacity | Specifies the level of opacity for this zone when it is merged |
| | with the page. The value can be specified as a range of 0.0 |
| | to 1.0 where 0.0 means 100% transparent, 1.0 means 100% |
| | opaque, and values in between specifying partial |
| | transparency. |
| justify | Specifies how to justify all glyphs allotted to a path for a vertical |
| | or a horizontal orientation. Typically there can be two justify |
| | parameters, one for each orientation. The justification can be |
| | on a per path or a per path segment basis. For brevity, the |
| | term path may refer to either or both of these. The justification |
| | values are as follows: a) left - justify the glyphs to the left-most |
| | portion of the path, b) center - justify the glyphs in the center of |
| | the path, c) right - justify the glyphs to the right-most portion of |
| | the path, d) full - justify across the entire available area where |
| | for horizontal justification, the extra space is applied to the |
| | spaces between word groupings and optionally to the spacing |
| | between individual glyphs within a word grouping, and for |
| | vertical justification, the spacing is between path repeats, but |
| | not above the top repeat or below the bottom repeat, e) even - |
| | for vertical justification, extra space is distributed between all |
| | path repeats and also above the top repeat and below the |
| | bottom repeat, f) top - path repeats are vertically justified to the |
| | top of the available render area, g) middle - path repeats are |
| | vertically centered within the render area, and h) bottom - path |
| | repeats are vertically justified to the bottom of the render area. |
| character_spacing | Specifies character spacing for the spacing from glyph to glyph |
| | both horizontally and vertically, as well as the size of a space |
| | glyph. For each of these three spacings, the spacing value can |
| | be specified as a fixed pixel spacing, or as a percentage of the |
| | nominal spacing that would be used based on other parameters |
| | such as the glyph size, the copyfit scaling factor, the normal |
| | width of a space character, or any other parameter that impacts |
| | spacing. |
| capitalization | Specifies how to capitalize the glyphs as follows: a) default - |
| | render the glyphs exactly as specified, b) upper - convert all |
| | glyphs to the capitalized version of the glyph according to its |
| | character code, c) lower - convert all glyphs to the lower- |
| | case version of the glyph according to its character code, or |
| | d) word - capitalize the first glyph in each word grouping |
| | according to that glyph's character code. |
| randomize | Specifies a randomization factor for a variety of aspects of |
| | the glyph placement, including the x positioning, the y |
| | positioning, the scale, and rotation. After the final |
| | placement of each of these glyph placement metrics has |
| | been calculated, this randomization can further alter these |
| | metrics. The x and y position range can be specified as a |
| | fraction of the final point size and the final scaling factor |
| | after copyfitting has been applied. This random position |
| | delta can be centered around the final position. The scale |
| | factor can be specified as a fraction of the final scaling |
| | factor where the random scaling delta is then centered |
| | around the final scaling factor. The rotation factor can be |
| | specified as the actual rotation amount with the random |
| | rotation delta centered around the final rotation factor that |
| | has been calculated. |
| text_repeat | Specifies whether text repeating has been enabled and |
| | optionally specifies a sequence of glyphs to insert between |
| | each repeat. Text repeating can be combined with |
| | copyfitting so that if the glyphs at maximum glyph size do |
| | not fill the available path space, they are repeated, yet if |
| | they do not fit, the glyphs can be scaled down until the |
| | single message fits in the available path space. Further, full |
| | text repeats can be specified so that a glyph sequence is |
| | only repeated if an integral number of glyph sequences can |
| | be fit on the path. |
| word_span | Specifies if word groups of glyphs can span path segment |
| | boundaries or path boundaries. Typically, if multiple path |
| | segments describe a continuous curve such as would often |
| | be the case with a series of contiguous bezier curves, |
| | words can be specified to span segments. However, if |
| | segments of a path are disjoint, it may be desirable to force |
| | word groupings to exist within a single path segment. |
| text_source | Specifies which of the at least one text source is used to |
| | supply the glyphs for this zone. The character codes of a |
| | text source can be used to retrieve glyphs from a font |
| | specified by the font parameter. The text source parameter |
| | can be further specified by either a range parameter or by |
| | start and count parameters. |
| range | The range parameter of the text_source parameter can specify the |
| | start and end of the text to include as a fraction of the entire set of |
| | glyphs. For example a start of 0.0 and an end of 0.6 would specify to |
| | include the first 60% of the glyphs. A Boolean word_boundary |
| | parameter can specify whether the boundaries should be positioned to |
| | the nearest glyph word grouping boundary for the start and the end. |
| start | Specify a start offset for a paragraph, word, or letter. One start |
| | parameter can be specified for each. This allows the start position to |
| | be specified in terms of paragraphs, words within paragraphs and |
| | letters within words. For each parameter, the position can be |
| | specified as a relative or absolute position, where absolute implies |
| | that it is an absolute paragraph, word or letter offset from the start of |
| | the entire text source, and a relative offset implies that it is a relative |
| | position compared to the current position in the case where glyphs |
| | have already been applied to another zone and the current zone may |
| | want to continue where the prior zone left off, but perhaps with relative |
| | adjustments such as skipping to the next word boundary or the next |
| | paragraph boundary. |
| count | Specifies how many letters, words, or paragraphs can be included in |
| | the glyph set for this zone. If not specified, all remaining glyphs in |
| | the text_source can be assumed. |
| transform | Specifies a transform to be applied to the zone pixels when being |
| | merged with the page pixels. Transforms can include quadrilateral or |
| | perspective. In a more general case, any matrix transformation of the |
| | zone pixel space to the page pixel space can be applied. |
| font | Specifies the font glyph set to be used. A name attribute can be used to |
| | identify which font set to use. Each font can specify a default style. |
| | However a style attribute can be specified in the event that multiple |
| | styles of a font exist. A point_size attribute can also be specified so that |
| | the glyph set best suited for a particular point size is chosen. If no |
| | copyfitting is enabled, this can be the point size used for rendering |
| | glyphs in this zone. A font can comprise either a vector font or a raster |
| | font. Each glyph in a font can exist as color channels such as |
| | grayscale, RGB, or CMYK, and one or more alpha masks that define |
| | the transparency of each pixel in the glyph. A vector font can be derived |
| | from any of a variety of popular vector font formats such as PostScript ®, |
| | TrueType ®, or OpenType ®. A raster font specifies each glyph as a full |
| | color pixel array. Any number of glyph variations can be specified for |
| | each character code. Further, the glyphs of a raster font can be |
| | rendered on-demand. As an example, a glyph can be rendered as a 2D |
| | pixel array from a 3D model. In another example, a glyph can be |
| | rendered as a collage of images such as randomly filling a letter shape |
| | with multiple images of pebbles so that the resulting glyph image looks |
| | like pebbles arranged in the shape of a letter. Any source that is |
| | capable of providing glyphs as a function of a character code can be |
| | specified. |
| copy_fit | Specifies the characteristics of copyfitting as follows: a) none - |
| | no copyfitting is performed and the point size specified for the |
| | font is used explicitly, b) strict - the glyphs must fit within a |
| | specified tolerance of fully filling the available path space, or c) |
| | relaxed - the glyphs can underflow as long as the number of |
| | path repeats are within the specified min and max repeats. A |
| | min_point_size parameter can specify the minimum font point |
| | size for copyfitting. A max_point_size parameter can specify the |
| | maximum font point size to use for copyfitting. |

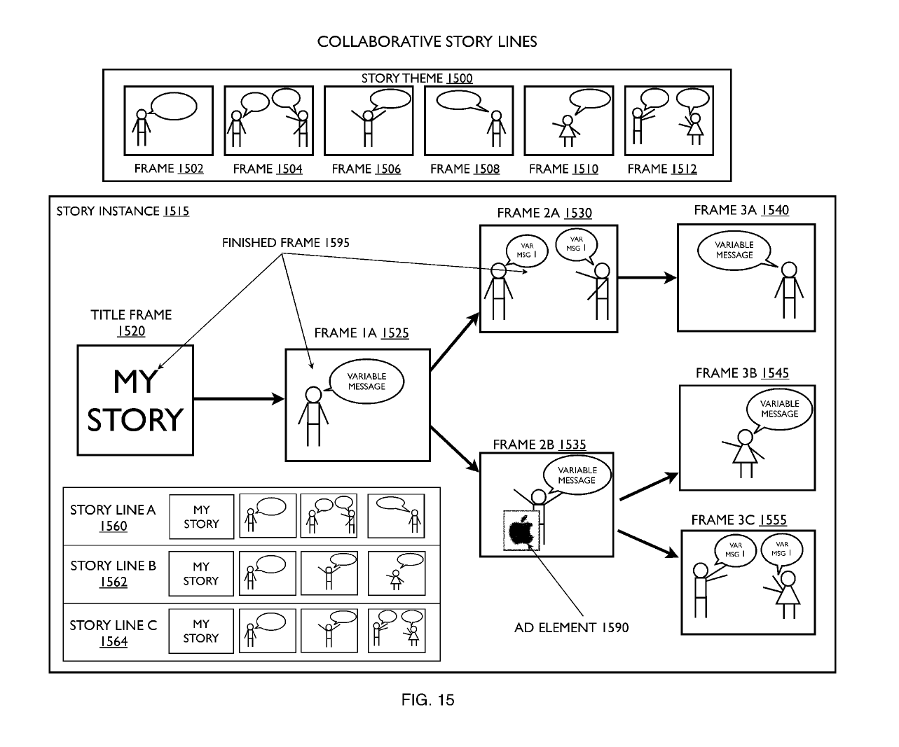

### FIG. 15

FIG. 15 illustrates schematically examples of collaborative story lines created from a series of digital products arranged into sequences of multiple frames, each at least in part comprising one or more finished products. A sequence can comprise still frames such as would be typical of a comic strip or a slide show, or a sequence can comprise the frames of a movie such as would be typical of a 3D animation, an illustrated animation, or a traditionally filmed movie.

In all of these manifestations, any number of the frames can be individualized as a function of the synthesis subsystem 164 and variable data provided by a variety of sources. A story theme 1500 can determine which digital products are available for building a story. Each digital product can be a still image, an audio clip, a video clip, a 3D model, or any of a variety of other entities that may be of interest to a user of the system. A story theme can be a mix of any number of unique digital product media types so that they can be combined in interesting ways. Each of the multiple frames 1502, 1504, 1506, 1508, 1510 and 1512 in the set corresponds to one or more digital products. Typically, although not required, all of the frames in the story theme can follow a particular style so that they work together to build a coherent or consistent story. Each frame 1502-1512 in the frame set 1500 represents a digital product which can be individualized by the synthesis subsystem 164 to create finished products. Each finished frame 1595 comprises a static media element or at least one finished product. The frames at certain positions in a story line sequence can be automatically determined and inserted as a function of metadata associated with the story theme 1500.

A first user can select one of the at least one story theme 1500 and initiate the creation of a story instance 1515, which is initially empty and contains no frames. The first user is designated as the owner of the story instance 1515. The first user can then choose an initial sequence of at least one frame 1520 from the story theme 1500 to add as the first frame of the story instance 1515. Each selected frame that is subsequently added to the story instance 1515 can optionally be individualized as a function of variable metadata provided by the first user or as a function of metadata derived from other sources (such as geo-location information, for example) to create a finished frame. The first user may optionally select additional frames such as frame 1A 1525 to add to the story sequence which also can be individualized. The initial sequence 1520 and 1525 of the story line 1515 is then made available for sharing with one or more second users.

Each of the one or more second users can add frames to the story line (thereby effectively “reconstructing” the digital product) and can optionally individualize the frame just as the first user had the option to do. The number or sequencing of frames each of the one or more second users is permitted to add or edit can be constrained, if desired, by parameters associated with the story theme 1500 or as a function of parameters provided by the first user. As an example, one second user can add frame 2A 1530 and frame 3A 1540, and another second user can add just frame 2B 1535. In some instances, certain frames in the story theme 1500 which are available to be added to the story instance 1515 might be available only as a function of one or more various parameters (e.g., restricted to a particular time frame or geo-location, or requiring a puzzle to be solved to unlock the frame). For example, a particular frame relevant to a theater might be available only if a second user is in that theater between 7:00 PM and 9:00 PM on a given day (as indicated by a clock and a geo-location system in a mobile device carried by that second user). Further some frames may require that the frame be purchased by the one or more second users before being added to the story.

Each of the one or more second users can then optionally make the augmented story line available to one or more additional users. Each additional user can further augment the story line that the additional user received. As an example, one such additional user can add frame 3B 1545 and another such additional user can add frame 3C 1555. At this point three unique story lines exist, story line A 1560, story line B 1562, and story line C 1564. Each story line was generated by contributions of at least one user. Each additional user can further share that additional user's version of the story line with other additional users. In some cases an additional user can be the same user as the first user, one of the one or more second users, or one of the one or more additional users.

Parameters associated with the story theme 1500 or parameters provided by the first user can limit how many times any one user is permitted to add frames to a story instance 1515. Each of the one or more story lines 1560, 1562, or 1564 can be rated so that an overall rating can be calculated as a function of all ratings of that story line. An overall rating of the story instance can be calculated as a function of all ratings of all of the one or more story lines associated with the story instance 1515. Parameters associated with a story instance 1515 can specify a minimum or a maximum number of frames that each story line may contain. Once a story line reaches the maximum number of frames, it can be locked so that no more frames can be added. Parameters associated with a story instance 1515 can specify whether frames can be deleted or modified by the user who added it or by the first user who owns the story instance 1515.

FIG. 3 illustrates schematically an exemplary data model which can be used to manage metadata associated with story instances. Sequence metadata 312 can describe the primary metadata associated with a story theme 1500. This metadata can include any variety of metadata that governs who, how, where, and when a story instance 1515 can be generated from a story theme 1500. As examples, sequence metadata can specify that the creation of a story instance can be limited to certain geo-locations, certain timeframes, or certain groups of users, or may specify that only one frame can be added per hour or per day. A sequence product 316 entry is associated with each frame 1502-1512. Each sequence product 316 entry can include any variety of metadata that governs how that story frame can be used in a sequence instance 308 entry that represents a story instance 1515. As an example, this metadata can specify that that sequence product can only be used as the first through third frames of a story instance 1515. Other metadata can specify that a particular sequence product 316 entry can only be used within a certain distance of a specific geo-location based on its longitude, latitude, and perhaps even altitude. This allows a user to unlock the frame associated with that sequence product 316 entry by visiting a certain place. Other metadata can specify that at least one of the available frames 1502-1512 can only be added to a story instance 1515 within a certain timeframe or after a certain point in time has passed.

As an example, a story theme 1500 can be created for a specific music event that will occur at a specific location and it is only available for creating story instances 1515 after the event starts by people who are currently at the event; however, once the story instance is initiated at the event, anyone can add additional frames to the story. If desired, specific positions in the sequence, for example the third frame of any storyline, can be specified to require visiting a certain venue, for example a particular restaurant, to add a frame to the story at that position in the storyline sequence. Each sequence instance 308 entry represents one story instance 1515. Each product instance 324 entry represents one frame 1520-1555 instance of a story instance 1515 and can only be created as a function of the sequence instance 308, sequence metadata 312, and sequence product 316 entries associated with this sequence.

The metadata associated with a sequence product 316 entry can associate that digital product with an advertisement sponsor. In that case when a frame 1502-1512 associated with that sequence product 316 entry is added to a story instance 1515, the advertisement sponsor can be charged a fee as a function of the creation and viewing of that story instance that includes a frame ad element 1590 associated with the advertisement sponsor. Note that the ad element 1590 can be static or can be dynamically rendered as a function of the story theme 1500, the story instance 1515, the frame 1535, or the story line viewer. A story theme 1500 owner or a sequence product 316 entry owner can receive a royalty payment as a function of the addition, use, or viewing of a story instance 1515 or a specific story line 1560-1564 that contains at least one frame associated with an advertisement sponsor. More generally, a fee can be charged to at least one advertisement sponsor as a function of viewing at least one story instance frame 1520-1555 that contains at least one visual ad element 1590 associated with at least one advertisement sponsor. Separately, a fee can be paid to the owner of a story instance 1515 as a function of viewing at least one story instance frame 1520-1555 that contains at least one visual ad element 1590 associated with at least one advertisement sponsor.

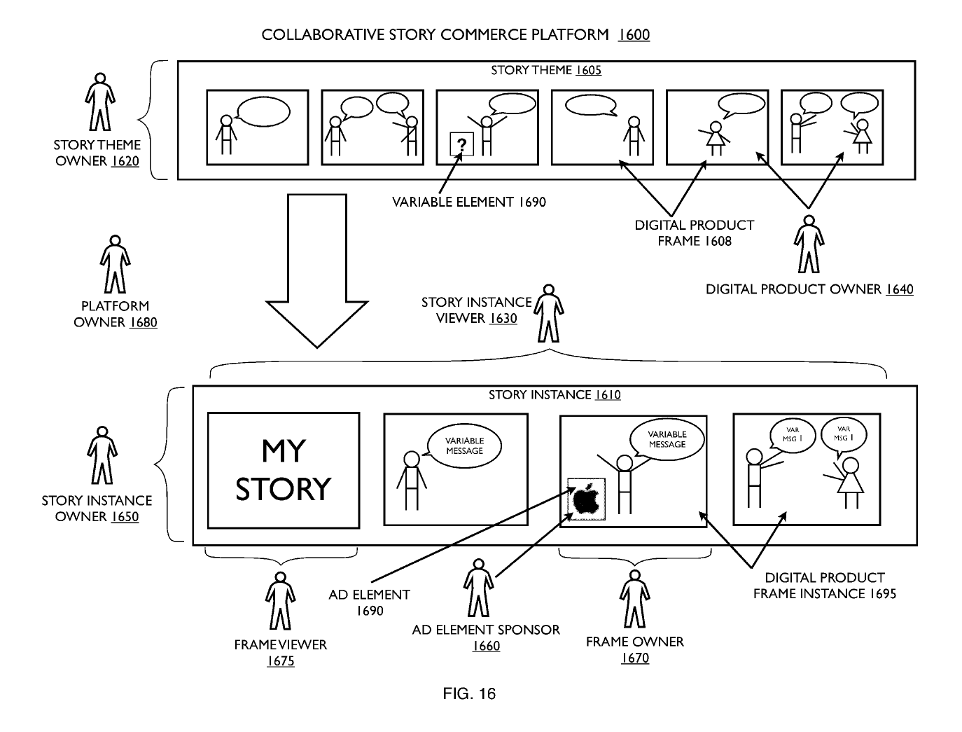

### FIG. 16

FIG. 16 illustrates schematically an example of collaborative story commerce. A collaborative story can comprise any suitable combination of media components such as images, audio, video, 3D objects, or physical objects that collectively tell a story. Each collaborative story can comprise a story theme 1605 and any number of story instances 1610 derived from the story theme 1605. A number of story themes 1605 can co-exist where the catalog of available digital product frames 1608 of those story themes may overlap. The collaborative story ecosystem involves multiple different ecosystem participants, including but not limited to story theme owners 1620, digital product owners 1640, story instance viewers 1630, story instance owners 1650, platform owners 1680, frame viewers 1675, ad element sponsors 1660, and frame owners 1670. Each ecosystem participant can be an individual person, one or more companies, a digital agent, or any other entity capable of serving the role of an ecosystem participant. The collaborative story platform 1600 is the overall managing entity of at least one story theme 1605 and any number of story instances 1610.

In an exemplary embodiment, the collaborative story platform 1600 can be an instance of a digital product synthesis system 100 configured to function as a collaborative story platform 1600. The collaborative story platform 1600 can be associated with at least one platform owner 1680. In an exemplary embodiment, this platform owner 1680 is Pijaz, Inc.; however, the platform owner 1680 can also be another entity. For example, a licensee of the digital product synthesis system 100 configured to function as a collaborative story platform 1600 can act as a platform owner 1680 if the license conveys non-exclusive rights to deploy an instance of the digital product synthesis system 100 or to operate an instance of the digital product synthesis system 100 hosted by another entity. There can be any number of collaborative story platform 1600 instances in existence and each can be logically or physically comprised of databases 180 and any number of central systems 160 or devices 120 (each typically comprising a CPU, a memory, program instructions, and a network interface).

A story theme 1605 can be associated with at least one story theme owner 1620 who typically creates and then manages the story theme. The story theme 1605 can contain a wide variety of information that describes the components and parameters for building a wide variety of story instances 1610 from a palette of digital product frames 1608. The story theme 1600 can include at least one reference to at least one digital product frame 1608. A digital product frame 1608 can be associated with the metadata necessary to synthesize at least one digital product frame instance 1695. There typically can be a one-to-one association between a digital product frame 1608 and a digital product that can be synthesized by the synthesis subsystem 164, although a single frame can often be produced from a variety of sources. The story theme 1605 can contain metadata governing the rules or guidelines for producing digital products such as images, videos, 3D models, audio, physical products, or any other type of output that can be assembled into a story line in any combination of the virtual world of a computer or in the physical world of manufactured goods. A story theme 1605 can also contain metadata that describes a variable element 1690. A variable element 1690 is a placeholder for integrating into at least one digital product frame instance 1695 at least one additional media element at the time a story instance is produced. Each digital product component of a story theme 1605 can have at least one digital product owner 1640. A digital product owner 1640 can be the same entity as a story theme owner 1620. There generally can be a many-to-one relationship of digital product owners 1640 to each story theme 1605.

A story instance owner 1650 can create and manage a story instance 1610 that is governed by a story theme 1605. A story instance 1610 can have at least one story instance owner 1650. Each frame of a story instance 1610 also can be associated with at least one frame owner 1670, who typically can be the entity who added that digital product frame instance 1695 to the story instance 1610. A frame owner 1670 can be the same entity as the story instance owner 1650. In summary, a story instance 1610 can be associated with at least one story instance owner 1650 and can comprise at least one digital product frame instance 1695, each of which can be associated with at least one frame owner 1670. Each digital product frame instance 1695 can be associated with a digital product frame 1608. A digital product frame instance 1695 generally can associate variable metadata provided by the frame owner 1670 at the time the frame instance is added to the story instance 1610, which then can be used to synthesize a digital product at or before the time it is viewed by a story instance viewer 1630, or more specifically, a frame viewer 1675 of that digital product frame instance 1695.

By way of example, a story instance viewer 1630 can read a cartoon style story instance where each frame contains a scene and some dialog. Some of those frames can contain product placements in the form of ad elements 1690 that can be chosen specifically for that viewer. Note that in some instances, the ad element 1690 can comprise the entire digital product frame instance 1695. In other words, the entire digital product frame instance 1695 can be an ad element 1690. In other instances a single digital product frame instance 1695 can contain one or more ad elements 1690. Some of those frames can further contain links that allow a physical object to be manufactured in an individualized manner and shipped to the story instance viewer or gifted to another individual. Some of the frames can contain an individualized video sequence that can be viewed. When a frame viewer 1675 views a digital product frame instance 1695 that is associated with a digital product frame 1608 that contains a variable element 1690, the digital product frame instance 1695 can be synthesized with a specific ad element 1690. That specific ad element 1690 can be chosen as a function of the identity(ies) of the frame viewer 1675, the frame owner 1670, the story instance owner 1650, the digital product owner 1640, or the story theme owner 1620. In other words, any individual or entity involved in the creation or viewing of that digital product frame instance 1695 can optionally in some way influence the choice of ad element 1690 that is integrated into the viewed frame.

The actual ad element 1690 chosen can also be influenced by other inputs, for example the current geo-location of the frame viewer 1675. As an example, the ad element 1690 can be a logo for a nearby restaurant that is clickable or touchable so that it can lead to more information about that nearby establishment. The actual ad element 1690 chosen can vary widely from viewer to viewer and from situation to situation. Each ad element 1690 can be associated with at least one ad element sponsor 1660. For example, if a rendering of an iPad® is chosen to be integrated into a video clip or cartoon frame, the ad element sponsor for that ad element is likely to be Apple® Inc. A story instance viewer 1630 generally can be an individual or entity who views at least one digital product frame instance 1695 of a story instance 1610. The story instance viewer 1630 might not actually view all frames of a story instance. A frame viewer 1675 can be the same individual as a story instance viewer 1630, but can instead or in addition be an individual who only receives a single digital product frame instance 1695. As an example, a story instance viewer 1630, might view a digital product frame instance 1695 that provides an offer to manufacture an individualized figurine that is relevant to the story instance 1610. That figurine can be further individualized to include an ad element 1690 that has been integrated into the manufactured product, such as wearing a shirt with a specific logo. The story instance viewer 1630 might then elect to have that individualized figurine manufactured and shipped to a friend. When the friend receives the figurine, that friend in this case is a frame viewer 1675.

In another example, any digital product frame instance 1695 can provide a control that enables a story instance viewer 1630 to forward just that frame to another person or user. From an e-commerce perspective, there are a wide variety of potential monetary flows between the ad element sponsor 1660 and the other individual participants, namely the platform owner 1680, frame viewer 1675, frame owner 1670, story instance owner 1650, digital product owner 1640, story instance viewer 1630, or story theme owner 1620. At the time a digital product frame instance 1695 is viewed by a frame viewer 1675, the synthesis system platform 1600 can associate a fee to an ad element sponsor 1660 as a function of the digital product frame instance 1695 and the nature of the viewing event by the frame viewer 1675. The synthesis system platform 1600 can further optionally associate a royalty payment to the platform owner 1680, frame viewer 1675, frame owner 1670, story instance owner 1650, digital product owner 1640, story instance viewer 1630, or story theme owner 1620 as a function of the digital product frame instance 1695 and the nature of the viewing event by the frame viewer 1675. Separately, a royalty payment can be associated with a digital product owner 1640 as a function of a digital product frame 1608 associated with that digital product owner 1640 when that digital product frame 1608 is selected by a frame owner 1670 for inclusion in a story instance 1610.

As an example, some of the digital product frames 1608 in the story theme 1605 can be premium frames that can only be included in a story instance 1610 if the story instance owner 1650 or the frame owner 1670 is willing to pay a fee for its inclusion. In the most general sense, when any producer individual in the ecosystem provides something of value to a consumer individual in the ecosystem, revenue can flow from the consumer individual to the producer individual either directly or indirectly through one or more other individual participants in the ecosystem. Further, when a producer individual benefits from consumption by a consumer individual, such as in the case of an advertisement, revenue can flow from the producer individual to one or more other individual participants in the ecosystem (perhaps most typically to individuals acting as distributors of the advertisement from an ad element sponsor 1660 to a frame viewer 1675).

Although not limited to the following examples, typical revenue flows can be described as follows. (1) An ad element sponsor 1660 pays a fee for the viewing or manufacture of a digital product frame instance 1695 that contains an ad element 1690 associated with that ad element sponsor 1660. That paid fee is credited to the platform owner 1680, which in turn may credit portions of that paid fee to the story instance owner 1650, the digital product owner 1640, or the story theme owner 1620. (2) A story instance owner 1650 pays a fee for the right to create a story instance 1610. When a digital product frame instance 1695 is added to a story instance 1610, the digital product owner 1640 for that frame receives a royalty as a function of the identity of the story instance owner 1650 and the fee paid by that story instance owner. (3) A story theme owner receives a royalty as a function of the identity of the story instance owner 1650. (4) A story theme owner receives a royalty as a function of the identity of an ad element sponsor 1660 associated with an ad element 1690 integrated into a digital product frame instance 1695 that is associated with a variable element 1690 of a digital product frame 1608 of the story theme 1605 which is viewed or received by a frame viewer 1675. Each digital product frame instance 1695 of each story instance 1610 can comprise any variety of media such as video, audio, image, 3D objects, or physical goods that may have been individualized as a function of the identity(ies) of the frame viewer 1675, the frame owner 1670, the story instance owner 1650, the digital product owner 1640, or the story theme owner 1620 as well as other environmental or system inputs such as time, geo-location, weather, or market conditions. The resulting story experienced by any one individual can be highly individualized and can trigger a variety of fee or royalty flows (i.e., revenue flows) between the various ecosystem participants. Each story experience can trigger different fee and royalty flows as a function of some or all of the variables which govern the exact nature of the experience delivered to a story instance viewer 1630 or a frame viewer 1675.

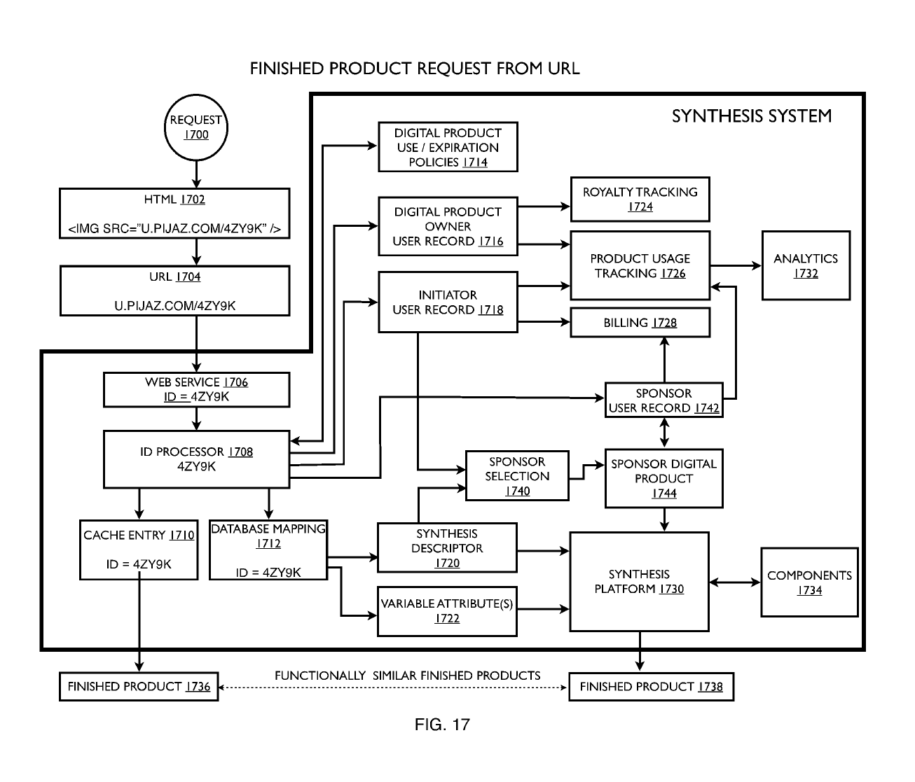

### FIG. 17

FIG. 17 illustrates schematically an exemplary process for retrieving a finished product request from a URL. In an exemplary embodiment, this URL can take the form of an HTTP request 1700 for a specific HTTP-compliant URL. For the case of a digital image, this can further comprise a URL 1702 specified as the SRC attribute of an HTML IMG element, where the URL 1704 specifies a digital data stream in the form of an HTML-compatible image format such as JPEG or PNG. The actual URL can follow other network protocols, and the requested finished product can be any type of digital data stream where an image data stream is just one example.

In an exemplary embodiment, the URL can be received by a web service 1706 which extracts an ID portion of the URL for use by an ID processor 1708. This ID processor can first check the digital product use and expiration policies 1714 to validate whether and in what form the request is permitted to be fulfilled. If those policies permit the request to be fulfilled, the ID processor can attempt to find a cache entry 1710 that matches the ID and, if found, transmits the associated finished product 1736. If no cache entry is found, a database mapping 1712 as a function of the ID can be used to access a synthesis descriptor 1720 and at least one variable attribute 1722 to initiate a digital product synthesis request to the synthesis system 1730. An optional sponsor selection 1740 can be initiated as a function of the synthesis descriptor that can choose one of at least one sponsor digital product 1744 for inclusion in the finished product 1738 generated by the synthesis system 1730. The sponsor digital product 1744 can be associated with a sponsor user record 1742. A product usage tracking reference can be created that records the usage of the sponsor digital product and a viewing fee associated with the sponsor user record 1742 in the billing 1728 function. The synthesis system 1730 can transmit a finished product 1738 that is functionally similar to the finished product 1736 that may have been previously transmitted in association with the ID. This new finished product 1738 is added as a cache entry 1710, so that subsequent requests can result in retrieval of the finished product from the cache as opposed to being generated again by the synthesis system 1730. Note that the ID processor 1708 can choose to regenerate the image even if a cache entry 1710 for that ID is found in the cache. This might occur if the digital product use and expiration policies 1714 indicated that some aspect of the generation criteria have changed and the new finished product for that ID is intended to have changed over time. For example, perhaps a different sponsor digital product can be integrated into the finished product. In this scenario the finished product 1738 and the previously finished product 1736 are functionally similar even if different sponsor digital products 1744 have been integrated into the two finished products. The product usage tracking 1726 information and associated information can be used to generate analytics 1732. In either case (cached product 1736 or new product 1738 delivered), the ID processor 1708 also optionally can associate a royalty tracking reference to the digital product owner user record associated with the ID.

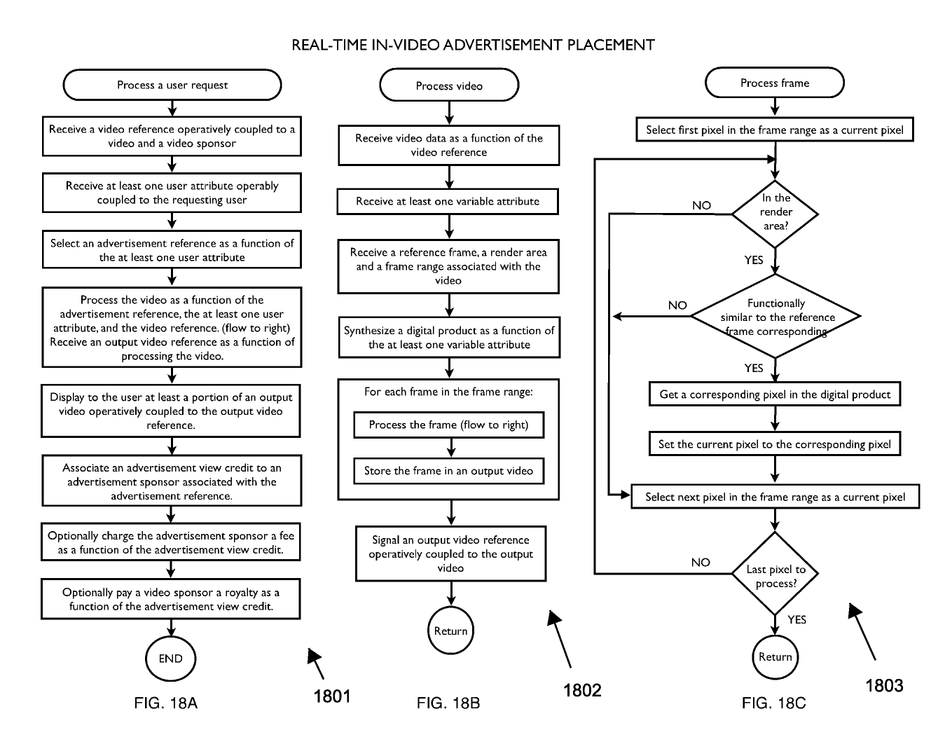

### FIGS. 18A, 18B, and 18C

FIG. 18A illustrates schematically an exemplary process 1801 for real-time in-video advertisement placement. The process of FIG. 18A includes, inter alia, processing a video; FIG. 18B illustrates schematically an exemplary process 1802 for processing a video that can be included, e.g., in the process of FIG. 18A. The process of FIG. 18B includes, inter alia, processing one or more frames; FIG. 18C illustrates schematically an exemplary process 1803 for processing a frame that can be included, e.g., in the process of FIG. 18B.

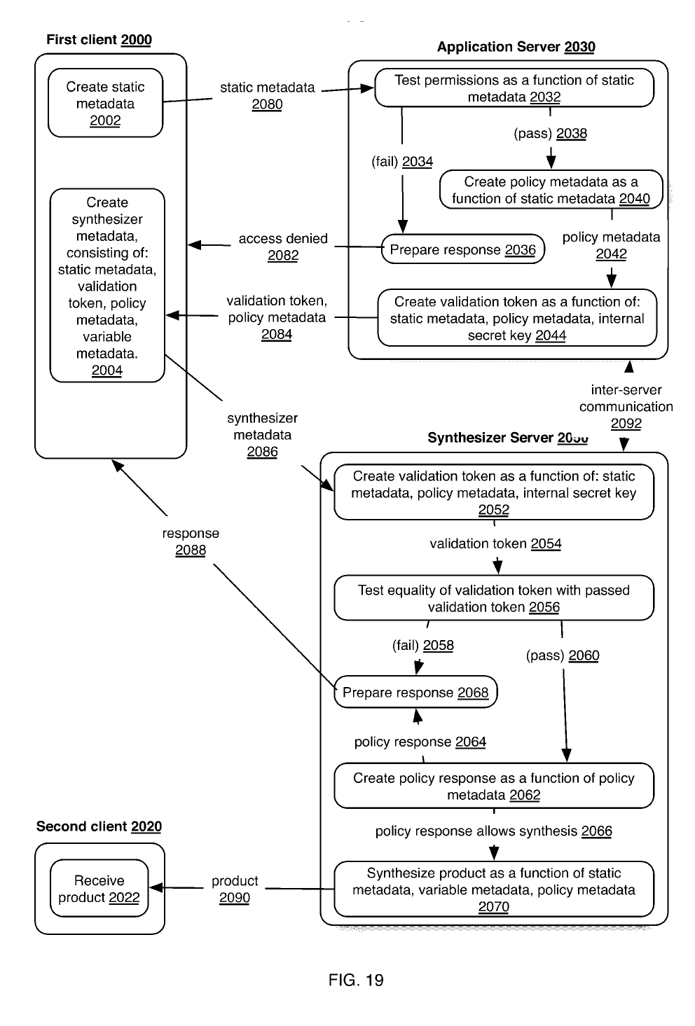

### FIG. 19

FIG. 19 illustrates schematically an exemplary system that enables one or more first clients 2000 to access one or more synthesizer servers 2050 using one or more application servers 2030 to provide advanced access control and policy. A set of static metadata and policy metadata can be provided that need only be validated once for any policy, and thereafter the client 2000 can directly access the one or more synthesizer servers 2050 while providing additional variable metadata that is not restricted by the policy for the life of the policy. The result can be highly scalable access control with variable product output. The first client 2000 can then be assumed to have properly authenticated with the application server 2030, so that the application server 2030 can confirm the identity of incoming requests from the first client 2000. An example would be via HTTP sessions utilizing a session cookie.

Static metadata can be defined as at least one piece of metadata provided by the first client 2000 that is required to be passed to the synthesizer server 2050 unaltered, for example, a client identifier, a user identifier, or an identifier for a synthesizer product. In the context of the work performed by the application server 2030, static metadata can also include any data that confirms the identity of the first client 2000 to the application server 2030, such is a session cookie. Policy metadata can be defined as at least one piece of metadata provided by the application server 2030 to the first client 2000 that is required to be passed to the synthesizer server 2050 unaltered, for example, an expiry timestamp, a resolution setting for a product, or an indicator that determines if a product should be watermarked. Variable metadata can be defined as at least one piece of metadata provided by the first client 2000 that is passed to the synthesizer server 2050 but is not part of the static metadata or the policy metadata. This variable metadata can change for each request to the synthesizer server 2050 without a need for re-validation by the application server 2030. Examples of variable metadata can include cropping dimensions for an image product, output volume setting for an audio product, or any other data that can control or influence the operation of the synthesizer server 2050. It should be noted that while passing no variable metadata would have limited use in the synthesis platform, the platform can function correctly without receiving any variable metadata. An internal secret key can be defined as some method or data that can be known by the application server 2030 and the synthesizer server 2050, but not by the first client 2000. For example, the secret key can be a string of random data, or a function that performs repeatable data manipulation on a piece of data. If used, the internal secret key of the application server 2030 must match the internal secret key of the application server 2050 for proper operation of the synthesis platform. An exemplary embodiment is a shared secret, which typically is copied to both the application server 2030 and the synthesizer server 2050 via static configuration files, or via a secure inter-server communication layer 2092.

The first client server 2000 can assemble 2002 a set of static metadata and can pass it 2080 to the application server 2030. The application server 2030 can test the access permissions 2032 for the first client 2000 as a function of the passed static metadata. For example, the client may or may not have access to a particular synthesizer product. If the test 2032 fails 2034, the application server 2030 can prepare a response 2036 and send an access denied message 2082 to the client 2000. The access denied message can contain information related to the failed access attempt (e.g., “insufficient funds”), so that, if desired, the first client 2000 can resubmit the request to the application server 2030. If the test 2032 passes 2038, the application server 2030 can create 2040 a set of policy metadata 2042 as a function of the static metadata. A validation token then can be created 2044 as a function of the static metadata, the policy metadata 2042, and the internal secret key. The validation token can be substantially unique to its components, so that a change in any individual component (e.g., the client identifier from the static metadata) would result in a different validation token. An example of a validation token function would be an SHA1 hash of a string comprising the metadata (<key,value> pairs, with keys ordered alphabetically) and the internal secret key. The validation token and policy metadata can then be passed 2084 to the first client 2000.

Upon successful receipt of the validation token and policy metadata 2084, the first client 2000 can then create 2004 at least one set of synthesizer metadata, each set comprising the static metadata, the validation token, the policy metadata, and at least one set of variable metadata. Each set of synthesizer metadata represents data that can be passed in a request containing the synthesizer metadata 2086 to the synthesizer server 2050.

Upon receipt of the synthesizer metadata 2086, the synthesizer server 2050 can create 2052 a validation token 2054 as a function of the static metadata and policy metadata (as passed in the synthesizer metadata from the first client 2000) and the internal secret key. The validation token 2054 is then tested for equality 2056 with the validation token passed in the synthesizer metadata. If the test fails 2058, a response can be prepared 2068 and sent 2088 to the first client 2000. The response can contain information related to the failure attempt (e.g., “validation token mismatch”). If the test passes 2060, a policy response can be created 2062 as a function of the policy metadata. The policy response can be a rejection of the policy if the policy is no longer valid as determined by the synthesizer server. For example, the policy metadata can contain an expiry timestamp for the validation token that has expired. A response can be prepared 2068 and sent 2088 to the first client 2000. The response can contain information related to an invalid policy (e.g., “validation token has expired”), or information about a valid policy (e.g., “synthesizer job accepted”). Note that it is not necessary for a response to be prepared 2068 or sent 2088 to the first client 2000 in order for a product to be synthesized. If the policy response allows synthesis of the product, the product can be synthesized 2070 as a function of the static metadata, the variable metadata, and the policy metadata. The synthesized product can then be sent 2090 to the second client. Note that the synthesized product could also be stored for later retrieval instead of being immediately returned 2090 to the second client 2020. Note that the first client 2000 and the second client 2020 can be the same client. In this case an optional simplified workflow is to return the synthesized product 2090 on successful synthesis of the product, or return a failure response 2088 on failure to synthesize the product.

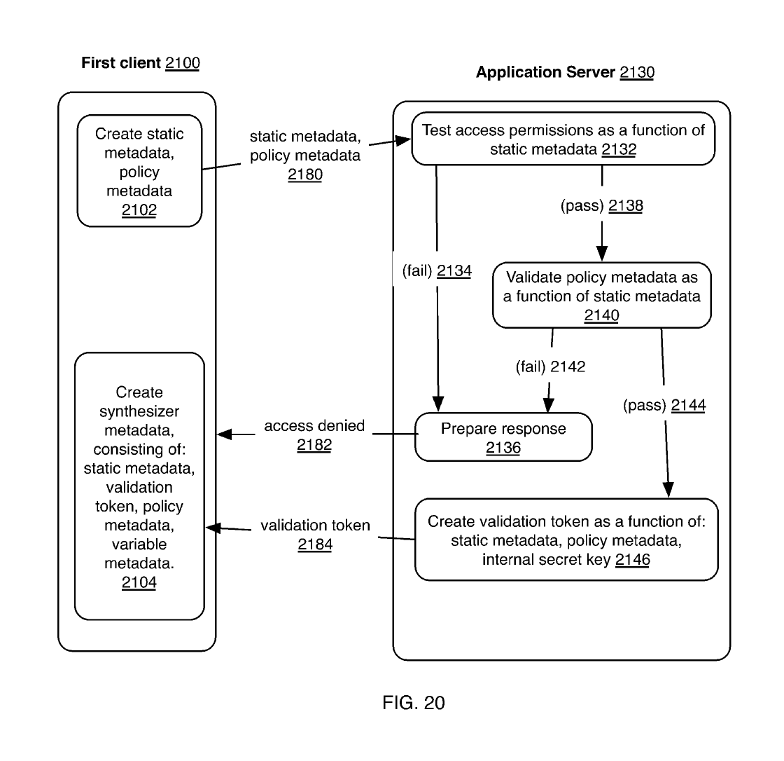

### FIG. 20

FIG. 20 illustrates schematically an alternative exemplary workflow for handling the policy metadata introduced in FIG. 19. Policy metadata in this example can be defined as at least one piece of metadata provided by the first client 2100 to the application server 2130 that is not part of the static metadata, and that the application server 2130 validates prior to the first client 2100 passing the policy metadata to the synthesizer server unaltered. The policy metadata can be created on the client server 2102 and passed along with the static metadata 2180 to the application server 2130. If the test for access permissions 2132 passes 2138, the policy metadata can be validated as a function of the static metadata 2140. If the validation passes, then a validation token can be created as a function of the static metadata, the policy metadata, and the internal secret key 2146, and only the validation token 2184 need be returned to the client 2100. If the policy metadata validation 2140 fails 2142, a response can be prepared 2136 and an access denied message 2182 can be sent to the first client 2100. The access denied message 2182 can contain information related to the failed policy metadata validation attempt (e.g., “unsupported policy”), so that the first client 2100 can, if desired, resubmit the request to the application server 2130.

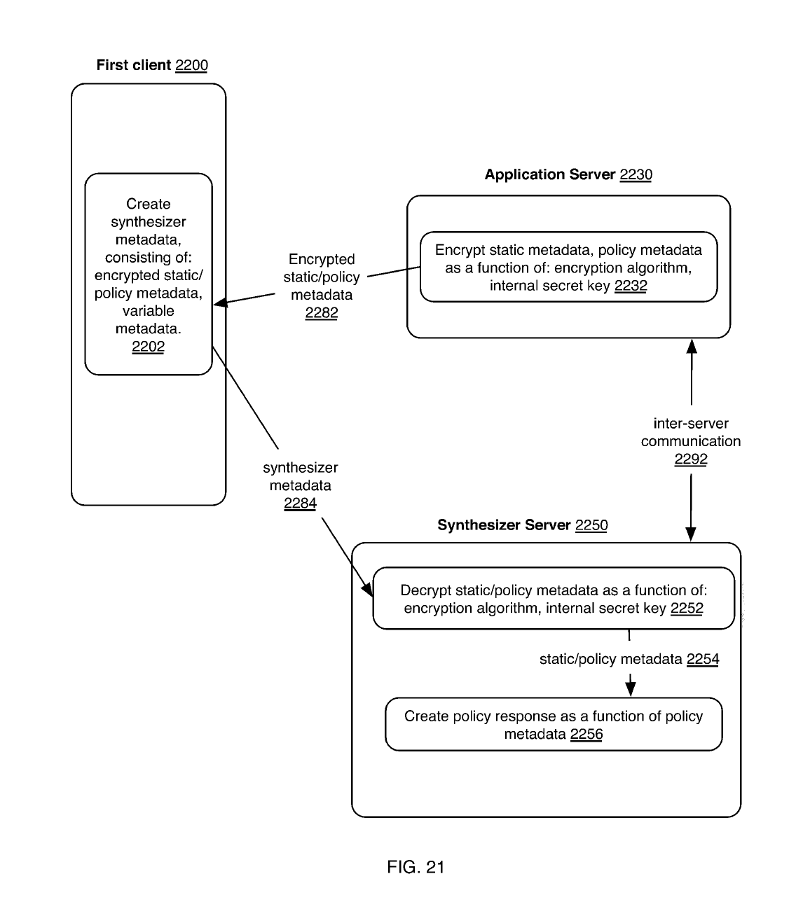

### FIG. 21

FIG. 21 illustrates schematically an alternative exemplary workflow for passing the static metadata and the policy metadata from the application server 2230 to the first client 2200, and then on from the first client 2200 to the synthesizer server 2250, in such a manner that the static metadata and the policy metadata are not altered by the first client 2200. In this exemplary workflow, the internal secret key of the application server 2230 must match the internal secret key of the synthesizer server 2250 so that the synthesizer server 2250, using an encryption algorithm and its copy of the internal secret key, can decrypt data encrypted by the application server 2230 using the same encryption algorithm and its own copy of the internal secret key to encrypt the data. An exemplary embodiment is a symmetric encryption algorithm such as DES, TripleDES, RC2, RC4, Blowfish, Twofish, or Rijndael; alternatively, a public-key cryptography approach could be used instead. The static metadata and the policy metadata can be encrypted as a function of an encryption algorithm and the internal secret key 2232, then the application server 2230 can pass the encrypted static/policy metadata 2282 to the first client 2200. The first client 2200 can create the synthesizer metadata, comprising the encrypted static/policy metadata, and at least one set of variable metadata 2202. The synthesizer metadata 2284 can be passed to the synthesizer server 2250, which decrypts the static/policy metadata as a function of the encryption algorithm and the internal secret key. A policy response can then be created as a function of the policy metadata 2256.

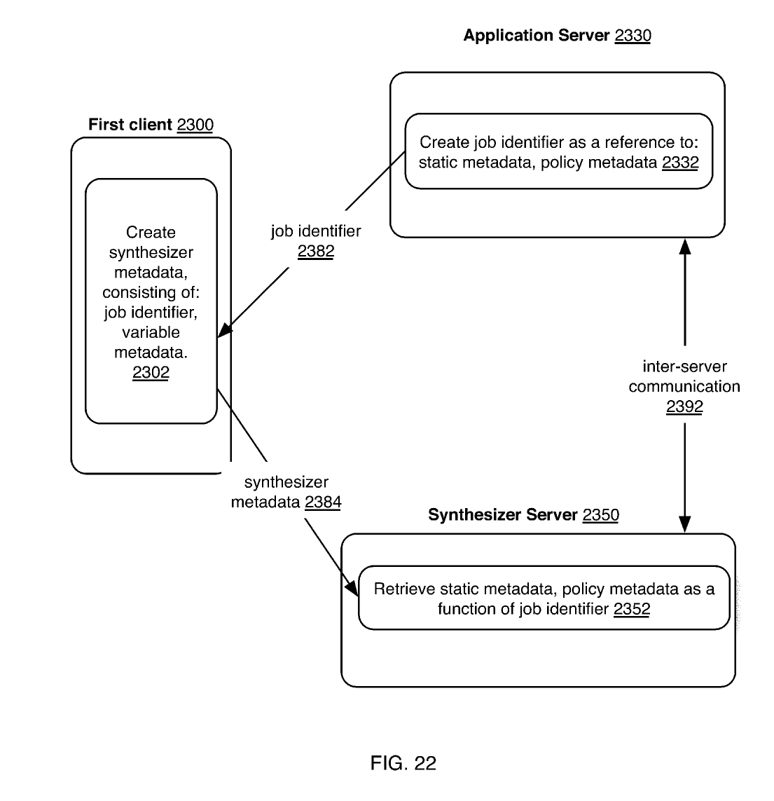

### FIG. 22

FIG. 22 illustrates schematically an alternative exemplary workflow for passing a representation of the static metadata and the policy metadata from the application server 2330 to the first client 2300, and then from the first client 2300 to the synthesizer server 2350. In this example, the static metadata and the policy metadata are not passed directly from the first client 2300 to the synthesizer server 2350, but instead can be passed directly from the application server 2330 to the synthesizer server 2350. A job identifier can be defined as a substantially unique identifier that references a set of static/policy metadata. For added security, the job identifier can be non-sequential, for example a UUID. The application server 2330 can create a job identifier as a reference to the static metadata and the policy metadata 2332. The job identifier 2382 can be passed to the first client 2300. The first client 2300 can create the synthesizer metadata, comprising the job identifier and at least one set of variable metadata, then can pass the synthesizer metadata 2384 to the synthesizer server 2350. Note that if the connection between the first client 2300 and the application server 2330 or the synthesizer server 2350 is insecure, a secure means of transmitting the job identifier can be employed (e.g., the HTTPS protocol). The synthesizer server 2350 can retrieve the static metadata and the policy metadata as a function of the job identifier passed in the synthesizer metadata 2384. The static metadata and the policy metadata can be passed from the application server 2330 to the synthesizer server 2350 via a secure inter-server communication layer 2392. Exemplary embodiments include the application server 2330 pushing the static metadata, the policy metadata, and the job identifier to the synthesizer server 2350, or the synthesizer server 2350 requesting the static metadata and the policy metadata from the application server 2330 using the job identifier passed in the synthesizer metadata 2384 from the first client 2300. The synthesizer server can optionally cache the static metadata and the policy metadata to prevent the overhead of repeated transmission from the application server 2330.

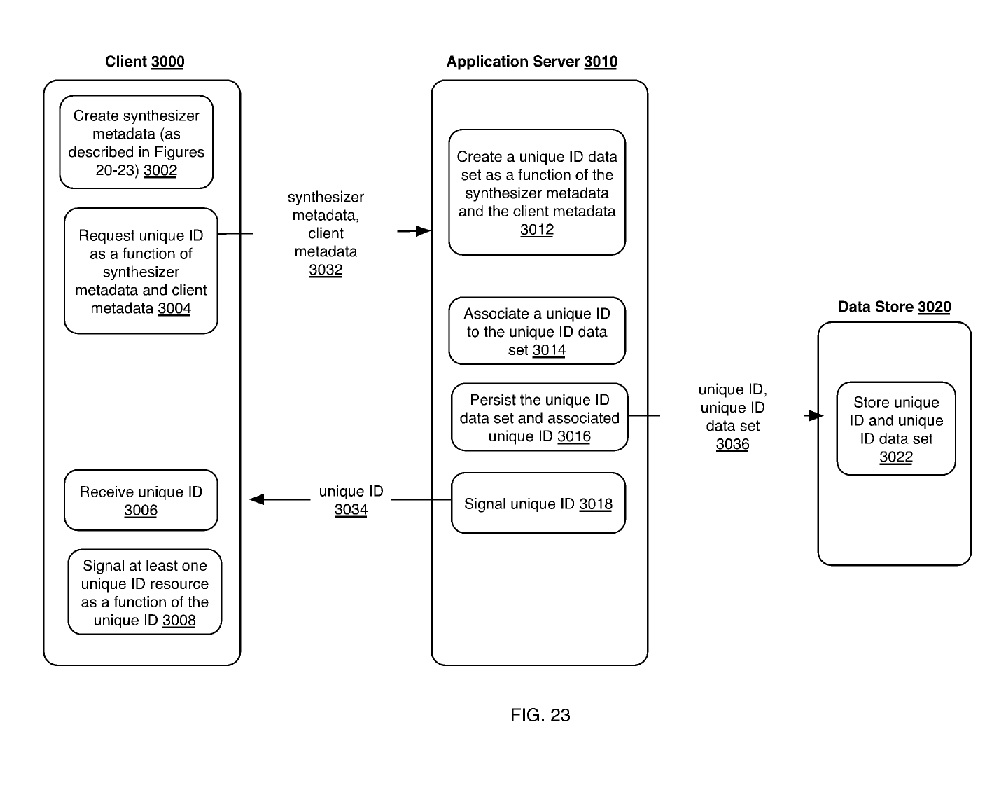

### FIG. 23

FIG. 23 illustrates schematically an exemplary method for representing, as a unique ID, the metadata required to synthesize a product. A unique ID can be defined as a unique piece of data which provides a consistent reference to a set of synthesizer metadata in a given system. Multiple unique IDs can refer to the same set of synthesizer metadata, but a single unique ID can only refer to one set of synthesizer metadata. An example of a set of unique IDs might include base 62 encoded representations of a series of long integers, where each long integer can be determined by an auto-incrementing function. Another example of a set of unique IDs might include system-generated UUIDs which are guaranteed to be unique across space and time.

A unique ID data set can be defined as data that describes the context of the unique ID derived from any number of data sources, including synthesizer metadata and client metadata. For example, client metadata can specify the type of client that requested the unique ID (e.g., according to the make and model of a specific mobile device), or it can specify the intended use case for a unique ID (e.g., for use on a particular social media site). A unique ID resource can be defined as a reference that encapsulates the unique ID for a particular use. A unique ID can be used to create multiple different unique ID resources, with each resource specifying a different outcome. For example, if the unique ID is 1234, the unique ID resource of http://product.example.com/1234 could be used to receive a digital product, and the unique ID resource of http://help.example.com/1234 could be used to receive a description of the product. Client metadata can be defined as data that describes the client, such as HTML headers indicating that the client is a mobile device.

The client 3000 can create synthesizer metadata 3002 according to one of the processes described for the examples of FIGS. 20-23. The client 3000 can then request a unique ID as a function of the synthesizer metadata and client metadata 3004 by transmitting the request 3032 to the application server 3010. The application server can create a unique ID data set as a function of the synthesizer metadata and the client metadata 3012 and can associate a unique ID to the unique ID data set 3014. The application server 3010 can store the unique ID data set and associated unique ID 3016 in the memory 3022 of a data store 3020 via a signal 3036. The application server 3010 can signal 3018 the unique ID 3034 to the client 3000. The client then can typically signal at least one unique ID resource as a function of the unique ID 3008, for example by publishing a URL used to retrieve a product. The application server 3010 can also return unique ID metadata and unique ID resources to the client 3000 created as a function of the unique ID, synthesizer metadata, and client metadata. For example, if the client is a mobile device, unique ID metadata indicating different uses for the unique ID could be returned, as well as a unique ID resource which mobile devices can use to retrieve a synthesized product.

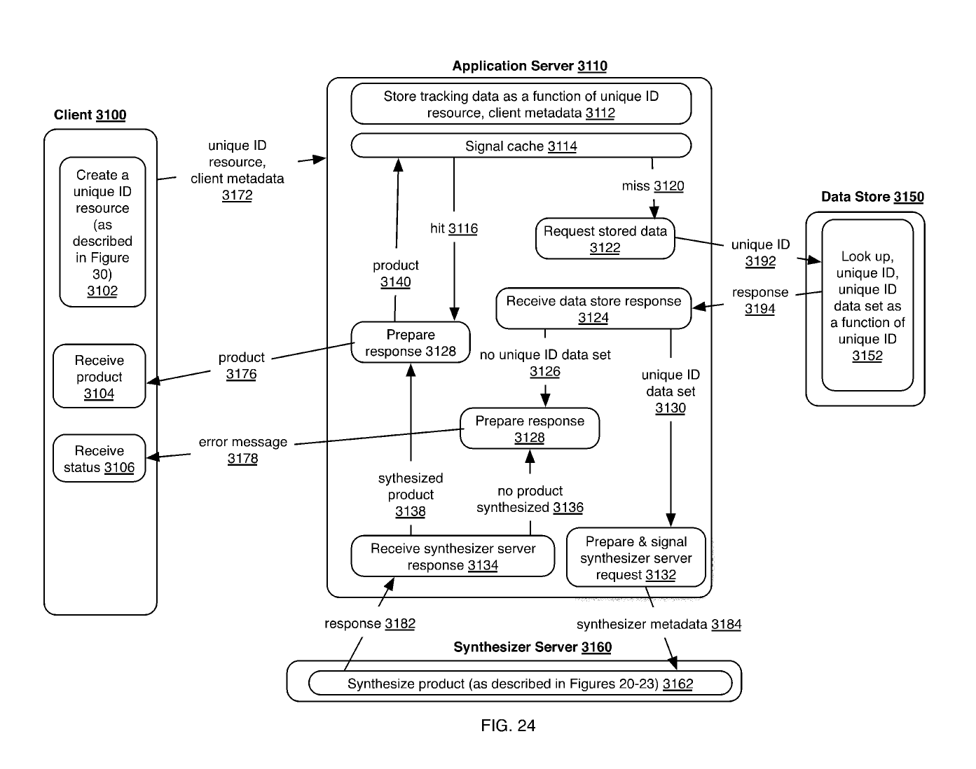

### FIG. 24

FIG. 24 illustrates schematically an exemplary method for retrieving a synthesized product as a function of a unique ID resource. The client 3100 can begin with a unique ID resource (created from the process described in FIG. 23) 3102. The client 3100 can send the unique ID resource and client metadata 3172 to the application server 3110. The application server 3110 can store tracking data as a function of the unique ID resource and the client metadata. An example of tracking data can include the unique ID, the unique ID resource, or the type of client making the request (e.g., according to a specific make and model of mobile device). The application server 3110 can first signal a cache for the synthesized product as a function of the unique ID resource 3114. This allows for a performance increase in the case of a particular unique ID resource being requested multiple times. If the product is in the cache 3116, a response is prepared 3128, and the product 3176 is returned to the client 3000. If the product is not in the cache 3120, stored data can be requested 3122 from a data store 3150, via a request containing the unique ID 3192. The data store 3150 can be expected to be populated in the manner described in FIG. 23. The data store 3150 can look up the unique ID and the unique ID data set referenced by the unique ID 3152, as a function of the passed unique ID 3192.

The data store response 3194 can include the unique ID and the unique ID data set from the lookup (if the lookup function finds data associated with the passed unique ID), or an error message (if the lookup function fails to find data associated with the passed unique ID). The response 3194 can be passed to the application server 3110, which receives the response 3124; if no unique ID data set is present in the response 3126, a response can be prepared 3128 and an error message 3178 can be sent to the client 3100. If the unique ID data set is present in the response 3130, a request can be prepared and the synthesizer server can be signaled 3132, and the synthesizer metadata (which is contained as a subset of the data in the unique ID data set) 3184 can be passed to the synthesizer server 3160. The synthesizer server 3160 can synthesize the product (as described for FIGS. 20-23) 3162. The synthesizer server response 3182 can contain the product if the product was successfully synthesized, or an error message otherwise. The application server 3110 can receive the synthesizer server response 3134, and if no product is present in the response 3136, a response can prepared 3128 and an error message 3178 can be sent to the client 3100. If a product is present in the response 3138, a response can be prepared 3128, the product 3176 can be returned to the client 3100, and the cache can be signaled 3114 to store a copy of the product 3140 for future use.

Note that multiple application servers 3110 can perform the necessary work. For example, one application server can handle the caching, while another can handle storing the tracking data and so forth. Note that the error message 3178 can contain any data that describes the reason for the failure to the client 3100, such as “invalid unique ID resource”, “product expired”, or “synthesizer server unavailable”. Note that the product response 3176 can also contain any data from the unique ID data set, including synthesizer metadata related to the product. For example, if the product is an image with embedded text, the response could also include the product identifier, and text data representing the text embedded in the image.

### FIG. 25

FIG. 25 illustrates schematically an exemplary method for publishing an editable product. Product can be defined as a deliverable which has been synthesized by the synthesizer system, such as an image with embedded text. Product metadata can be defined as any subset of synthesizer metadata that describes a product, such as a product ID or text data which represents text embedded in an image. Synthesizer interface can be defined as a set of interface components which enable the creation of synthesizer metadata, for example, a web page which displays an image product and a text box. Text entered into the text box can be converted into synthesizer metadata so that the text can be embedded into the image product. Control can be defined as any interface element that can be operated to bring about an effect, for example, a hyperlink on a web page. Control data can be defined as any data which is capable of presenting a control, for example, on a web page, hyperlink code which presents a hyperlink and associated JavaScript code which binds a function to the click event of the hyperlink.

A first client 3500 can synthesize a product (using any exemplary process of FIGS. 19-22) as a function of the synthesizer interface 3502. Using the returned synthesizer metadata 3504, the client 3500 then can create a unique ID (e.g., as in FIG. 23) 3506, then can publish a unique ID resource as a function of the unique ID 3508. For example, if the synthesized product is an image, and the unique ID is 1234, the client 3500 could publish http://image.example.com/1234 as a unique ID resource that can be used to retrieve the product. A second client 3510 can retrieve the published unique ID resource 3512 and then can send the unique ID resource 3552 in a request to an application server 3530. The application server can create the product and the product metadata as a function of the unique ID resource and the request (e.g., as in FIG. 24). For example, if the unique ID resource that the application server 3530 receives from the second client 3510 is http://html.example.com/1234, it can retrieve the unique ID data set for unique ID 1234, synthesize the product based on the synthesizer metadata extracted from the unique ID data set referenced by unique ID 1234, and extract the product metadata from the synthesizer metadata.

The application server 3530 also can create control data as a function of the unique ID resource and the request. For example, if the unique ID resource is http://html.example.com/1234, the html.example.com domain in the resource can trigger creation of control data comprising a hyperlink with associated JavaScript code that binds a function to the click event of the hyperlink. The product, product metadata, and control data 3554 can be sent in a response to the second client 3510, and the second client 3510 presents 3514 the product and control. For example, if the product is an image, and the control data is hyperlink code with associated JavaScript code binding a function to the click event of the hyperlink, then the second client 3510 would present the image and the hyperlink. When the control is operated 3516, it can activate a synthesizer interface 3518. The synthesizer interface can be embedded in the control data, or created dynamically by the control data. For example, if the control is a hyperlink with a JavaScript function bound to the click event, then clicking the link would fire the JavaScript function, which would create and display a text box used for entering text that becomes part of the synthesizer metadata for synthesizing a product. In this specific case the text could be embedded in an image by the synthesizer system. Once the synthesizer interface has been activated, products can be synthesized (e.g., according to FIGS. 19-22) as a function of the synthesizer interface 3520. At this stage, the second client 3510 is now in the same state 3520 as the first client 3500 when it began 3502. This allows for a repeatable cycle whereby clients can publish unique ID resources which are consumed by other clients, which then re-publish their own unique ID resources in a viral fashion.

Because product metadata also can be included in the response to the second client 3510, the synthesizer interface that is presented to the second client 3510 can have similar or identical characteristics to the state of the synthesizer interface on the first client 3500 at the point that the first client 3500 created the unique ID resource that the second client 3510 consumed. For example, if the synthesizer interface on the first client 3500 can comprise a text box used to enter text that the synthesizer system will embed in an image product, and the first client populates the text box with “This is a test message”, then that text can be included in the synthesizer metadata used to create the unique ID data set associated with the unique ID resource published by the first client. Therefore, the second client 3510 may receive the text data “This is a test message” as an element of the product metadata in the response to the request that contains the unique ID resource, and a text box created as a function of operating the control on the second client 3510 can be auto-populated with the text “This is a test message”. As a second example, if the synthesizer interface contains a selector for different product types, such as different images that a message can be embedded in, then in a similar manner as the text box example, the product ID of the selected product on the first client 3500 can be used to auto-select the same product on the second client 3510.

Due to the state maintenance of the synthesizer interface and synthesizer metadata describe above, each client that consumes a unique ID resource created by another client can be enabled to start with a similar or identical synthesizer interface and related set of synthesizer metadata as the client it consumed the unique ID resource from, and is then able to uniquely alter the synthesizer metadata and publish a new unique ID resource which refers to a unique ID data set containing the altered synthesizer metadata. For example, a first client embeds the message “This is a test” in an image and publishes the related unique ID resource, then a second client consumes the unique ID resource from the first client, and alters the message to “This is a test message” and publishes another unique ID resource, then a third client consumes the unique ID resource from the second client, and alters the message to “This is the final test message”, and so on.

Also note that a reference to a product can be sent in the control data instead of sending a product in the response to the second client 3510. For example, if the second client 3510 sends the unique ID resource http://html.example.com/1234 in a request to an application server 3530, the application server can place the unique ID resource http://image.example.com/1234 in the control data returned to the second client 3510. This unique ID resource can be used by the second client 3510 to retrieve the referenced product directly, for example, by placing it in the src attribute of an image tag on a web page.

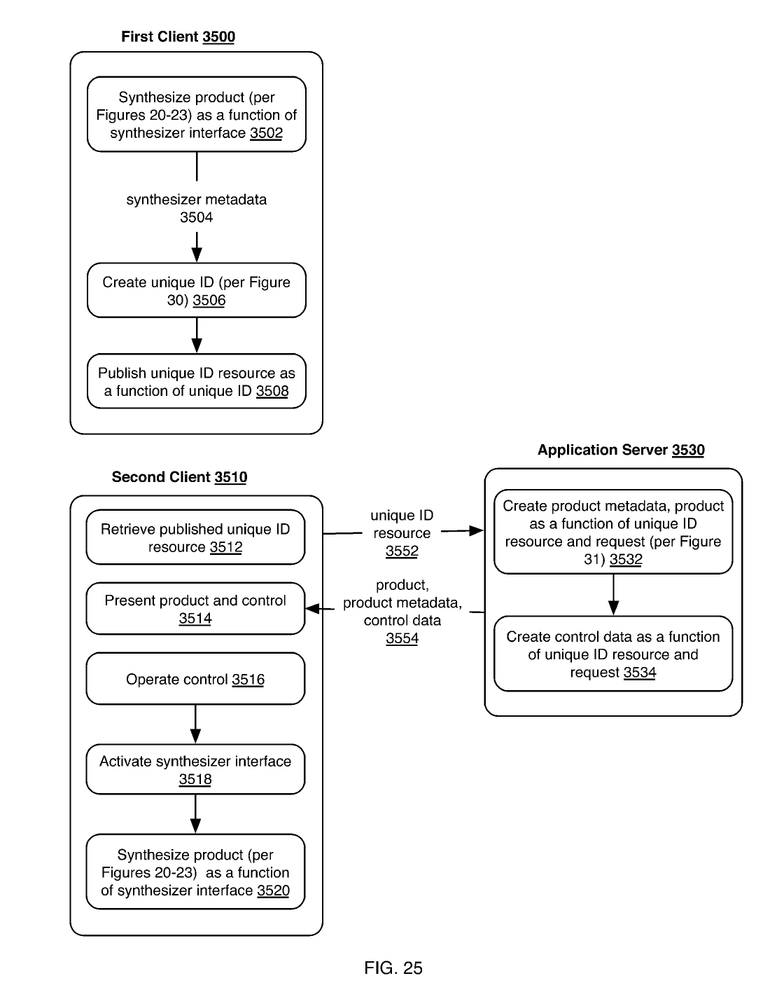

### FIG. 26

FIG. 26 illustrates schematically an alternative exemplary workflow 2600 for composing or incorporating one or more messages into at least one image. Such a workflow can be referred to as a composer. A composer can be a function of a component of a workflow. A composer can receive at least one variable attribute for the purposes of altering the function of the composer. Examples of the at least one variable attributes include but are not limited to a text message to compose into an image, a font family, a font size, a font color, a path along which to render the message, horizontal justification, or random scaling, rotating or positioning parameters. A composer can retrieve a composition descriptor as a function of the at least one variable attribute. Alternatively, a composition descriptor can exist as a portion of the description of a workflow and can be provided by the workflow to the composer. The descriptor can instruct the composer as to how to compose a message into at least one image.

The composer can retrieve at least one glyph as a function of the at least one variable attribute. As an example, the composer can retrieve one glyph for each character of a text message provided as a variable attribute. The composer can establish a base path or an optional top-line path as a function of the composition descriptor. The base bath can be used to determine the positioning or rotation of glyphs. If the optional top-line path is specified, the base path and the top-line path can be used to determine areal regions of an image into which a glyph can be rendered. A composer can modify each glyph as a function of the composition descriptor. Examples of glyph modifications include but are not limited to scaling, rotating, adding a drop shadow, pattern filling, adorning with additional graphical elements, colorizing, randomly filling with at least one graphical element, framing, cropping, texturizing, sharpening, or blurring. The composer can establish a scaling factor as a function of the width of the at least one glyph, the path length of the base path, and the composition descriptor. The composer can determine this scaling factor as a function of a copy fitting procedure. The composer can determine a position along the base path for each of the at least one glyph as a function of each glyph width, the scaling factor, or the composition descriptor. The composer can determine the rotation for each of the at least one glyph as a function of the tangent of the path at the glyph position on that path. Alternatively if a top-line path is specified, the composer can determine a transform for each of the at least one glyph as a function of a top-line position, the base-line position and glyph width. This transform can be a quadrilateral transform where the four coordinates of the quadrilateral are determined as a function of a top-line position, the base-line position, and a glyph width. The composer can optionally further transform each of the at least one glyph position, scale, or rotation as a function of a random number generator and the composition descriptor. As an example, the composition descriptor can specify that glyphs shall be randomly scaled anywhere in the range from 90% to 110% of its nominally calculated glyph size, and randomly rotated from −5 degrees to +3 degrees. The composer can merge each of the at least one glyph into a destination pixel buffer as a function of the position, scale, rotation, optional transforms, other modifications and the composition descriptor.

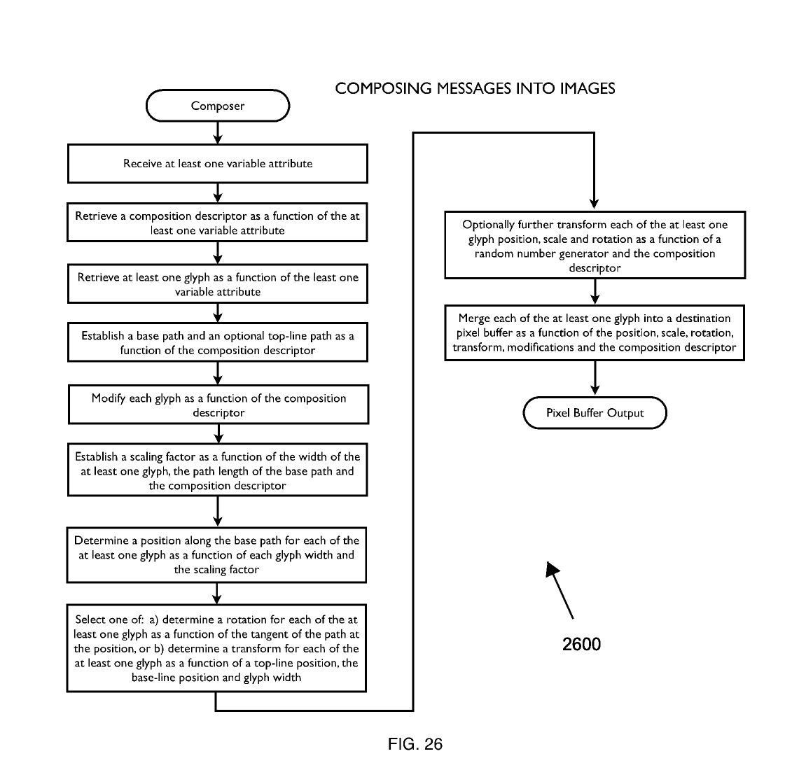

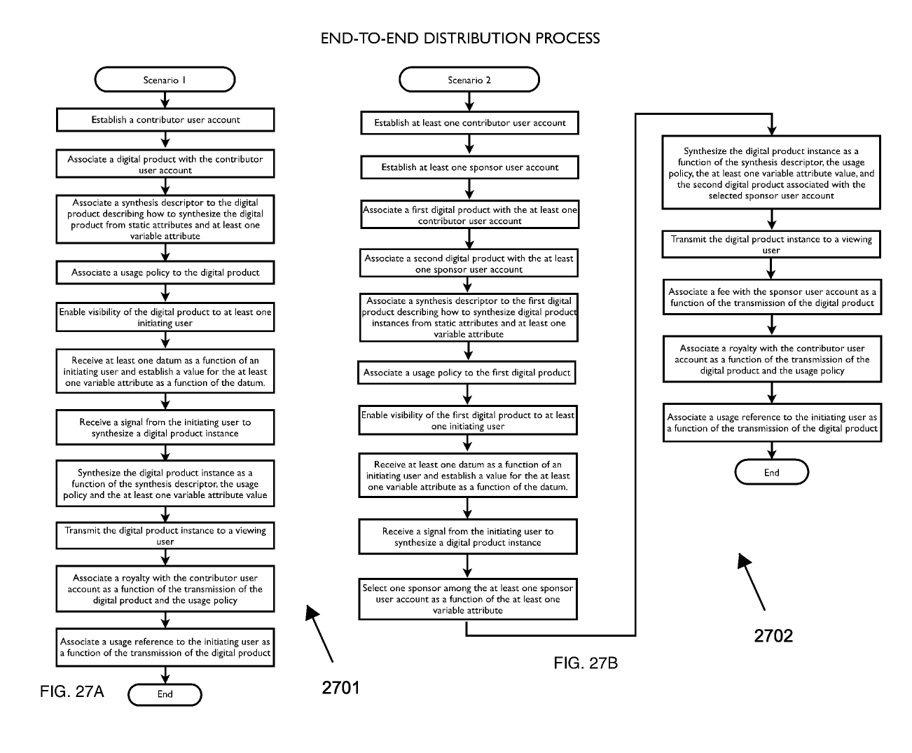

### FIGS. 27A and 27B

FIG. 27A illustrates schematically an alternative exemplary workflow 2701 for an end-to-end distribution process. The distribution process can establish a contributor user account for a contributor. A contributor can be a person who establishes a digital product in the distribution system for use by the distribution process. The contributor user account can specify attributes of the user including but not limited to a first name, a last name, a username, a password, account balance, or an email address. The distribution process can associate a digital product with the contributor user account. In this case, the contributor can typically be considered the owner of the digital product and generally manages attributes of the digital product. The distribution process can associate a synthesis descriptor to the digital product describing how to synthesize the digital product from static attributes and at least one variable attribute. The synthesis descriptor can be a workflow descriptor describing a workflow that can synthesize product instances of the digital product as a function of the workflow descriptor and the at least one variable attribute. The distribution process can associate a usage policy to the digital product. This usage policy can determine under which circumstances or in what manner digital product instances can be generated from a digital product. The distribution process can enable visibility of the digital product to at least one initiating user. The visibility of a digital product can be controlled by the usage policy. Some digital products might be considered private to a contributor and might be made visible to only a select group of users.

The distribution process can receive at least one datum as a function of an initiating user and establish a value for the at least one variable attribute as a function of the datum. As an example, the at least one datum can be a text message to be rendered into an image. As another example, it could be a random number that can be utilized to randomly generate a comprehensive composite of images. The distribution process can receive a signal from the initiating user to synthesize a digital product instance. As an example, the initiating user can enter a message as one typed character at a time into a buffer and the signal can be received as a function of the typed characters at which point the current buffer of characters is provided as a variable attribute. The distribution process can synthesize the digital product instance as a function of the synthesis descriptor, the usage policy, and the at least one variable attribute value, and can then transmit the digital product instance to a viewing user. The distribution process can associate a royalty with the contributor user account as a function of the transmission of the digital product and the usage policy. The distribution process can also associate a usage reference to the initiating user as a function of the transmission of the digital product. In one exemplary use of the system, the initiating user can provide monetary funds for the use of the system and a portion of these monetary funds can be used to provide the royalty to the contributor.

FIG. 27B illustrates schematically another alternative exemplary workflow 2702 for an end-to-end distribution process. In this scenario, the distribution process can establish at least one contributor user account. A contributor can be a person who establishes a digital product in the distribution system for use by the distribution process. The contributor user account can specify attributes of the user including but not limited to a first name, a last name, a username, a password, account balance, or an email address. The distribution process can establish at least one sponsor user account. A sponsor can be an entity wishing to advertise a product in the distribution system. For example a sponsor can provide images of a product with the intent of these images being placed as product placements within digital product instances. The distribution process can associate a first digital product with the at least one contributor user account and associate a second digital product with the at least one sponsor user account. The second digital product can be a static image as is the case in a simple product placement example. In more complex examples, the digital product can be used to generate digital product instances that can be unique in different uses. As in FIG. 27A, the distribution process can associate a synthesis descriptor to the first digital product describing how to synthesize digital product instances from static attributes and at least one variable attribute, can associate a usage policy to the first digital product, can enable visibility of the first digital product to at least one initiating user, can receive at least one datum as a function of an initiating user and establish a value for the at least one variable attribute as a function of the datum, or can receive a signal from the initiating user to synthesize a digital product instance. Unlike FIG. 27A, in this alternative workflow 2702, the distribution process can select one sponsor among the at least one sponsor user account as a function of the at least one variable attribute. As an example, the variable attributes can describe demographics, preferences, personal tastes, friends, or other informative attributes of the initiating user. One or more of those attributes can be used to select the sponsor which has a high likelihood of promoting products that would be of interest to the initiating user. Instead or in addition, the sponsor can be selected as a function of other parameters of the system either in conjunction with the variable attributes or independent of them, for example, one or more attributes of the system owner, the digital product owner, or the sponsor itself.

The distribution process can synthesize the digital product instance as a function of the synthesis descriptor, the usage policy, the at least one variable attribute value, and the second digital product associated with the selected sponsor user account. As an example, the second digital product can be an image of a branded computer, for example a MacBook® laptop, that can be rendered into the digital product instance as if the laptop were on a table in the scene of the digital product instance. The distribution process can then transmit the digital product instance to a viewing user and can associate a fee with the sponsor user account as a function of the transmission of the digital product, and can optionally associate a royalty with the contributor user account as a function of the transmission of the digital product and the usage policy. The distribution process can also associate a usage reference to the initiating user as a function of the transmission of the digital product.

### FIG. 28

FIG. 28 illustrates schematically another alternative exemplary workflow 2800 for a synthesizer workflow. Specifically, this workflow illustrates a word-to-shape workflow. The first component can provide a textual message as a series of words which can be split into words or phrases by a splitter component according to splitter attributes. The splitter component can split words into sections which are then provided to at least one compose component, which in turn can compose the words in the section into rendered glyphs. In the case of section 1, the composed words can be individually framed according to framer attributes which can provide images for rendering the edges, corners, or background of the frame. As an example, each word can be framed to look like a refrigerator magnet. In the case of sections 2 through N, words can be processed in any way that creates a desirable outcome, including rendering the words as was done in section 1. These composed or otherwise processed words can then be recombined into one composite rendered image. The rendered images of section 1 and sections 2 through N can then be merged by an image merge component into one image according to merge attributes which can specify positioning, alpha masks, or other merge instructions. The merged image can then be provided as a finished product or a digital product instance.

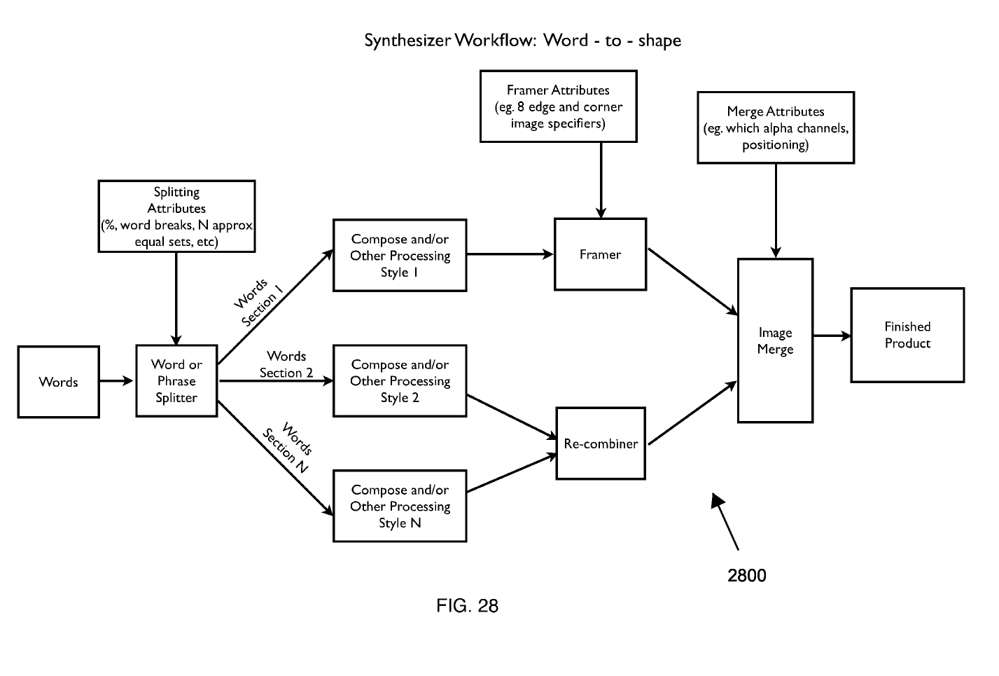

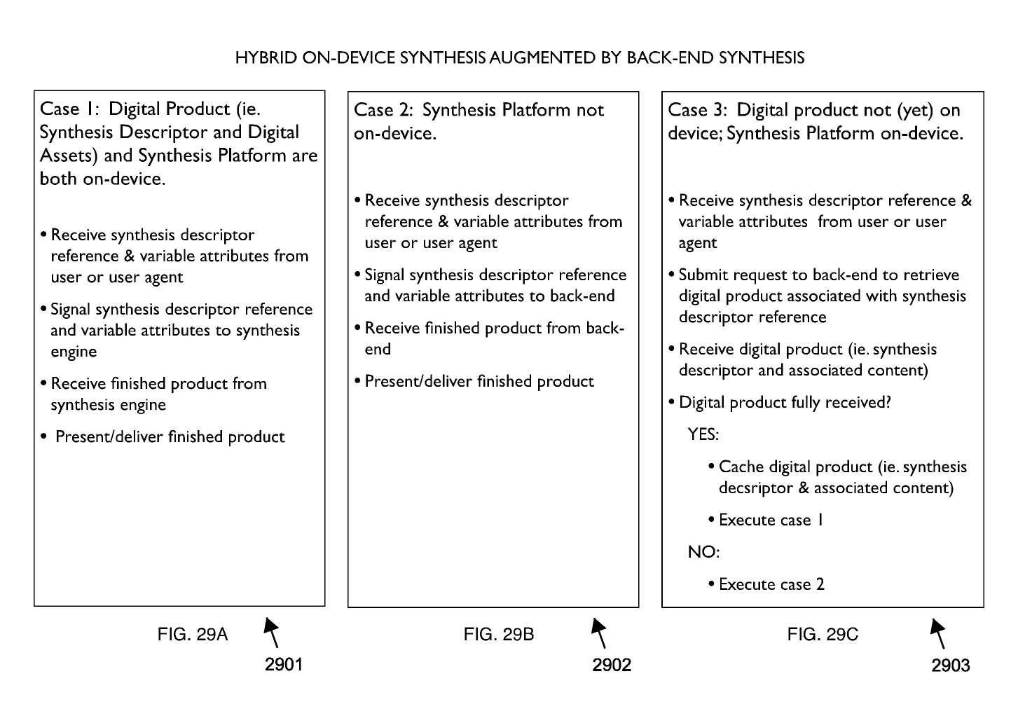

### FIGS. 29A, 29B, and 29C

FIGS. 29A, 29B, and 29C illustrate schematically alternative exemplary hybrid on-device synthesis workflows 2901, 2902, and 2903, respectively. Mobile devices provide challenging environments for providing excellent user experiences under a variety of situations. Case 1 2901 of FIG. 29A illustrates a case where all of the necessary elements already exist on a device to synthesize a digital product instance without any external dependencies. Case 2 2902 of FIG. 29B illustrates a case where the synthesis platform is not on the device. In this case, the device signals a back-end to synthesize the digital product instance and receives the finished product to deliver on the device. Case 3 2903 of FIG. 29C illustrates a case where the synthesis platform is on the device yet the digital product is not yet on the device. In this case the device signals a back-end system to retrieve a digital product associated with a synthesis descriptor reference and can cache it on the device for current or future use. For the sake of expedient delivery of the finished product, if the digital product or associated content is not yet on the device or not expected to be on the device within a reasonable timeframe, then case 2 of FIG. 29B can be executed to produce the finished product elsewhere (i.e., off-device). Alternatively, if the digital product and associated content are present or can be received on the device within a reasonable timeframe, then case 1 2901 of FIG. 29A can be executed once the digital product and associated content are present or received on the device.

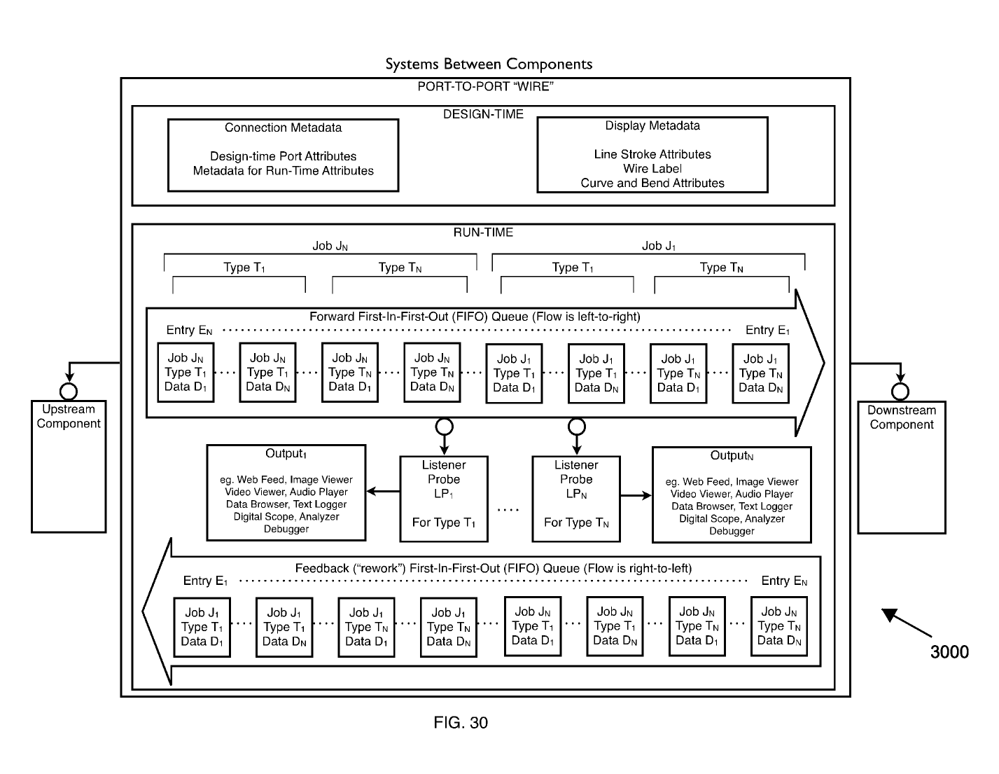

### FIG. 30

FIG. 30 illustrates schematically an alternative exemplary workflow 3000 for the systems between components. It illustrates the various elements of a data flow path, referred to as a logical wire between the connections or ports of two components. The logical port-to-port wire between components can manage at least one forward first-in-first-out (i.e., FIFO) queue for storing data received from an upstream component and delivering the data to a downstream component. Any number of listener probes can be associated with the forward FIFO queue to allow other aspects of the system to receive signals when data is added or removed from the queue. The logical port-to-port wire can manage at least one feedback, or rework, FIFO queue for storing data received from a downstream component and delivering the data to an upstream component. The logical port-to-port wire can also contain design-time connection metadata or display metadata which can be utilized to provide user experiences for creating workflows from wires or the components connected by the wires.

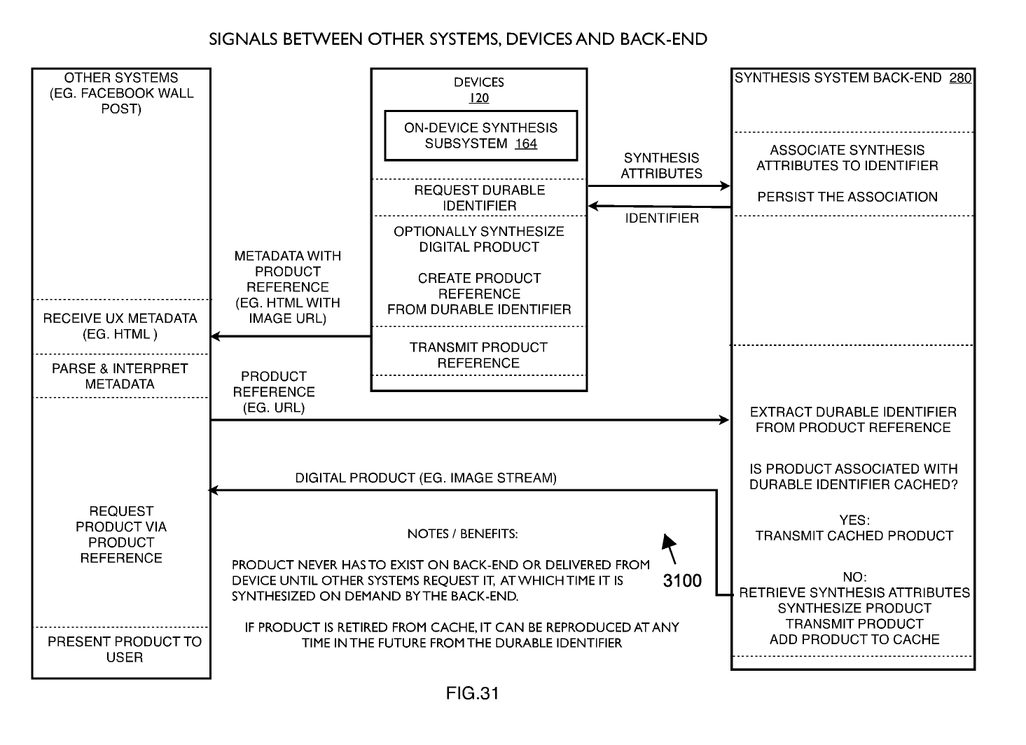

### FIG. 31

FIG. 31 illustrates schematically an alternative exemplary workflow 3100 for signals between other systems, devices, and a back-end. The at least one device 120 can request a durable identifier by providing synthesis attributes to a synthesis system back-end 280 which then can associate the synthesis attributes with a durable identifier, can store the association, and can signal the durable identifier to the at least one device 120. The at least one device 120 can optionally utilize an on-device synthesis subsystem 164 to synthesize a digital product. The at least one device 120 can create a product reference from the durable identifier and transmit the product reference to at least one other system. As an example, the product reference can be in the form of an HTTP URL. The at least one other system receives user experience metadata that can include the product reference, parses the metadata, and signals the product reference to the synthesis system back-end. The back-end can extract the durable identifier from the product reference and can check to see of the associated digital product is in a cache. If the back-end is utilizing a cache and the associated digital product is in the cache, the back-end can transmit the cached digital product to the at least one other system. If no cache is used or the digital product is not in the cache, the back-end can retrieve synthesis attributes associated with the durable identifier, synthesize a digital product as a function of the synthesis attributes, and transmit the synthesized digital product to the at least one other system. The digital product never has to exist on the back-end 280 or be delivered from the device 120 until other systems request it, at which time it is synthesized on demand by the back-end. If a digital product is retired from cache, it can be reproduced at any time in the future from the durable identifier.

### Synthesis System Notes

One component in workflow can produce a series of output products for one “job” that feed into subsequent components (e.g., one “job” can build 100 frames of an animation as a series of 100 images.) Some subsequent components may not be affected by how many products are grouped into one job and can be considered relatively job-boundary-agnostic. Eventually a downstream component will have metadata or instructions for how to consume a series of intermediate products and assemble them in meaningful ways back into one job product (e.g., assembled pixel frames that have been embellished with personalization into a video file).

A specific Text Example follows. A textual sentence is received. A word splitter creates a series of word “subjobs”, the next component composes incoming text into the smallest area that does not require copyfitting at specified font size and using specified font style(s) and with specified pixel margin, and outputs each word-on-a-canvas to the next component. The next component is a framing component which builds a frame around that canvas using the “8 images” approach common to build web buttons. This is now emitted as a single canvas to the next downstream canvas. This canvas accepts all canvases emitted from previous component until end-of-job. Once all are received, this series of WORD images are now composed more or less exactly as if they were letter glyphs, with random rotate, x and y jitter, copyfitting, etc. Two examples that can be generated in this example are: (a) turn a sentence into refrigerator word magnets or (b) create ransom note out of words torn out of a magazine.

Large amounts of metadata can be employed or generated. The workflow itself can declare attributes via metadata that are meant to be user-selectable at run-time and then these can be used by any component. Each aspect of the system allows for extensive design-time reflection to allow for rich tool design. For example, in a visual design tool, it may be desirable if the user could “rubber band” together only in and out ports that are known to carry compatible data types. Perhaps the design (i.e., the “job”) itself might even change the data types being carried forward. wires that become questionable can be shown in red to alert the designer that the design-time choices has made an existing wire no longer a workable choice. As an example, perhaps one component can handle three types of input, but the output always reflects the type of the input. The designer ties the input to an upstream provider that only supports type 1. That means, in the current design, its output now only supports type 1. If the component was wired to a downstream component that only consumes type 2, this now has created a workflow that does not work. That downstream wire could be turned red to alert the designer.

The systems and methods disclosed herein can be used to generate revenue in a variety of ways for various of the involved entities, not limited to the examples given here, that fall within the scope of the present disclosure or appended claims. The terms “pay,” “collect,” “receive,” and so forth, when referring to revenue amounts, can denote actual exchanges of funds or can denote credits or debits to electronic accounts, possibly including automatic payment implemented with computer tracking and storing of information in one or more computer-accessible databases. The terms can apply whether the payments are characterized as commissions, royalties, referral fees, holdbacks, overrides, purchase-resales, or any other compensation arrangements giving net results of split revenues as stated above. Payment can occur manually or automatically, either immediately, such as through micro-payment transfers, periodically, such as daily, weekly, or monthly, or upon accumulation of payments from multiple events totaling above a threshold amount. The systems and methods disclosed herein can be implemented with any suitable accounting modules or subsystems for tracking such payments or receipts of funds.

Various actions or method steps characterized herein as being performed by a particular entity typically are performed automatically by one or more computers or computer systems under the control of that entity, whether owned or rented, and whether at the entity's facility or at a remote location. The methods disclosed here are typically performed using software of any suitable type running on one or more computers, one or more of which are connected to the Internet. The software can be self-contained on a single computer, duplicated on multiple computers, or distributed with differing portions or modules on different computers. The software can be executed by one or more servers, or the software (or a portion thereof) can be executed by an online user interface device used by the electronic visitor (e.g., a desktop or portable computer; a wireless handset, “smart phone,” or other wireless device; a personal digital assistant (PDA) or other handheld device; a television or STB). Software running on the visitor's online user interface device can include, e.g., Java™ client software or other suitable software. Some methods can include downloading such software to a user's device to perform there one or more of the methods disclosed herein.

The systems and methods disclosed herein can be implemented as a system of one or more general or special purpose computers or servers or other programmable hardware devices programmed through software, or as hardware or equipment “programmed” through hard wiring, or a combination of the two. A “computer” (e.g., a “server” or a user device) or computer system can comprise a single machine or processor or can comprise multiple interacting machines or processors (located at a single location or at multiple locations remote from one another), and can include one or more memories or storage of any suitable type or types (e.g., temporary or permanent storage or replaceable media, such as network-based or Internet-based or otherwise distributed storage modules that can operate together, RAM, ROM, CD ROM, CD-R, CD-R/W, DVD ROM, DVD±R, DVD±R/W, hard drives, thumb drives, flash memory, optical media, magnetic media, semiconductor media, or any future storage alternatives). A computer-readable medium can be encoded with a computer program, so that execution of that program by one or more computers causes the one or more computers to perform one or more of the methods disclosed herein. Suitable media can include temporary or permanent storage or replaceable media, such as network-based or Internet-based or otherwise distributed storage of software modules that can operate together, RAM, ROM, CD ROM, CD-R, CD-R/W, DVD ROM, DVD±R, DVD±R/W, hard drives, thumb drives, flash memory, optical media, magnetic media, semiconductor media, or any future storage alternatives. Such media can also be used for databases recording the information described above.

### EXAMPLES

In addition to the preceding, the following examples fall within the scope of the present disclosure or appended claims.

### Example 1

A method performed using a system of one or more programmed hardware computers, which system includes one or more processors and one or more memories, the method comprising: (a) receiving automatically at the computer system from a first requesting interface device electronic indicia of (i) a first synthesis descriptor reference and (ii) a first set of one or more variable attributes; (b) retrieving automatically from one or more of the memories a first synthesis descriptor indicated by the first synthesis descriptor reference; (c) using the computer system, constructing automatically a first digital product instance of a first digital product class, wherein the first synthesis descriptor defines the first digital product class; and (d) automatically with the computer system (i) electronically delivering a digital copy of the first digital product instance to a first receiving interface device, or (ii) storing a digital copy of the first digital product instance on one or more of the memories, wherein: (e) the first synthesis descriptor includes a first set of one or more instructions which, when applied to the computer system, instruct one or more of the computers to cause a corresponding digital product instance to be constructed using a corresponding set of one or more variable attributes; (f) the first set of one or more variable attributes includes one or more parameters or one or more references to one or more digital content items; and (g) the one or more parameters or the one or more referenced digital content items of the first set are used by the computer system according to the first synthesis descriptor to construct the first digital product instance.

### Example 2

The method of Example 1 wherein (i) the first synthesis descriptor (i) further includes one or more additional parameters or one or more references to additional digital content items and (ii) the one or more additional parameters or the one or more referenced additional digital content items are used by the computer system according to the first synthesis descriptor to construct the first digital product instance.

### Example 3

The method of Example 1 or 2 further comprising: (h) receiving automatically at the computer system from a second requesting interface device electronic indicia of (i) a second synthesis descriptor reference and (ii) a second set of one or more variable attributes; (i) retrieving automatically from one or more of the memories a second synthesis descriptor indicated by the second synthesis descriptor reference; (j) using the computer system, constructing automatically a second digital product instance of a second digital product class, wherein the second synthesis descriptor defines the second digital product class; and (k) automatically with the computer system electronically delivering a digital copy of the second digital product instance to a second receiving interface device, wherein: (l) the second synthesis descriptor includes electronic indicia of a second set of one or more instructions which, when applied to the computer system, instruct one or more of the computers to cause a corresponding digital product instance to be constructed using a corresponding set of one or more variable attributes; (m) the second set of one or more variable attributes includes one or more parameters or one or more references to one or more digital content items; (n) the one or more parameters or the one or more referenced digital content items of the second set are used by the computer system according to the second synthesis descriptor to construct the second digital product instance; and (o) the first requesting interface device differs from the second requesting interface device, the first synthesis descriptor reference differs from the second synthesis descriptor reference, the first synthesis descriptor differs from the second synthesis descriptor, the first set of one or more variable attributes differs from the second set of one or more variable attributes, the first digital product class differs from the second digital product class, the first digital product instance differs from the second digital product instance, or the first receiving interface device differs from the second receiving interface device.

### Example 4

The method of Example 1 or 2 further comprising: (h) receiving automatically at the computer system from a second requesting interface device electronic indicia of (i) a second synthesis descriptor reference and (ii) a second set of one or more variable attributes; (i) retrieving automatically from one or more of the memories a second synthesis descriptor indicated by the second synthesis descriptor reference; (j) using the computer system, reconstructing automatically the first digital product instance; and (k) automatically with the computer system electronically delivering a digital copy of the reconstructed first digital product instance to a second receiving interface device, wherein: (l) the second synthesis descriptor includes electronic indicia of a second set of one or more instructions which, when applied to the computer system, instruct one or more of the computers to cause a corresponding digital product instance to be constructed or reconstructed using a corresponding set of one or more variable attributes; (m) the second set of one or more variable attributes includes one or more parameters or one or more references to one or more digital content items; (n) the one or more parameters or the one or more referenced digital content items of the second set are used by the computer system according to the second synthesis descriptor to reconstruct the first digital product instance; and (o) the first requesting interface device differs from the second requesting interface device, the first synthesis descriptor reference differs from the second synthesis descriptor reference, the first synthesis descriptor differs from the second synthesis descriptor, the first set of one or more variable attributes differs from the second set of one or more variable attributes, or the first receiving interface device differs from the second receiving interface device.

### Example 5

The method of any preceding Example wherein one or more of the computers and the requesting interface device are connected to a common computer network, and electronically receiving the electronic indicia of the first synthesis descriptor reference and the first set of one or more variable attributes comprises automatically receiving the electronic indicia from the requesting interface device via the common computer network.

### Example 6

The method of any preceding Example wherein one or more of the computers and the receiving interface device are connected to a common computer network, and electronically delivering the digital copy comprises automatically transmitting the digital copy to the receiving interface device via the common computer network.

### Example 7

The method of Example 5 or 6 wherein the common computer network is the Internet.

### Example 8

The method of Example 5 or 6 wherein the common computer network is a local area network.

### Example 9

The method of any preceding Example wherein the computer system includes the requesting or receiving interface device.

### Example 10

The method of any preceding Example wherein the requesting and receiving interface devices are the same device.

### Example 11

The method of any preceding Example wherein the requesting interface device is used by a requesting user and the receiving interface device is used by a receiving user different from the requesting user.

### Example 12

The method of any preceding Example wherein the first digital product class comprises multimedia documents, PDF files, CAD files, image files, video files, 3D rendering files, HTML files, or instructional files for controlling digital or physical delivery devices.

### Example 13

The method of any preceding Example wherein the digital content items include one or more images, videos, vector fonts, or raster fonts.

### Example 14

The method of any preceding Example wherein: (h) the first digital product class comprises image files or video files; (i) the first set of one or more variable attributes include a character string; and (j) the first synthesis descriptor or the first set of one or more variable attributes specify (i) one or more sets of fonts employed to render characters of the string, (ii) one or more render areas arranged on one or more images or video frames, (iii) one or more paths arranged within one or more of the render areas along which rendered characters of the string are arranged, and (iv) a position, scale, rotation, transformation, or repetition of each rendered character of the string.

### Example 15

The method of any preceding Example wherein: (h) the first digital product class comprises image files or video files; (i) the first synthesis descriptor includes parameters specifying one or more corresponding raster zones of the image file or of one or more corresponding frames of the video file; and (j) the first set of one or more variable attributes specify corresponding alterations of one or more of the specified raster zones.

### Example 16

The method of Example 15 wherein one or more of the corresponding alterations include superimposing corresponding secondary images onto one or more of the specified raster zones.

### Example 17

The method of any preceding Example wherein delivering a digital copy of the first digital product instance comprises, in response to construction of the first digital product instance, transmitting automatically from the computer system to the receiving interface device electronic indicia of the digital copy.

### Example 18

The method of any preceding Example wherein delivering a digital copy of the first digital product instance comprises (i) assigning automatically a corresponding identifier to the first digital product instance, (ii) transmitting automatically from the computer system to the requesting or receiving interface device electronic indicia of the first digital product instance identifier, (iii) receiving automatically at the computer system from the receiving interface device electronic indicia of the first digital product identifier, and (iv) in response to receiving the electronic indicia of the first digital product identifier, transmitting automatically from the computer system to the receiving interface device electronic indicia of the digital copy.

### Example 19

The method of Example 18 wherein the first digital product instance is constructed before receiving the electronic indicia of the first digital product identifier and cached in one or more of the memories, and the digital copy is generated from the cached first digital product instance.

### Example 20

The method of Example 18 wherein the first digital product instance is constructed in response to receiving the electronic indicia of the first digital product identifier, and the digital copy is generated from the constructed first digital product instance.

### Example 21

The method of any preceding Example further comprising authenticating automatically with the computer system one or more users of corresponding requesting interface devices and one or more users of corresponding receiving interface devices.

### Example 22

The method of any preceding Example further comprising receiving automatically from one or more of the users of corresponding requesting or receiving devices corresponding revenue amounts for one or more corresponding delivered digital copies.

### Example 23

The method of any preceding Example further comprising authenticating automatically with the computer system one or more providers of synthesis descriptors or digital content items, and receiving automatically at the computer system from one or more of the authenticated providers one or more corresponding synthesis descriptors or one or more digital content items.

### Example 24

The method of any preceding Example further comprising paying automatically to one or more of the providers of corresponding synthesis descriptors or digital content items corresponding revenue amounts for one or more corresponding delivered digital copies.

### Example 25

The method of any preceding Example further comprising receiving automatically from one or more of the providers of corresponding synthesis descriptors or digital content items corresponding revenue amounts for one or more corresponding delivered digital copies.

### Example 26

The method of Example 25 wherein one or more of the delivered digital copies, for which corresponding revenue amounts are received from one or more of the providers of corresponding synthesis descriptors or digital content items, include advertising content.

### Example 27

The method of any preceding Example further comprising receiving automatically at the computer system from one or more of the providers electronic indicia of corresponding usage policies for corresponding digital product instances.

### Example 28

The method of Example 27 further comprising determining automatically with the computer system a corresponding revenue amount for a corresponding digital product instance, which revenue amount is based at least in part on the corresponding synthesis descriptor, the corresponding set of variable attributes, the corresponding digital content items, the corresponding provider of synthesis descriptors or digital content items, or the corresponding usage policy.

### Example 29

The method of any preceding Example wherein electronic indicia of multiple synthesis descriptors, identifiers of multiple digital content items, identifiers of multiple variable attributes, multiple usage policies, or multiple revenue amounts are stored on one or more of the memories in a database.

### Example 30

A machine comprising a system of one or more programmed hardware computers, which system includes one or more processors and one or more memories and is structured and programmed to perform the method of any preceding Example.

### Example 31

An article comprising a tangible medium encoding computer-readable instructions that, when applied to a computer system, instruct the computer system to perform the method of any preceding Example.

It is intended that equivalents of the disclosed exemplary systems and methods shall fall within the scope of the present disclosure or appended claims. It is intended that the disclosed exemplary systems and methods, and equivalents thereof, can be modified while remaining within the scope of the present disclosure or appended claims.

In the foregoing Detailed Description, various features may be grouped together in several exemplary embodiments for the purpose of streamlining the disclosure. This method of disclosure is not to be interpreted as reflecting an intention that any claimed embodiment requires more features than are expressly recited in the corresponding claim. Rather, as the appended claims reflect, inventive subject matter may lie in less than all features of a single disclosed exemplary embodiment. Thus, the appended claims are hereby incorporated into the Detailed Description, with each claim standing on its own as a separate disclosed embodiment. However, the present disclosure shall also be construed as implicitly disclosing any embodiment having any suitable set of one or more disclosed or claimed features (i.e., sets of features that are not incompatible or mutually exclusive) that appear in the present disclosure or the appended claims, including those sets that may not be explicitly disclosed herein. It should be further noted that the scope of the appended claims do not necessarily encompass the whole of the subject matter disclosed herein.

For purposes of the present disclosure and appended claims, the conjunction “or” is to be construed inclusively (e.g., “a dog or a cat” would be interpreted as “a dog, or a cat, or both”; e.g., “a dog, a cat, or a mouse” would be interpreted as “a dog, or a cat, or a mouse, or any two, or all three”), unless: (i) it is explicitly stated otherwise, e.g., by use of “either . . . or,” “only one of,” or similar language; or (ii) two or more of the listed alternatives are mutually exclusive within the particular context, in which case “or” would encompass only those combinations involving non-mutually-exclusive alternatives. For purposes of the present disclosure or appended claims, the words “comprising,” “including,” “having,” and variants thereof, wherever they appear, shall be construed as open ended terminology, with the same meaning as if the phrase “at least” or “but (is/are) not limited to” were appended after each instance thereof.

In the appended claims, if the provisions of 35 USC §112 ¶ 6 are desired to be invoked in an apparatus claim, then the word “means” will appear in that apparatus claim. If those provisions are desired to be invoked in a method claim, the words “a step for” will appear in that method claim. Conversely, if the words “means” or “a step for” do not appear in a claim, then the provisions of 35 USC §112 ¶ 6 are not intended to be invoked for that claim.

If any one or more disclosures are incorporated herein by reference and such incorporated disclosures conflict in part or whole with, or differ in scope from, the present disclosure, then to the extent of conflict, broader disclosure, or broader definition of terms, the present disclosure controls. If such incorporated disclosures conflict in part or whole with one another, then to the extent of conflict, the later-dated disclosure controls.

The Abstract is provided as required as an aid to those searching for specific subject matter within the patent literature. However, the Abstract is not intended to imply that any elements, features, or limitations recited therein are necessarily encompassed by any particular claim. The scope of subject matter encompassed by each claim shall be determined by the recitation of only that claim.

What is claimed is:

1. A method performed using a system of one or more programmed hardware computers, which system includes one or more processors and one or more memories, the method comprising:
(a) receiving automatically at the computer system from a first requesting interface device electronic indicia of (i) a first synthesis descriptor reference and (ii) a first set of one or more variable attributes;
(b) retrieving automatically from one or more of the memories a first synthesis descriptor indicated by the first synthesis descriptor reference;
(c) using the computer system, constructing automatically a first digital product instance of a first digital product class, wherein the first synthesis descriptor defines the first digital product class; and
(d) automatically with the computer system (i) electronically delivering a digital copy of the first digital product instance to a first receiving interface device, or (ii) storing a digital copy of the first digital product instance on one or more of the memories,
wherein:
(e) the first synthesis descriptor includes a first set of one or more instructions which, when applied to the computer system, instruct one or more of the computers to cause a corresponding digital product instance to be constructed using a corresponding set of one or more variable attributes;
(f) the first set of one or more variable attributes includes one or more parameters or one or more references to one or more digital content items; and
(g) the one or more parameters or the one or more referenced digital content items of the first set are used by the computer system according to the first synthesis descriptor to construct the first digital product instance.

2. The method of claim 1 wherein (i) the first synthesis descriptor (i) further includes one or more additional parameters or one or more references to additional digital content items and (ii) the one or more additional parameters or the one or more referenced additional digital content items are used by the computer system according to the first synthesis descriptor to construct the first digital product instance.

3. The method of claim 1 further comprising:
(h) receiving automatically at the computer system from a second requesting interface device electronic indicia of (i) a second synthesis descriptor reference and (ii) a second set of one or more variable attributes;
(i) retrieving automatically from one or more of the memories a second synthesis descriptor indicated by the second synthesis descriptor reference;
(j) using the computer system, constructing automatically a second digital product instance of a second digital product class, wherein the second synthesis descriptor defines the second digital product class; and
(k) automatically with the computer system electronically delivering a digital copy of the second digital product instance to a second receiving interface device,
wherein:
(l) the second synthesis descriptor includes electronic indicia of a second set of one or more instructions which, when applied to the computer system, instruct one or more of the computers to cause a corresponding digital product instance to be constructed using a corresponding set of one or more variable attributes;
(m) the second set of one or more variable attributes includes one or more parameters or one or more references to one or more digital content items;
(n) the one or more parameters or the one or more referenced digital content items of the second set are used by the computer system according to the second synthesis descriptor to construct the second digital product instance; and
(o) the first requesting interface device differs from the second requesting interface device, the first synthesis descriptor reference differs from the second synthesis descriptor reference, the first synthesis descriptor differs from the second synthesis descriptor, the first set of one or more variable attributes differs from the second set of one or more variable attributes, the first digital product class differs from the second digital product class, the first digital product instance differs from the second digital product instance, or the first receiving interface device differs from the second receiving interface device.

4. The method of claim 1 further comprising:
(h) receiving automatically at the computer system from a second requesting interface device electronic indicia of (i) a second synthesis descriptor reference and (ii) a second set of one or more variable attributes;
(i) retrieving automatically from one or more of the memories a second synthesis descriptor indicated by the second synthesis descriptor reference;
(j) using the computer system, reconstructing automatically the first digital product instance; and
(k) automatically with the computer system electronically delivering a digital copy of the reconstructed first digital product instance to a second receiving interface device,
wherein:
(l) the second synthesis descriptor includes electronic indicia of a second set of one or more instructions which, when applied to the computer system, instruct one or more of the computers to cause a corresponding digital product instance to be constructed or reconstructed using a corresponding set of one or more variable attributes;
(m) the second set of one or more variable attributes includes one or more parameters or one or more references to one or more digital content items;
(n) the one or more parameters or the one or more referenced digital content items of the second set are used by the computer system according to the second synthesis descriptor to reconstruct the first digital product instance; and
(o) the first requesting interface device differs from the second requesting interface device, the first synthesis descriptor reference differs from the second synthesis descriptor reference, the first synthesis descriptor differs from the second synthesis descriptor, the first set of one or more variable attributes differs from the second set of one or more variable attributes, or the first receiving interface device differs from the second receiving interface device.

5. The method of claim 1 wherein one or more of the computers and the requesting interface device are connected to a common computer network, and electronically receiving the electronic indicia of the first synthesis descriptor reference and the first set of one or more variable attributes comprises automatically receiving the electronic indicia from the requesting interface device via the common computer network.

6. The method of claim 5 wherein the common computer network is a local area network or the Internet.

7. The method of claim 1 wherein one or more of the computers and the receiving interface device are connected to a common computer network, and electronically delivering the digital copy comprises automatically transmitting the digital copy to the receiving interface device via the common computer network.

8. The method of claim 7 wherein the common computer network is a local area network or the Internet.

9. The method of claim 1 wherein the computer system includes the requesting or receiving interface device.

10. The method of claim 1 wherein the requesting and receiving interface devices are the same device.

11. The method of claim 1 wherein the requesting interface device is used by a requesting user and the receiving interface device is used by a receiving user different from the requesting user.

12. The method of claim 1 wherein the first digital product class comprises multimedia documents, PDF files, CAD files, image files, video files, 3D rendering files, HTML files, or instructional files for controlling digital or physical delivery devices.

13. The method of claim 1 wherein the digital content items include one or more images, videos, vector fonts, or raster fonts.

14. The method of claim 1 wherein:
(h) the first digital product class comprises image files or video files;
(i) the first set of one or more variable attributes include a character string; and
(j) the first synthesis descriptor or the first set of one or more variable attributes specify (i) one or more sets of fonts employed to render characters of the string, (ii) one or more render areas arranged on one or more images or video frames, (iii) one or more paths arranged within one or more of the render areas along which rendered characters of the string are arranged, and (iv) a position, scale, rotation, transformation, or repetition of each rendered character of the string.

15. The method of claim 1 wherein:
(h) the first digital product class comprises image files or video files;
(i) the first synthesis descriptor includes parameters specifying one or more corresponding raster zones of the image file or of one or more corresponding frames of the video file; and
(j) the first set of one or more variable attributes specify corresponding alterations of one or more of the specified raster zones.

16. The method of claim 15 wherein one or more of the corresponding alterations include superimposing corresponding secondary images onto one or more of the specified raster zones.

17. The method of claim 1 wherein delivering a digital copy of the first digital product instance comprises, in response to construction of the first digital product instance, transmitting automatically from the computer system to the receiving interface device electronic indicia of the digital copy.

18. The method of claim 1 wherein delivering a digital copy of the first digital product instance comprises (i) assigning automatically a corresponding identifier to the first digital product instance, (ii) transmitting automatically from the computer system to the requesting or receiving interface device electronic indicia of the first digital product instance identifier, (iii) receiving automatically at the computer system from the receiving interface device electronic indicia of the first digital product identifier, and (iv) in response to receiving the electronic indicia of the first digital product identifier, transmitting automatically from the computer system to the receiving interface device electronic indicia of the digital copy.

19. The method of claim 18 wherein the first digital product instance is constructed before receiving the electronic indicia of the first digital product identifier and cached in one or more of the memories, and the digital copy is generated from the cached first digital product instance.

20. The method of claim 18 wherein the first digital product instance is constructed in response to receiving the electronic indicia of the first digital product identifier, and the digital copy is generated from the constructed first digital product instance.

21. The method of claim 1 further comprising authenticating automatically with the computer system one or more users of corresponding requesting interface devices and one or more users of corresponding receiving interface devices.

22. The method of claim 1 further comprising receiving automatically from one or more of the users of corresponding requesting or receiving devices corresponding revenue amounts for one or more corresponding delivered digital copies.

23. The method of claim 1 further comprising authenticating automatically with the computer system one or more providers of synthesis descriptors or digital content items, and receiving automatically at the computer system from one or more of the authenticated providers one or more corresponding synthesis descriptors or one or more digital content items.

24. The method of claim 1 further comprising paying automatically to one or more of the providers of corresponding synthesis descriptors or digital content items corresponding revenue amounts for one or more corresponding delivered digital copies.

25. The method of claim 1 further comprising receiving automatically from one or more of the providers of corresponding synthesis descriptors or digital content items corresponding revenue amounts for one or more corresponding delivered digital copies.

26. The method of claim 25 wherein one or more of the delivered digital copies, for which corresponding revenue amounts are received from one or more of the providers of corresponding synthesis descriptors or digital content items, include advertising content.

27. The method of claim 1 further comprising receiving automatically at the computer system from one or more of the providers electronic indicia of corresponding usage policies for corresponding digital product instances.

28. The method of claim 27 further comprising determining automatically with the computer system a corresponding revenue amount for a corresponding digital product instance, which revenue amount is based at least in part on the corresponding synthesis descriptor, the corresponding set of variable attributes, the corresponding digital content items, the corresponding provider of synthesis descriptors or digital content items, or the corresponding usage policy.

29. The method of claim 1 wherein electronic indicia of multiple synthesis descriptors, identifiers of multiple digital content items, identifiers of multiple variable attributes, multiple usage policies, or multiple revenue amounts are stored on one or more of the memories in a database.

30. A machine comprising a system of one or more programmed hardware computers, which system includes one or more processors and one or more memories and is structured and programmed to perform the method of claim 1.

31. An article comprising a tangible medium encoding computer-readable instructions that, when applied to a computer system, instruct the computer system to perform the method of claim 1.
